(19) United States
(12) Patent Application Publication
(10) Pub. No.: US 2015/0036047 A1
(43) Pub. Date: Feb. 5, 2015

(54) ORIENTATION CONTROL OF AN IMAGE SENSOR OF A PORTABLE DIGITAL VIDEO CAMERA

(71) Applicant: Contour, LLC, Provo, UT (US)

(72) Inventor: Derek Lee Bledsoe, Woodinville, WA (US)

(21) Appl. No.: 14/447,250

(22) Filed: Jul. 30, 2014

Related U.S. Application Data
(60) Provisional application No. 61/861,264, filed on Aug. 1, 2013.

(51) Int. Cl. H04N 5/225

(52) U.S. Cl. CPC H04N 5/2254
USPC 348/375

(57) ABSTRACT

A camera accessory includes one or more kinematic sensor(s), such as accelerometer(s) and/or angular rate sensor(s), an actuator, and a coupling mechanism to adjust the orientation of a horizontal image plane of an image sensor of a digital video camera independent of the orientation of the camera housing of the digital video camera.

### INCORPORATION BY REFERENCE TO ANY PRIORITY APPLICATIONS

Any and all applications for which a foreign or domestic priority claim is identified in the Application Data Sheet as filed with the present application are incorporated by reference under 37 CFR 1.57 and made a part of this specification.

### FIELD

This disclosure relates to video cameras and, in particular, to control of an orientation of an image sensor in such a camera, such as a point-of-view (POV) sports action digital video camera or camcorder.

### BACKGROUND

First-person or POV video cameras have become popular with action sports participants, especially those participating in extreme sports. The POV video cameras permit hands-free capture of video during motion of the person, vehicle, or equipment to which the camera is mounted. Some wearable POV digital video cameras, such as the Roam and Contour+ series cameras, manufactured by Contour, LLC, include an image sensor that is rotatable with respect to the housing of the camera. The independently rotatable image sensor permits the orientation of the plane of the horizon recorded by the image sensor to be adjusted after the camera is mounted to the person, vehicle, or sports equipment to compensate for pitch, yaw, and/or roll misalignments of the mounted camera housing with respect to the horizon of the scene perceived by the user.

Although a user can use one of his or her hands to make slow gross adjustments to the orientation of the image sensor during real-time video capture to compensate for the mounting orientation of the camera housing, the user does not have a means to make instantaneous small adjustments to the orientation of the image sensor to respond to sudden changes in the pitch, yaw, or roll experienced by the camera.

### SUMMARY

In some embodiments, a camera accessory is provided for controlling orientation of an image sensor mounted within a rotatable frame that is supported by a camera housing.

In some embodiments, the camera accessory has an accessory housing with an accessory mounting feature that is operable for engaging a camera mounting feature on the camera housing.

In some embodiments, the camera accessory has an angular rate sensor positionable within the accessory housing and operable to obtain angular rate information concerning angular forces experienced by the accessory housing.

In some embodiments, the camera accessory has an accelerometer positionable within the accessory housing and operable to obtain acceleration information concerning acceleration experienced by the accessory housing.

In some embodiments, the camera accessory has an actuator positionable within the accessory housing, wherein the actuator is directly or indirectly responsive to the angular rate information obtained by the angular rate sensor and the acceleration information obtained by the accelerometer, and wherein the actuator is operable to provide compensatory motion to offset deviation from reference plane caused by angular forces and acceleration experienced by the accessory housing.

In some embodiments, the camera accessory has a coupling mechanism operable for coupling motion provided by the actuator to the rotatable frame, wherein the rotatable frame is operable for rotation independently from the camera housing such that the actuator is operable to cause a change in the orientation of the image sensor with respect to the camera housing.

In some embodiments, the camera accessory is attached to a digital video camera, such as POV digital video camera or a wearable digital video camera.

In some embodiments, the digital video camera has a rotatable frame or an imaging receptacle supported by the camera housing, wherein the camera housing is operable to have a first orientation with respect to the scene or the reference plane, wherein the imaging receptacle supports a lens and the image sensor, and wherein the image sensor is operable for capturing light propagating through the lens and representing the scene, wherein the imaging receptacle is operable for rotation independent of the camera housing, wherein the image sensor is supported in rotational congruence with the imaging receptacle such that rotation of the imaging receptacle causes rotation of the image sensor and such that the image sensor is operable to have a second orientation with respect to the scene or the reference plane, and wherein the second orientation is different from the first orientation.

In some embodiments, the camera housing is operable for mounting to a person, a vehicle, or equipment such that the camera housing has a first orientation with respect to the scene or a reference plane such that the digital video camera is operable for hands-free capture of video during motion of the person, the vehicle, or the equipment involved in an action sports activity.

In some embodiments, a method for adjusting orientation of an image sensor involves supporting a camera housing with a first orientation with respect to the reference plane; rotating an imaging receptacle supported by the camera housing, wherein the imaging receptacle is operable for rotation independent of the camera, wherein the imaging receptacle supports a lens and an image sensor, wherein the image sensor is supported in rotational congruence with the imaging receptacle such that rotation of the imaging receptacle causes rotation of the image sensor and such that the image sensor is operable to have a second orientation with respect to the reference plane, wherein the second orientation is different from the first orientation; employing an angular rate sensor to obtain angular rate information concerning angular forces experienced by the camera housing with respect to the reference plane; employing an accelerometer operable to obtain acceleration information concerning acceleration experienced by the camera housing with respect to the reference plane; causing an actuator to rotate the imaging receptacle directly or indirectly in response to angular rate information obtained by the angular rate sensor and the acceleration information obtained by the accelerometer, such that the actuator is operable to cause a change of the second orientation of the image sensor with respect to the reference plane while maintaining the first orientation of the camera housing with respect to the reference plane; and employing the image sensor to capture light propagating through the lens and representing the scene.

Additional aspects and advantages will be apparent from the following detailed description, which proceeds with reference to the accompanying drawings.

### BRIEF DESCRIPTION OF THE DRAWINGS

FIGS. 1A, 1B, 1C, 1D, 1E, and 1F are, respectively, front perspective, back perspective, side elevation, front elevation, back elevation, and top plan views of an embodiment of an integrated hands-free, POV action sports digital video camera.

FIG. 2A is a front perspective view of an embodiment of an integrated hands free, POV action sports digital video camera, showing alternative positioning of a switch and representative alternative rotation of a rotary horizontal adjustment controller.

FIG. 2B is a back perspective view of an embodiment of an integrated hands free, POV action sports digital video camera, showing a representative alternative number of rail cavities and an optional detent within a rail cavity.

FIG. 3 is a cross-sectional side view of an embodiment of an integrated hands-free, POV action sports digital video camera.

FIG. 4 is an exploded view of mechanical components of an embodiment of an integrated hands-free, POV action sports digital video camera.

FIG. 5 is an exploded view of optical and mechanical components of an integrated hands-free, POV action sports digital video camera.

FIGS. 6A and 6B are fragmentary cross-sectional views of the lens system of the camera of FIG. 5, showing, respectively, a standard lens and the standard lens fitted with a lens filter.

FIG. 7 is a partly exploded view of a versatile mounting system demonstrating ease of adjustment of camera mount orientation coupled with ease of camera detachment with retention of the mount orientation.

FIG. 8 is a front perspective view of a standard mount, employing a rail plug having two rails and two detents.

FIGS. 9A, 9B, 9C, and 9D are, respectively, back elevation, front elevation, side elevation, and top plan views of the versatile mounting system, demonstrating the matable relationship between the camera of FIGS. 1A-1E with the standard mount shown in FIG. 8.

FIGS. 10 and 11 are, respectively, perspective and top plan views of a mounting system comprising a rotating circular rail plug set in a base mount configured with a locking feature.

FIGS. 12 and 13 are, respectively, perspective and top plan views of the base mount of FIGS. 10 and 11.

FIGS. 14A, 14B, 14C, 14D, and 14E, are, respectively, perspective, top plan, end elevation, side elevation, and bottom plan views of a slidable lockable member installed in the base mount of FIGS. 12 and 13.

FIG. 15 is an exploded view of the mounting system of FIGS. 10 and 11, to which is attached an attaching mechanism.

FIGS. 16A, 16B, 16C, and 16D are front perspective views of the digital video camera of FIGS. 2A and 2B, showing its lens set in a vertical position, with the camera housing rotated 90° counter-clockwise, not rotated, rotated 90° clockwise, and rotated 180° to an inverted position, respectively, relative to the vertical position. FIG. 16E is a front elevation view of the digital video camera in the orientation of FIG. 16B annotated with dimension lines indicating ranges of angular displacement of a horizontal image plane achievable by manual rotation of the rotary horizontal adjustment controller.

FIGS. 17A and 17B are, respectively, front perspective and top plan views of the digital video camera of FIGS. 2A and 2B with its slidable switch activator in a recording ON slide setting position.

FIGS. 18A and 18B are, respectively, front perspective and top plan views of the digital video camera of FIGS. 2A and 2B with its slidable switch activator in a recording OFF slide setting position.

FIG. 19 is a partly exploded view of the digital video camera of FIGS. 17A, 17B, 18A, and 18B.

FIGS. 20A and 20B show, respectively, perspective and exploded views of a GPS assembly that includes a GPS patch antenna and GPS receiver module to provide GPS functionality in the digital video camera of FIGS. 17A, 17B, 18A, and 18B.

FIG. 21 is a simplified block diagram showing an implementation of wireless technology in the digital video camera of FIGS. 17A, 17B, 18A, and 18B.

FIG. 22 is a flow diagram showing the pairing of two devices by Bluetooth® wireless connection.

FIG. 23 is a flow diagram showing an example of pairing a Bluetooth®-enabled microphone and the digital video camera of FIGS. 17A, 17B, 18A, and 18B.

FIG. 24 is a flow diagram showing a camera mounting position adjustment procedure carried out by a helmet-wearing user to align a helmet-mounted digital video camera of FIGS. 17A, 17B, 18A, and 18B.

FIG. 25 is a flow diagram showing a manual lighting level and color settings adjustment procedure.

FIG. 26 is a flow diagram showing an automatic lighting level and color settings adjustment procedure carried out by a user after completing the camera mounting position adjustment of FIG. 24.

FIG. 27 shows two of the digital video cameras of FIGS. 17A, 17B, 18A, and 18B aimed at a common color chart.

FIG. 28 is a flow diagram showing the digital video camera of FIGS. 17A, 17B, 18A, and 18B and a mobile controller device paired by Bluetooth® wireless connection and cooperating to accomplish without security the pass-through of data from a second Bluetooth®-enabled digital video camera.

FIG. 29 is a hybrid flow diagram and pictorial illustration of a mobile controller device paired by Bluetooth® wireless data and control command connection to two digital video cameras of FIGS. 17A, 17B, 18A, and 18B to implement a remote Start/Stop capability for multiple cameras.

FIG. 30 is a flow diagram showing an example of pairing two digital video cameras of 17A, 17B, 18A, and 18B by Bluetooth® wireless connection through a mobile controller device.

FIG. 31 is a block diagram showing the post-processing procedure of synchronizing audio data produced by a wireless microphone and hard-wired microphone incorporated in the digital video camera of FIGS. 17A, 17B, 18A, and 18B.

FIG. 32 is a simplified block diagram showing the processing of a single track of data from one data source.

FIG. 33 is a simplified block diagram showing the processing of multiple tracks of data from multiple data sources.

FIGS. 34-36 are respective front, side, and plan views of an embodiment of a camera accessory.

FIG. 37 is a top, front, right side isometric view of the camera accessory shown in FIGS. 34-36.

FIG. 38 is an exploded view of an embodiment of the camera accessory shown in FIGS. 34-36.

FIGS. 39-41 are respective front, side, and plan views showing an embodiment of a camera accessory attached to a digital video camera.

FIG. 42 is a top, front, right side isometric view of the camera accessory shown in FIGS. 39-41 attached to a digital video camera.

FIGS. 43-47 are a top, front, right side isometric views of the camera accessory shown in FIGS. 39-41 attached to a digital video camera with certain components removed from the camera accessory.

FIG. 48 is a schematic diagram showing an embodiment of the camera accessory employing gyroscopic sensors and an accelerometer.

FIG. 49 is a flow diagram illustrating an embodiment of a routine implemented by a controller of the accessory.

FIGS. 50A-50C are perspective views of another embodiment of the camera accessory.

FIGS. 51A-51D are exploded views of an embodiment of the camera accessory shown in FIGS. 50A-50C.

FIGS. 52A and 52B are perspective views of an embodiment of the front of the camera accessory shown in FIGS. 50A-50C.

FIG. 53 is a perspective view of an embodiment of the housing of the camera accessory shown in FIGS. 50A-50C.

FIG. 54 is a perspective view of an embodiment of a back cover of the camera accessory shown in FIGS. 50A-50C.

FIG. 55 is a perspective view of an embodiment of a gear drive member of the camera accessory shown in FIGS. 50A-50C.

FIGS. 56A and 56B are perspective views of an embodiment of a gear drive member of the camera accessory shown in FIGS. 50A-50C.

FIGS. 57A and 57B are perspective views of an embodiment of an actuator gear of the camera accessory shown in FIGS. 50A-50C.

FIGS. 58A, 58B, and 59A-59C are perspective views of an embodiment of skeletal frame members of the camera accessory shown in FIGS. 50A-50C.

FIGS. 60A and 60B are perspective views of an embodiment of a frame gear of the camera accessory shown in FIGS. 50A-50C.

### DETAILED DESCRIPTION

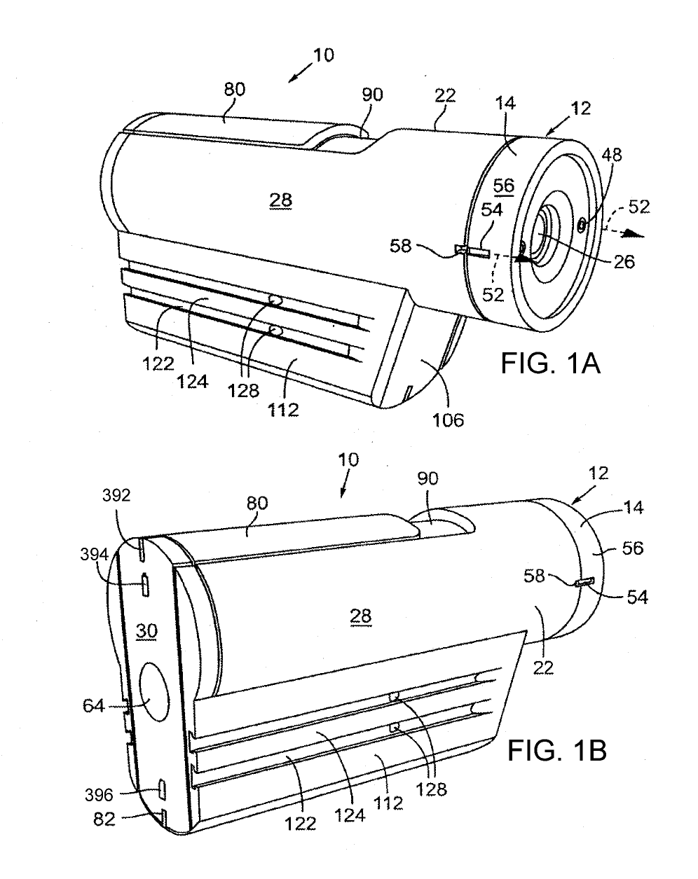

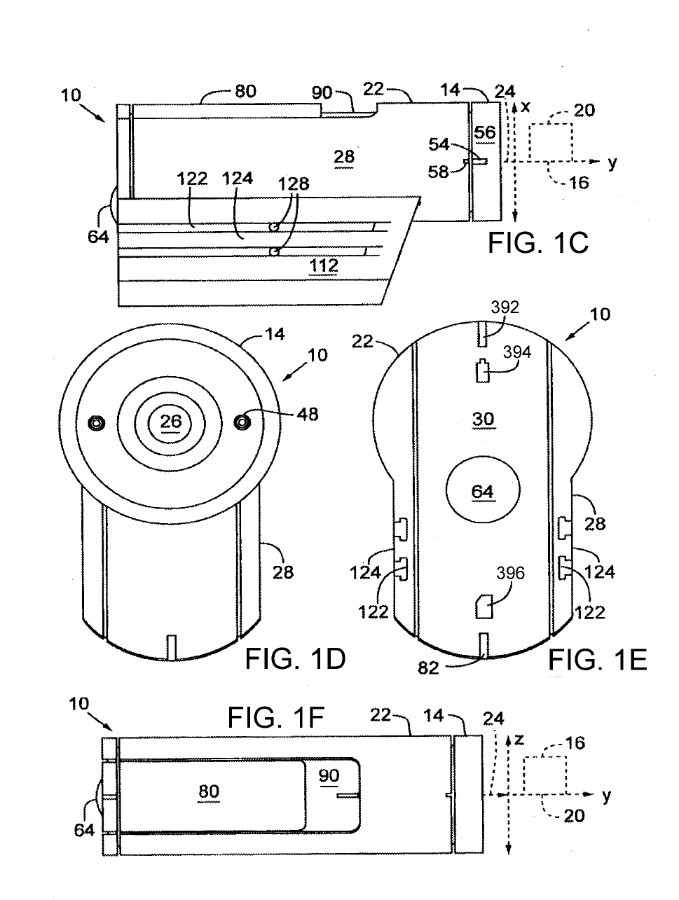

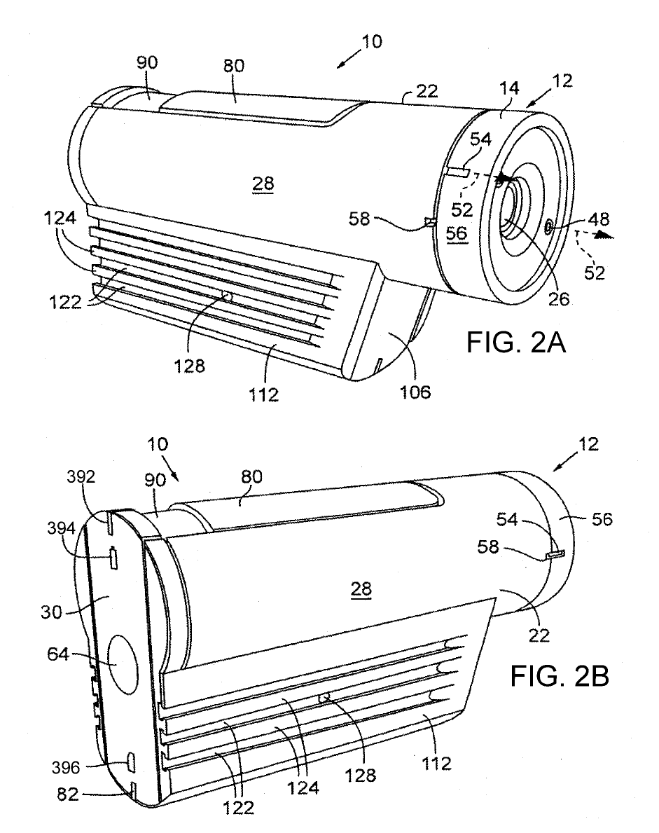

FIGS. 1A, 1B, 1C, 1D, 1E, and 1F are, respectively, front perspective, back perspective, side elevation, front elevation, back elevation, and top plan views of an embodiment of a digital video camera 10, such as an integrated hands-free, wearable, first-person, and/or POV action sports camera. FIGS. 2A and 2B are front and back perspective views of, respectively, an alternative configuration and an alternative embodiment of the digital video camera 10. For purposes of this description, the term “camera” is intended to cover camcorder(s) as well as camera(s). An example of such a digital video camera 10 is included in the Contour 1080p™ system, marketed by Contour, Inc., of Seattle, Wash.

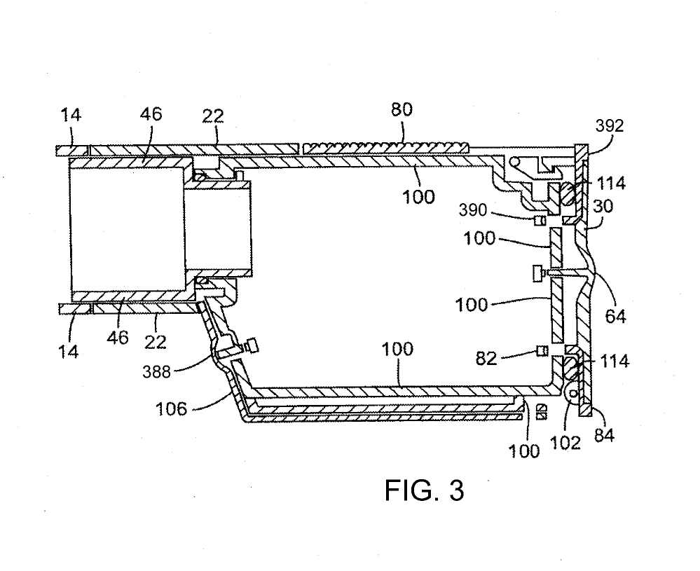

FIGS. 3, 4, 5, 6A, and 6B show optical and mechanical components of the digital video camera 10. With reference to FIGS. 1A-1F, 2A, 2B, 3, 4, 5, 6A, and 6B, some embodiments of the digital video camera 10 include a manual horizon adjustment control system 12 including a manual horizon adjustment control for adjusting an orientation of a horizontal image plane 16 of an image recorded by an image sensor 18 with respect to a housing plane 20 (along a vertical cross-section) of a camera housing 22. An embodiment of the image sensor 18 can be a CMOS image capture card that provides for minimum illumination of 0.04 Lux @ f/1.2 and offers high sensitivity for lowlight operation, low fixed pattern noise, anti-blooming, zero smearing, and low power consumption.

With reference to FIGS. 1A, 1C, 1F, 2A, 4, and 5, in some embodiments, the manual horizon adjustment control is a rotary controller 14 that rotates about a control axis 24 such that the manual rotation of the rotary controller 14 changes the orientation of the horizontal image plane 16 with respect to the housing plane 20. In some embodiments, the control axis 24 can correspond to a longitudinal axis (e.g., the axis that runs from the front of the camera 10 to the back of the camera 10 and/or from the front of the accessory 700 to the back of the accessory 700). The manual horizon adjustment control can be used to offset the horizontal image plane 16 with respect to the pitch, yaw, and/or roll of the mounting position of the camera housing 22.

In some embodiments, the rotary controller 14 can be positioned about a lens 26 and cooperate with a lens shroud 32 to support the lens 26 within the camera housing 22 such that manual rotation of the rotary controller 14 rotates the lens 26 with respect to the camera housing 22. In other embodiments, the lens 26 can remain fixed with respect to the camera housing 22 even though the rotary controller 14 rotates around lens 26. In some embodiments, the lens 26 can have a 3.6 mm focal length, four element glass lens with a 135° viewing angle and a focal length covering a large range, such as from arm's length (e.g., 500 mm) to infinity, which focuses visual information onto the image sensor 18 at a resolution such as at 1920×1080. Skilled persons will appreciate that a variety of types and sizes of suitable lenses are commercially available.

In some embodiments, the image sensor 18 is supported in rotational congruence with the orientation of the rotary controller 14 such that manual rotation of the rotary controller 14 rotates the image sensor 18 with respect to the housing plane 20 of the camera housing 22. When the image sensor 18 has a fixed relationship with the orientation of the rotary controller 14, the image data captured by the image sensor 18 do not require any post-capture horizon adjustment processing to obtain play back of the image data with a desired horizontal image plane 16. In particular, the rotary controller 14 can be set to a desired horizontal image plane 16, and the image sensor 18 will capture the image data with respect to the orientation of the horizontal image plane 16. In some embodiments, the image sensor 18 can remain fixed with respect to the camera housing 22 even though the rotary controller 14 rotates around the image sensor 18.

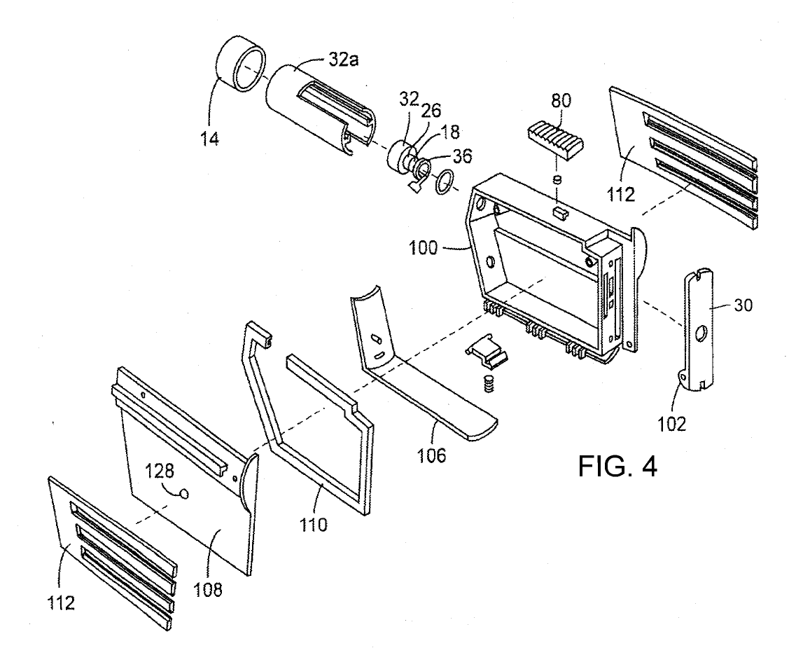

With reference to FIGS. 4, 5, 6A, and 6B, in some embodiments, an optical assembly 34 shows how the image sensor 18 and the lens 26 can be supported in rotational congruence by the cooperation of the lens shroud 32, an internal rotation controller 36, and the rotary controller 14. In some embodiments, the rotary controller 14 can be separated from the camera housing 22 by a gap 37 to facilitate the rotation of the rotary controller 14 with respect to the camera housing 22.

A lens cap holder 38 can be secured to the rotary controller 14 by screw threads and cooperates with an O-ring 40a and to provide support for a lens cover 42 (such as a piece of glass). A lens holder 44 and a lens assembly holder 46 can also be employed to support the lens 26 in a desired position with respect to the other components in the optical assembly 34. The lens assembly holder 46 can be secured to the lens cap holder 38 by screw threads and an O-ring 40b. An O-ring or bearings 43 can be employed between the lens assembly holder 46 and a main housing 100 to facilitate the rotation of the lens assembly holder 46 about the control axis 24 with respect to the main housing 100. A set screw 45 can be employed to secure the lens assembly holder 46 of the optical assembly 34 to the main housing 100 without impeding the rotation of the lens assembly holder 46 or the components within it. In some embodiments, the rotary controller 14, the lens cap holder 38, the O-ring 40a, the lens cover 42, the lens shroud 32, laser sources 48, the lens 26, the lens holder 44, the image sensor 18, the internal rotation controller 36, the O-ring 40b, and the lens assembly holder 46 of the optical assembly 34 can rotate together. Skilled persons will appreciate that several of these components can be fixed with respect to camera housing 22 or their synchronized rotation can be relaxed. For example, the lens cover 42, the lens 26, and the lens holder 44 need not rotate. It will also be appreciated that the optical axis from the image sensor 18 through the lens 26 can be collinear with the control axis 24.

With reference to FIG. 6B, the rotary controller 14 can support a lens filter or other lens component, or the rotary controller 14 can include screw threads or other means to enable attachment of additional or alternative lens components.

In some embodiments, the rotary controller 14 cooperates with an encoder to orient the image sensor 18 to a desired horizontal image plane 16. Alternatively, the encoder can guide post-capture horizon adjustment processing to adjust the horizontal image plane 16 of the captured image so that it is transformed to play back the image data with the encoded horizontal image plane 16.

In some embodiments, the rotary controller 14 is positioned in one or both of an arbitrary location away from the lens 26 and an arbitrary relationship with the position of the image sensor 18. For example, the rotary controller 14 can be positioned on a side 28 of the camera housing 22 or on a back door 30, and the rotary controller 14 can remotely control the orientation of the image sensor 18 or can control an encoder. Skilled persons will appreciate that an arbitrarily located manual horizon adjustment control need not be of a rotary type and can be of an electronic instead of a mechanical type.

In some embodiments, the rotary controller 14 provides greater than or equal to 90° rotation of the horizontal image plane 16 with respect to the housing plane 20 of the camera housing 22 in each of the clockwise and counterclockwise directions. In some embodiments, the rotary controller 14 provides greater than or equal to 135° rotation of the horizontal image plane 16 with respect to the housing plane 20 of the camera housing 22 in each of the clockwise and counterclockwise directions. In some embodiments, the rotary controller 14 provides greater than or equal to 180° rotation of the horizontal image plane 16 with respect to the housing plane 20 of the camera housing 22 in each of the clockwise and counterclockwise directions. In one example, the rotary controller 14 provides 180° plus greater than or equal to 6° of additional rotation in each direction, providing at least a 360° rotation of the horizontal image plane 16 with respect to the housing plane 20. This adjustability includes embodiments in which the orientation of the rotary controller 14 is in congruence with the orientation of the image sensor 18, as well as embodiments employing an encoder. In some embodiments, both the lens 26 and the image sensor 18 rotate together for at least 270°, and, in some cases, at least 360°, within a pivoting hermetically sealed capsule. This means that, no matter how an operator mounts the digital video camera 10, the image sensor 18 can be rotated to capture a level world. It will be appreciated that the available degree of rotation need not be the same in the clockwise and counterclockwise directions.

With reference to FIGS. 2A and 2B, in some embodiments, a rotation indicator 54 is provided on an exterior surface 56 of the rotary controller 14. The rotation indicator 54 can take the form of a horizontal notch or raised bar that can be of a different color from the color of the camera housing 22. The camera housing 22 can have set in a fixed position a notch or raised bar 58 that is similar to or smaller than the rotation indicator 54. The rotation indicator 54 and the notch or raised bar 58 can be of the same color or of different colors. The angular extent of dislocation between the rotation indicator 54 and the notch 58 provides a physical indication of the amount that the rotary controller 14 is displaced from its “home” position with respect to the camera housing

In some embodiments, the rotation indicator 54 and the horizontal notch 58 are in a collinear alignment (in the “home” position) when the horizontal image plane 16 is perpendicular to the housing plane 20. Thus, if the digital video camera 10 were set on a level horizontal surface and the two notches were collinear, the horizontal image plane 16 would be horizontal.

With reference to FIGS. 1A, 1C, 1D, 1F, 2A, 5, and 6, in some embodiments, one or more laser sources 48 are fitted within the rotary controller 14, are oriented with the horizontal image plane 16, and are capable of projecting light emission(s) to define a horizontal projection axis or plane 52 that is parallel to or coplanar with the horizontal image plane 16. Thus, manual rotation of the rotary controller 14 changes the orientation of the horizontal projection axis 52 with respect to the housing plane 20 as the orientation of the horizontal image plane 16 is changed with respect to the horizontal projection plane 52. The beam(s) of light forming the horizontal projection plane 52 can be used as a guide by an operator to facilitate adjustment of the horizontal image plane 16 by simple rotation of the rotary controller 14 after the camera housing 22 has been mounted.

In some embodiments, a single laser source 48 can employ beam shaping optics and or a beam shaping aperture, filter, or film to provide a desired beam shape such as a line, lines of decreasing or increasing size, or a smiley face. In some embodiments, only a single beam shape is provided. In some embodiments, multiple beam shapes are provided and can be exchanged such as through manual or electronic rotation of a laser filter. Skilled persons will appreciate that two or more laser sources 48 can be outfitted with beam shaping capabilities that cooperate with each other to provide the horizontal projection plane 52 or an image that provides the horizontal projection plane 52 or other guidance tool.

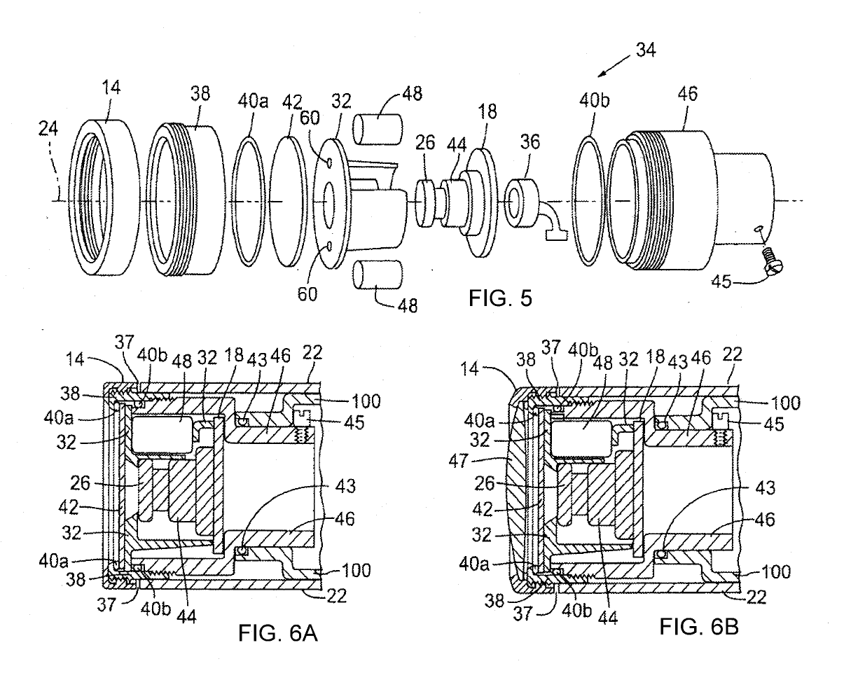

In some embodiments, two laser sources 48 (or two groups of laser sources) are employed to project two beams of light that determine the horizontal projection plane 52. Two laser sources 48 can be mounted on opposite sides of the lens 26 such that their positions determine a laser mounting axis that bisects the lens 26. In some embodiments, the lens shroud 32 provides support for the laser sources 48 such that they are positioned to emit light through apertures 60 in the lens shroud 32 (FIG. 5). In some embodiments, an alternative or additional optical support barrel, rotatable frame, or imaging receptacle can support the laser source 48 and the other optical components. It will be appreciated that the imaging receptacle need not be cylindrical to provide rotation independent of the orientation of the camera housing 22. For example, the imaging receptacle can have a dodecahedral cross section.

The laser sources 48 can be diode lasers that are similar to those used in laser pointers. The laser sources 48 can project the same wavelength(s) of light. In some embodiments, an operator can select between a few different wavelengths, such as for red or green light, depending on contrast with the background colors. In some embodiments, two wavelengths can be projected simultaneously or alternately. For example, four laser sources can be employed with red and green laser sources 48 positioned on each side of the lens 26 such that red and green horizontal projection planes 52 are projected simultaneously or alternately in the event that one of the colors does not contrast with the background.

In some embodiments, the laser sources 48 can be responsive to a power switch or button 64, which in some examples can be located on a back door 30 of the camera housing 22. A rotation of the horizon adjustment control system 12 or the rotary controller 14 can provide the laser sources 48 with an ON condition responsive to a timer, which can be preset such as for five seconds or can be a user selectable time period. Alternatively, a single press of the button 64 can provide the laser sources 48 with an ON condition with a second press of the button 64 providing an OFF condition. Alternatively, a single press of the button 64 can provide an ON condition responsive to a timer, which can be preset such as for five seconds or can be a user selectable time period. Alternatively, the button 64 can require continuous pressure to maintain laser sources 48 in an ON condition. The button 64 can also control other functions such as standby mode. Skilled persons will appreciate that many variations are possible and are well within the domain of skilled practitioners.

Skilled persons will also appreciate that any type of video screen, such as those common to conventional camcorders, can be connected to or be a part of the camera housing 22. Such video screen and any associated touch display can also be used as feedback for orientation in conjunction with or separately from the laser sources 48. Skilled persons will appreciate that the video screen can take the form of a micro-display mounted internally to the camera housing 22 with a viewing window to the screen through camera housing 22 or can take the form of an external LCD screen.

With reference to FIGS. 1A, 1B, 1C, 1F, 2A, 2B, 3, and 4, in some embodiments, the digital video camera 10 has a manually operable switch activator 80 that controls one or both of the recording condition of the image sensor 18 and conveyance of the acquired image data to a data storage medium, such as on a two gigabyte Micro SD card. In some embodiments, the digital video camera 10 is designed to use pulse power to conserve battery life while monitoring the switch activator 80. When the switch activator 80 is positioned to the ON position, the pulse power system is instructed to provide full power to the electronics and begin recording immediately; similarly, when the switch activator 80 is positioned to the OFF position, the pulse power system is instructed to cut power to the electronics and stop recording immediately.

In some embodiments, when the switch activator 80 is slid or toggled, it moves a magnetic reed that is recognized from an impulse power sensor. Once the sensor recognizes the magnetic reed has been toggled to the ON position, the pulse power system is then triggered to power up most or all of the electronics of the digital video camera 10, including all of the electronics required for recording as well as selected other electronics or simply all the electronics. Once full power is provided to the system electronics, a feed from image sensor 18 begins encoding and writing to the data storage medium. As soon as the first frames are written to the data storage medium, a signal is sent to an LED 82 to indicate via a light pipe 84 that the digital video camera 10 is recording. Thus, activation of switch activator 80 initiates recording nearly instantaneously.

In some embodiments, the switch activator 80 powers up the electronics and initiates recording from a standby mode such as after the button 64 has been pushed to activate the pulse power mode. In other embodiments, the switch activator 80 powers up the electronics and initiates recording directly without any pre-activation. In some embodiments, a video encoder that cooperates with the image sensor 18 and a microprocessor provides instructions to the video encoder. In some embodiments, the switch activator 80 is adapted to substantially simultaneously control supply of power to the microprocessor, the image sensor 18, and the video encoder, such that when the switch activator 80 is placed in the ON position the microprocessor, the image sensor 18, and the video encoder all receive power substantially concurrently and thereby substantially instantaneously initiate a video data capturing operation.

In some embodiments, an audio encoder cooperates with a microphone 90, and the microprocessor provides instructions to the audio encoder. In some embodiments, the switch activator 80 is adapted to substantially simultaneously control the supply of power to the microphone 90 and the audio encoder such that when the switch activator 80 is placed in the ON position, the microprocessor, the microphone 90, and the audio encoder all receive power substantially concurrently and thereby substantially instantaneously initiate an audio data capturing operation.

In some embodiments, when the switch activator 80 is placed in the OFF position, the microprocessor, image sensor 18, and the video encoder all cease to receive power substantially concurrently and thereby substantially instantaneously cease the video data capturing operation. In some embodiments, when the switch activator 80 is placed in the OFF position, the microprocessor, the microphone 90, and the audio encoder all cease to receive power substantially concurrently and thereby substantially instantaneously cease the audio data capturing operation.

In some embodiments, the microprocessor, the image sensor 18, the video encoder, the microphone 90, and the audio encoder all receive power substantially concurrently and thereby substantially instantaneously initiate the video data and audio data capturing operations. In some embodiments, the microprocessor, the image sensor 18, the video encoder, the microphone 90, and the audio encoder all cease to receive power substantially concurrently and thereby substantially instantaneously cease the video data and audio data capturing operations.

In some embodiments, the switch activator 80 controls supply of power to additional electronics such that the additional electronics are deactivated when the switch activator 80 is in the OFF position and such that the additional electronics are activated when the switch activator 80 is in the ON position.

Skilled persons will appreciate that the switch activator 80 can be designed to have more than two slide settings. For example, in addition to ON and OFF settings for recording, the switch activator 80 can provide an intermediate setting to activate the laser sources 48, to activate one or more status indicators, or initiate other functions in the digital video camera 10.

The use of a magnetic reed switch as an embodiment for the switch activator 80 prevents water or other fluids from entering through the camera housing 22. Skilled persons will appreciate that other waterproof ON/OFF switch designs are possible. In some embodiments, the digital video camera 10 also employs a waterproof microphone 90, such as an omni-directional microphone with a sensitivity (0 dB=1V/Pa, 1 KHz) of −44±2 dB and a frequency range of 100-10,000 Hz, for capturing audio data and providing them to the data storage medium or to a second data storage medium. Alternatively, the camera housing 22 can include breathable, watertight materials (such as Gore-Tex™) to prevent the egress of water without requiring a waterproof microphone 90. Skilled persons will appreciate microphones with a large variety of operational parameters that are suitable for the microphone 90 are commercially available or can be manufactured to suit desired criteria.

In some embodiments, the microphone 90 is positioned beneath the switch activator 80 such that switch activator 80 covers the microphone 90 whenever the switch activator 80 is in the OFF position and such that the switch activator 80 exposes the microphone 90 whenever the switch activator 80 is in the ON position. The audio data capturing operation can be deactivated when the switch activator 80 is in the OFF position and that the audio data capturing operation can be activated when the switch activator 80 is in the ON position. The ON and OFF conditions of the audio data capturing operation can be controlled by the switch activator 80 in conjunction with the ON and OFF conditions of the video capturing operation.

With reference to FIGS. 3 and 4, in some embodiments, the camera housing 22 includes the main housing 100 that supports the switch activator 80, a front and bottom trim piece 106, and a back door 30 which is connected to the main housing 100 through a hinge 102. In some embodiments, the back door 30 can be removable through its hinge 102 to allow connection of accessories to the main housing 100 for extended functionality. The back door 30 can provide an area of thinner material to permit compression of the button 64. Gaskets 114 can be seated between the main housing 100 and the back door 30 to provide waterproofing. A housing cover 108 can be connected to the main housing 100 through a rubber gasket 110 that also enhances the waterproof characteristics of the camera housing 22.

Side caps 112 can be ultrasonically welded to the exterior surfaces of a housing cover 108 and the lower portion of the main housing 100, which form the lower portions of the sides 28 of the camera housing 22. In some embodiments, the camera housing 22 is made from brushed aluminum, baked fiberglass, and rubber. In particular, the main housing 100, the housing cover 108, and the side caps 112 can be made from aluminum. Front and bottom trim piece 106 can also be ultrasonically welded to the main housing 100.

With reference to FIGS. 1A, 1B, 2A, 2B, 4, and 7, in some embodiments, the digital video camera 10 includes part of a mounting system 120 that has two or more housing rail cavities 122 and two or more interleaved housing rails 124 on each of the sides 28 of the camera housing 22 for engaging a versatile mount 126. An example of such a mounting system 120 is the Trail™ mounting system, marketed by Contour, Inc., of Seattle, Wash.

The housing rail cavities 122 and the housing rails 124 can be formed by cut outs in the side caps 112 that are mounted to the main housing 100. In some embodiments, the digital video camera 10 is bilaterally symmetrical and has an equal number of housing rail cavities 122 on each of the side caps 112 and an equal number of housing rails 124 on each of the side caps 112. In some embodiments, the digital video camera 10 can, for example, provide two housing rail cavities 122 (such as shown in FIGS. 1A and 1B) or three housing rail cavities 122 in each of the side caps 112 (such as shown in FIGS. 2A and 2B). Skilled persons will appreciate, however, that in some embodiments, the digital video camera 10 need not be symmetrical and can have unequal numbers of the rail cavities 122 or the housing rails 124 on its different side caps 112.

In some embodiments, the rail cavities 122 have a “T”-like, wedge-like, or trapezoid-like cross-sectional appearance. Skilled persons will appreciate that the dimensions of the stem or lateral branches of the “T” can be different. For example, the stem can be thicker than the branches, or one or more of the branches can be thicker than the stem; similarly, the stem can be longer than the branches, and one or more of the branches can be longer than the stem. The cross-sectional shapes can have flat edges or corners, or the edges or corners can be rounded. Skilled persons will also appreciate that numerous other cross-sectional shapes for the rail cavities 122 are possible and that the cross-sectional shapes of different housing rail cavities 122 need not be the same whether in the same side cap 112 or in different side caps 112. Similarly, the housing rail cavities 122 can have different lengths and the housing rails 124 can have different lengths. The bottom of the trim piece 106 can be alternatively or additionally fitted with the housing rail cavities 122 and/or the housing rails 124.

In some embodiments, one or more of the housing rail cavities 122 can contain one or more bumps or detents 128. In some embodiments, each side 28 of the camera housing 22 contains at least one bump or detent 128. In some embodiments, each housing rail cavity 122 contains at least one bump or detent 128. In some examples, however, only a single housing rail cavity 122 on each side 28 contains a bump or detent 128. Skilled persons will appreciate that the different sides 28 need not contain the same number of bumps or detents 128.

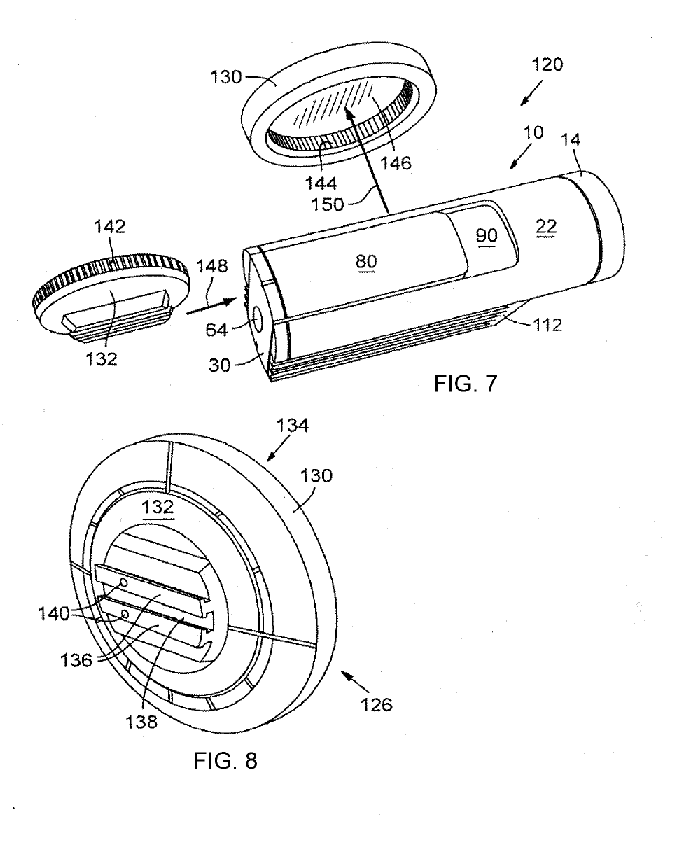

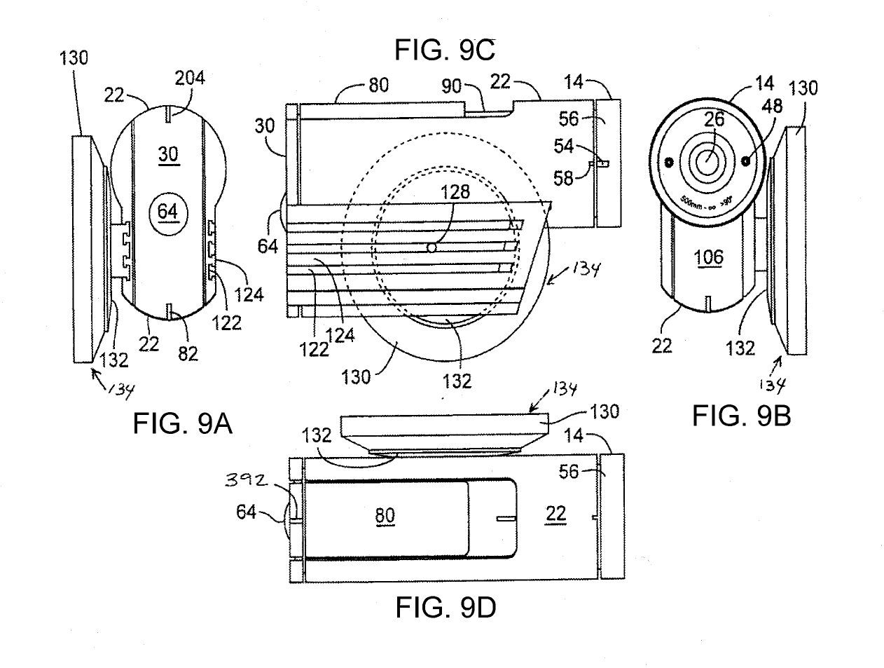

FIG. 7 shows a base mount 130 and a rail plug 132 that fit together to form a flat surface mount 134 shown in FIG. 8. FIGS. 9A-9D (FIG. 9) depict different views of the camera housing 22 mated with the flat surface mount 134. With reference to FIGS. 7-9, the rail plug 132 contains one or more mount rails 136 that are adapted to mate with the housing rail cavities 122 on the camera housing 22. Similarly, the rail plug 132 contains one or more mount rail cavities 138 that are adapted to mate with the housing rails 124 on the camera housing 22. The mount rails 136 can have the same or different cross-sectional shapes as those of the housing rails 124, and the mount rail cavities 138 can have the same or different cross-sectional shapes as those of the housing rail cavities 122. In some embodiments, the rails 124 and 136 and the cavities 122 and 138 have the same cross-sectional profiles.

In some embodiments, one or more of mount rails 136 on the rail plug 132 can contain one or more detents or bumps 140. In some embodiments, each mount rail 136 contains at least one detent or bump 140. In some examples, however, only a single mount rail 136 contains a detent or bump 140. The detents or bumps 140 are adapted to mate with the bumps or detents 128 such that if the camera housing 22 has detents 128 then the rail plug 132 has the bumps 140 or if the camera housing 22 has the bumps 128 then the rail plug 132 has the detents 140. Skilled persons will appreciate that in some alternative embodiments, the housing rails 124 have bumps or detents 128 and the mount rail cavities 138 have detents or bumps 140.

The versatile mounting system 120 provides for ease of mounting and orientation of the digital video camera 10 with ease of detachment of the digital video camera 10 with retention of the mounted orientation. In some embodiments, the base mount 130 can have a very small footprint and can be attached to a surface with an adhesive pad designed for outdoor use. After the base mount 130 has been attached to a surface, the rail plug 132 can be inserted into or detached from the base mount 130.

In some embodiments, the rail plug 132 has a circumferential saw-toothed edge 142 that is mated to a saw tooth-receiving inside edge 144 of a base mount cavity 146 adapted to receive the rail plug 132. In some embodiments, the rail plug 132 has a compression fit within the base mount 130. In some embodiments, hook and loop double-toothed Velcro™ can be used instead of or in addition to a compression fit technique to further secure the rail plug 132 within the base mount 130.

The mount rails 136 of the rail plug 132 can slide into the housing rail cavities 122 of the camera housing 22 as the mount rail cavities 138 of the rail plug 132 slide onto the housing rails 124 of the camera housing 22 as indicated by a direction arrow 148 (FIG. 7) to secure the rail plug 132 to the camera housing 22. The mated detents and bumps 128 and 140 can be engaged to prevent unintended lateral movement of the rail plug 132 with respect to camera housing 22. The rail plug 132 with the attached digital video camera 10 can be rotated from zero to 360 degrees about an axis perpendicular to the base mount 130 to capture a desired viewing angle. Then, the rail plug 132 can be inserted or re-inserted into the base mount 130 as indicated by a direction arrow 150 (FIG. 7). FIG. 9 shows from several different views how the digital video camera 10, the rail plug 132, and the base mount 130 appear when they are mated together.

In some embodiments, the rail plug 132 and the base mount 130 can be made from a hard, but flexible material such as rubber or a polymer with similar properties, but skilled persons will appreciate that the rail plug 132 and the base mount 130 can be made from a hard or soft plastic. Because the base mount 130 can be flexible, it can be attached to a variety of surfaces such as, for example, the surfaces of helmets, snowboard decks, skis, fuel tanks, windows, doors, and vehicle hoods. The type and flexibility of the material of the flat mount 126 can provide a “rubber” dampening effect as well as enhance rail sliding, rail engagement, and plug engagement. The mounting system 120 can also include a runaway leash (not shown).

When recording of an activity is completed, the rail plug 132 with the attached the digital video camera 10 can be disengaged from the base mount 130 for safe storage or data uploading. The base mount 130 can be left attached to the surface and need not be re-attached and/or re-adjusted. Alternatively, the camera housing 22 can be disengaged from the rail plug 132, leaving the rail plug 132 engaged with the base mount 130 so that the original orientation of the mount rails 136 of the rail plug 132 is maintained to permit quick reattachment of the digital video camera 10 without requiring its orientation to be re-adjusted to the base mount 130 or the person, equipment, or vehicle to which the base mount 130 is mounted.

The rail plug 132 can be used as a standalone mount with an adhesive backing, or it can be used in conjunction with or integrated into one or more varieties of base mounts 130. The rail plug 132 can be attached to base mount 130a through the use of an adhesive mounting, through the use of Velcro™, through the use of a screw, through the use of other conventionally known means, or combinations thereof. The mount rails 136 can be formed to provide an aperture 162 to provide access for a screw and screwdriver to mount the rail plug 132 onto the base mount 130.

Such embodiments permit a user to adjust the angle of the digital video camera 10 to be different from the vertical viewing angle of the user. For example, the user can be viewing down at the ground while the digital video camera 10 (and its image sensor 18) captures images straight ahead. In some embodiments, the base mount 130 can include pads to dampen against vibrations and can include retaining tabs to prevent rail plug 132 from being inadvertently jarred loose.

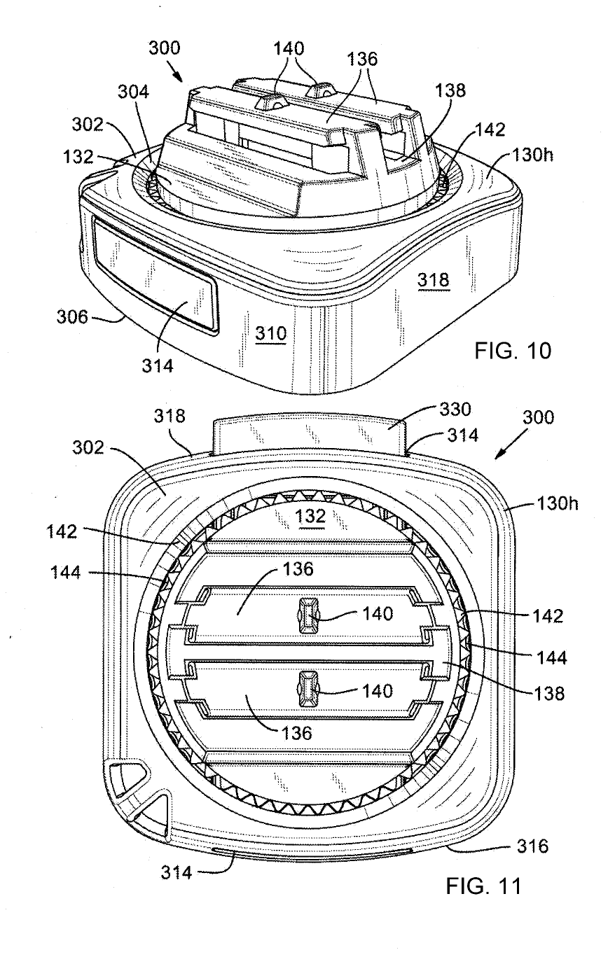

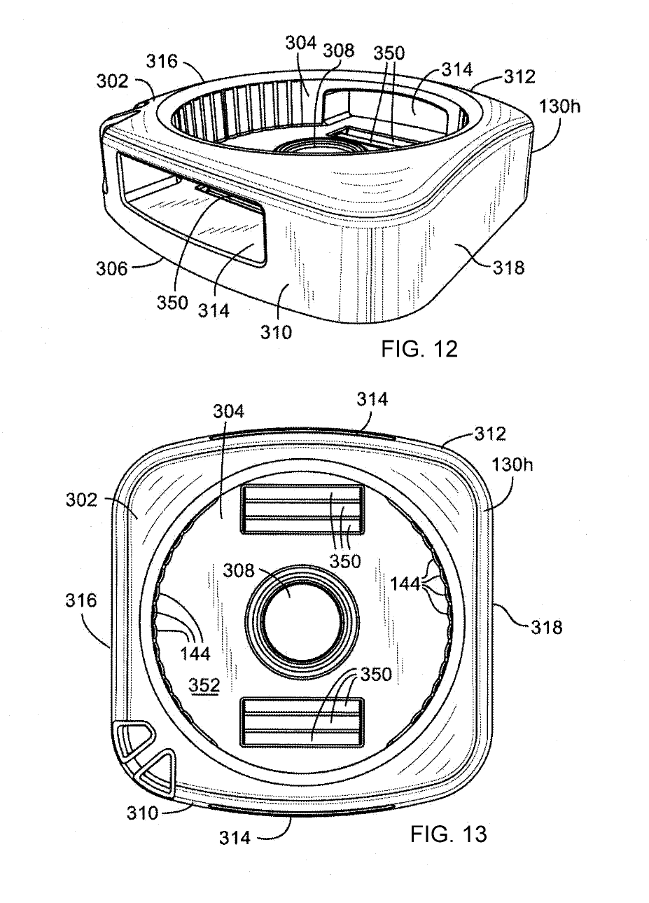

FIGS. 10 and 11 are, respectively, perspective and top plan views of a mounting system 300 that comprises a rotatable circular rail plug 132 set in a base mount 130h configured with a locking feature that allows adjustment of the digital video camera 10 when it is attached to a mounting surface. FIGS. 12 and 13 are, respectively, perspective and top plan views of the base mount 130h. The base mount 130h is of generally rectangular shape and includes in its top wall 302 a large diameter circular opening 304 and in its bottom wall 306 a smaller diameter circular opening 308. The base mount 130h has opposite side walls 310 and 312 through which aligned, generally rectangular slots 314 of the same size are formed and opposite side walls 316 and 318 on the inner surfaces of which spatially aligned saw-tooth-receiving edges 144 are formed. The inner surfaces of the side walls 310, 312, 316, and 318 include arcuate segments that are sized to permit bidirectional ratcheted rotational motion of the circular rail plug 132 when it is set through the circular opening 304 in the base mount 130h with the saw tooth-receiving edges 144 in matable relationship with the circumferential saw-toothed edge 142.

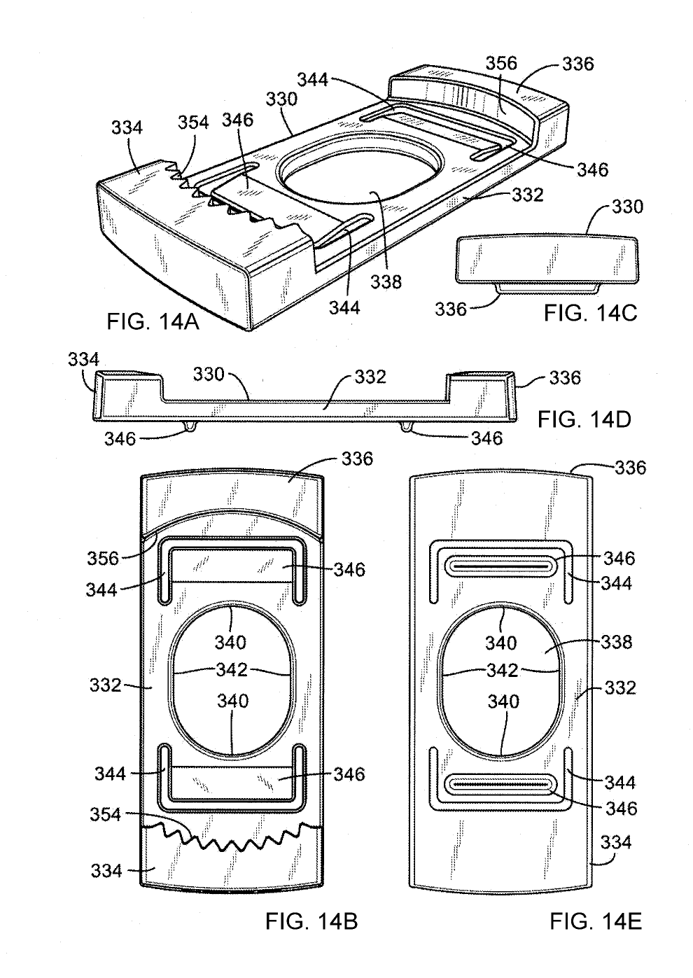

FIGS. 14A, 148, 14C, 14D, and 14E are, respectively, perspective, top plan, end elevation, side elevation, and bottom plan views of a slidable locking member 330 of generally rectangular shape. The slidable locking member 330 is sized to fit within each slot 314 and slidably extend through and project outside either one of side walls 310 and 312 when inserted in both of the slots 314 in the base mount 130h. The locking member 330 is a unitary structure that includes a generally planar center portion 332 positioned between a locking end piece 334 and a non-locking end piece 336. The center portion 332 constitutes a recessed area that is bounded by raised end pieces 334 and 336 and into which the circular rail plug 132 is inserted when the mounting system 300 is assembled. The center portion 332 includes an oblong hole 338 having opposite circular segments 340 separated by straight line segments 342. U-shaped slots 344 cut in the center portion 332 on either side of the oblong hole 338 provide downwardly depending locking tabs 346. The locking tabs 346 are sized and configured to slide across and fit into corresponding grooves 350 in a floor 352 of the base mount 130h. The locking end piece 334 has a serrated arcuate inner surface 354, and the non-locking end piece 336 has a smooth arcuate inner surface 356. The curvatures of arcuate inner surfaces 354 and 356 are complementary to the curvature of the circular rail plug 132.

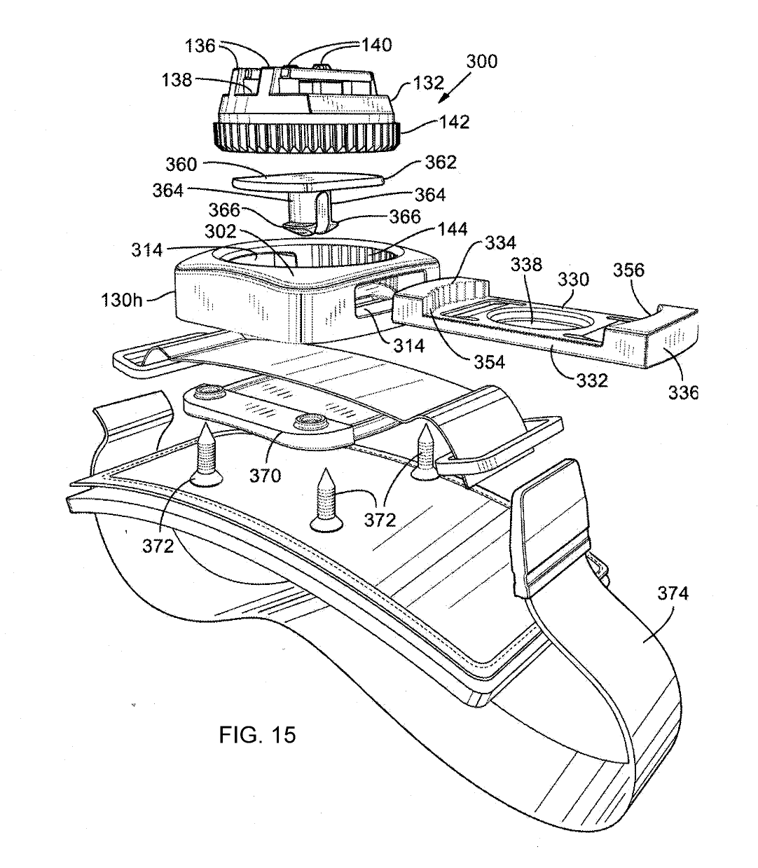

FIG. 15 is an exploded view of the mounting system 300 to which is attached an embodiment of an attaching mechanism. When the mounting system 300 is assembled, the locking member 330 is installed in the base mount 130h with the end pieces 334 and 336 fitted for sliding movement in the slots 314. A plug 360 composed of a top disk 362 and two downwardly depending legs 364 secures the locking member 330 to and limits its range of travel within the slots 314 in the base mount 130h. The top disk 362 fits in a recess in and thereby receives the rail plug 132, and flanges 366 extending from the free ends of the legs 364 secure the plug 360 in the base mount 130h when the free ends of the legs 364 are pushed through the circular opening 308.

The mounting system 300 can operate in the following manner: a user can adjust the angular position of the digital video camera 10, which is operatively connected to the mounting rails 136, by the rotating rail plug 132 within the base mount 130h. To permit such rotation, the user pushes the non-locking end piece 336 to slide the locking member 330 so that the serrated inner surface 354 moves away from and does not engage the saw-toothed edge 142 of the rail plug 132. The legs 364 of the plug 360 contact the boundary of the oblong hole 338 and thereby stop the sliding motion of the locking member 330 with its locking end piece 334 projecting outwardly from its associated slot 314. The locking tabs 346 fit in their corresponding grooves 350 to releasably hold the locking member 330 in its unlocked position. Rotation of the rail plug 132 provides audible, tactile feedback to the user because of the meshing relationship between the saw tooth-receiving edges 144 and the saw-toothed edge 142.

Upon completion of angular position adjustment of the digital video camera 10, the user locks the rail plug 132 in place by pushing the locking end piece 334 to slide the locking member 330 so that the serrated inner surface 354 engages the saw-toothed edge 142 of the rail plug 132. The sliding motion of the locking member 330 stops with its non-locking end piece 336 projecting outwardly from its associated slot 314. The locking tabs 346 fit in their corresponding grooves to releasably hold the locking member 330 in its locked position.

The base mount 130h can be directly mounted to a mounting surface with use of an adhesive. The base mount 130h also can be mated to a variety of mounting surfaces by adding a custom connecting plate, such as a strap-connecting plate 370, with screws 372 or another technique such as adhesive bonding or welding. These connecting plates can alter the shape of the base mount 130h to better connect to shaped surfaces or can include a variety of attaching mechanisms, such as, for example, a strap 374 or a hook.

With reference again to FIGS. 1B, 1E, 2B, and 3, the button 64 (or an additional button 388) can control one or more status indicators such as the LED 82 that indicates via the light pipe 84 that the digital video camera 10 is recording. The button 64 (or the additional button 388) can, for example, also control operation of an LED 390 that indicates through a light pipe 392 the power status of a battery (not shown). In some embodiments, a single push can controls two or more status indicators (or all of the status indicators, and can control the laser sources 48 and a recording standby mode as well).

In some embodiments, the status indicators can provide a different color depending on the status of the item in question. In some embodiments, green, yellow, and red LEDs are used to indicate whether the battery is completely charged, half charged, or nearly depleted. Similarly, in some embodiments, green, yellow, and red LEDs are used to indicate whether the SD memory card is nearly empty, half-empty, or nearly full. In other embodiments, green light indicates greater than or equal to 80% space or charge, yellow light indicates greater than or equal to 30% space or charge, and red light indicates less than 30% space or charge. Skilled persons will appreciate that the number and meaning of colors can be varied. The camera housing 22 can provide symbols indicating what items the light pipes 84 and 392 designate, such as a battery symbol 394 and a memory card symbol 396 on the back door 30.

To facilitate an easier and more manageable process for the video once it has been recorded, the digital video camera 10 can be designed to automatically segment the video into computer and web-ready file sizes. The segment can be automatically determined by the hardware during the recording process without intervention by the user. In some embodiments, software will automatically close a video file and open a new file at predefined boundaries. In some embodiments, the boundaries will be time based, for example, ten minutes for each segment, or size-based, for example 10 MB for each segment. Additionally, the segmentation process can be designed so that file boundaries are based on preset limits or so that the user can adjust the segment length to the user's own desired time. In some embodiments, the video encoder (hardware or software based) will optimize the file boundary by delaying the boundary from the nominal boundary position until a period of time with relatively static video and audio, i.e., when there are minimal changes in motion. Skilled persons will appreciate, however, that in some embodiments, such segmentation can be implemented via software or hardware.

The digital video camera 10 is an all-in-one, shoot and store digital video camcorder and is designed to operate in extreme weather conditions and in a hands free manner. The digital video camera 10 is wearable and designed for rugged environments (water, heat, cold, extreme vibrations), and the Contour 1080p™ system includes application mounts 126 to attach to any person, equipment, or vehicle. The internal components of the digital video camera 10 can be silicon treated, coated, or otherwise insulated from the elements, keeping the digital video camera 10 operational, no matter the mud, the dirt, the snow, and the rain.

Some embodiments of the digital video camera 10 are equipped with wireless connection protocol and global navigation and location determination, such as global positioning system (GPS), technology to provide remote image acquisition control and viewing. The Bluetooth® packet-based open wireless technology standard protocol is used to provide control signals or stream data to the digital video camera 10 and to access image content stored on or streaming from the digital video camera 10. The GPS technology enables tracking of the location of the digital video camera 10 as it records image information. The following describes in detail the implementation of the Bluetooth® protocol and GPS technology in the digital video camera 10.

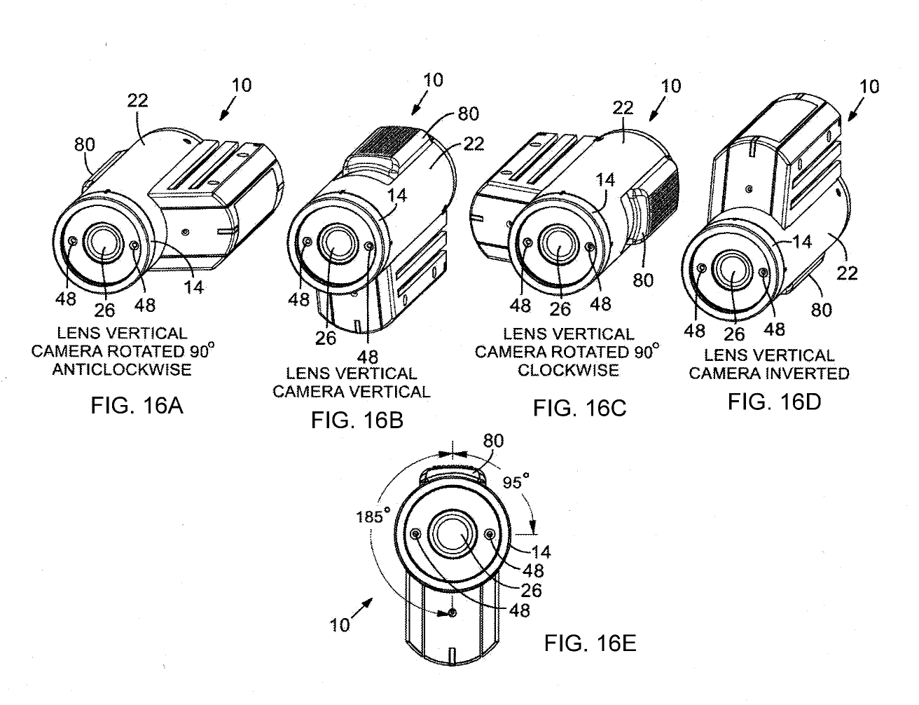

Some embodiments of the digital video camera 10 permit the mounting of the camera housing 22 upside down (or in some other orientation) while retaining the proper orientation of the video images. This can be implemented by mechanical or electrical 180° rotation of image sensor 18 and also the lens 26, as desired, by means of the rotary controller 14. The mechanical rotation is shown in FIGS. 16A, 16B, 16C, 16D, and 16E. FIGS. 16A, 16B, 16C, and 16D are front perspective views of the digital video camera 10 showing the rotary controller 14 set in a vertical position (with the laser sources 48 horizontally aligned), with the camera housing 22 of the digital video camera 10 rotated 90° counterclockwise, not rotated, rotated 90° clockwise, and rotated 180° to an inverted position, respectively, relative to the vertical position. FIG. 16E is a front elevation view of the digital video camera 10 in the orientation of FIG. 16B annotated with dimension lines indicating 1850 counter-clockwise and 950 clockwise ranges of angular displacement of horizontal image plane 16 achievable by manual rotation of the rotary controller 14. The orientation can be flipped prior to signal processing by simply altering the pixel selection or can be flipped during signal processing by simply altering the interpretation of the pixels. The orientation can be automatically controlled by sensing the orientation of the camera housing 22 using a variety of sensors and altering the pixels based on these data.

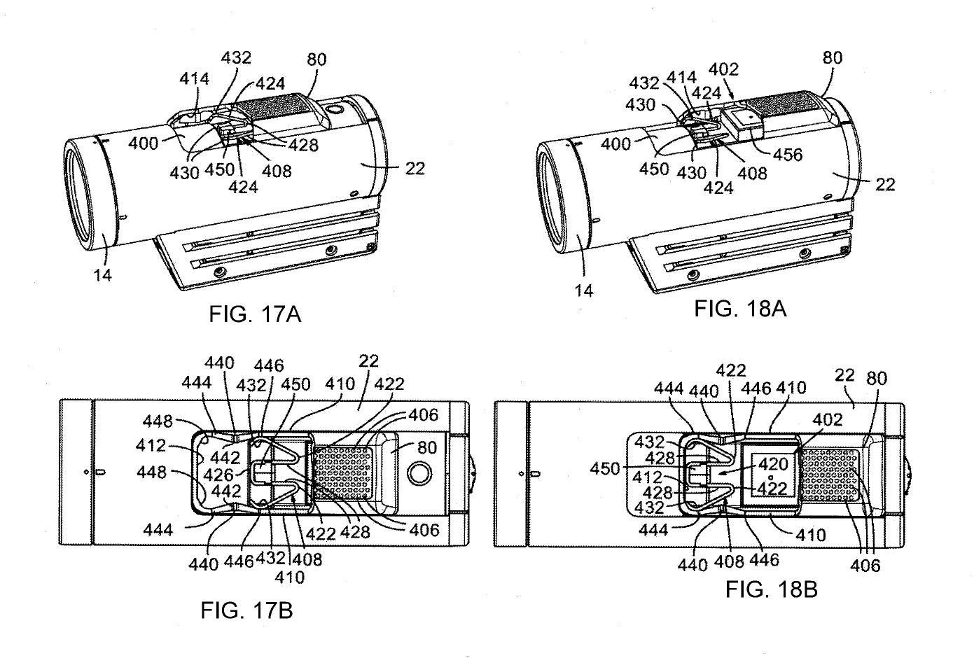

FIGS. 17A and 17B, FIGS. 18A and 18B, FIG. 19, and FIGS. 20A and 20B show the configuration of the digital video camera 10 in which Bluetooth® wireless protocol and GPS technology are implemented to enable remote image acquisition control and viewing. FIGS. 17A and 18A are front perspective views of the digital video camera 10 with the slidable switch activator 80 in its respective recording ON and recording OFF slide setting positions; and FIGS. 17B and 18B are top plan views of the digital video camera 10 with the slidable switch activator 80 in its respective recording ON and recording OFF slide setting positions. A portion of the switch activator 80 is broken away in these drawing figures to reveal the placement of certain internal component parts described in greater detail below.

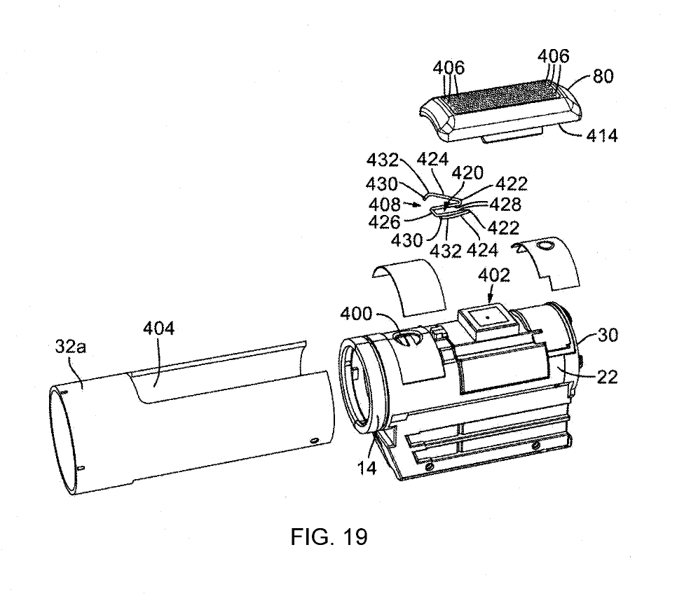

FIG. 19 is a partly exploded view of the digital video camera 10, showing the placement and mounting arrangement of component parts implementing Bluetooth® wireless protocol and GPS receiver technology in the main housing 100 shown in FIGS. 3 and 4. A Bluetooth® wireless module 400 is installed in the main housing 100 at a location proximal to the rotary controller 14. A GPS assembly 402 is installed in the main housing 100 at a location proximal to the back door 30 of the camera housing 28. The camera housing 22 having an open ended slot 404 fits over the main housing 100 in an orientation such that the Bluetooth® wireless module 400 and the upper end of the GPS assembly 402 fit and are thereby exposed within the slot 404. The switch activator 80 provided with a two-dimensional array of circular openings 406 fits over and slides within the slot 404 between the recording ON slide setting position shown in FIGS. 17A and 17B and the recording OFF slide setting position shown in FIGS. 18A and 18B. The openings 406 provide an audible sound passageway to facilitate pickup by the microphone 90 of spoken words or other sound effects.

Common implementations for sliding switches that have long travel entail use of a magnet to pull and hold the switch in its final position or use of a switch mechanism continuously pressed by the user over the full travel distance and provided with a holding mechanism in place in the ON and OFF positions. The digital video camera 10 is equipped with a slide switch mechanism that solves the problems associated with long travel distance. A scissor spring 408 assists in actuating the slidable switch 25 activator 80 over the long travel range between the recording ON and OFF slide setting positions.

FIGS. 17B, 18B, and 19 show a shape of the scissor spring 408 and the manner in which it cooperates with the geometric features of inner side wall surfaces 410 and an inner end wall surface 412 formed in an underside cavity 414 of the switch activator 80. The scissor spring 408 is a one-piece wire member including multiple bends that form a U-shaped center portion 420 having rounded distal ends 422 from each of which a leg portion 424 upwardly extends back toward the center portion 420. The U-shaped center portion 420 includes a base member 426 and two generally parallel side members 428 that terminate in rounded distal ends 422. The upwardly extending leg portions 424 diverge generally outwardly away from the side members 428 and terminate in ends 430 that are inwardly bent toward the side members 428 and do not extend beyond the center portion 420. A curved section 432 in each leg portion 424 forms its inwardly directed bend and provides a bearing surface that contacts an inner side wall surface 410 of the switch activator 80.

FIGS. 17A, 17B, 18A, and 18B show the geometric features in the inner side wall surfaces 410 and the inner end wall surface 412 of the switch activator 80. Each side wall surface 410 includes an inwardly directed beveled portion 440 having an apex 442 and a proximal end 444 and a distal end 446 located respectively nearer to and farther from the end wall surface 412. The main housing 100 entails placement of the U-shaped center portion 420 with its base member 426 and side members 428 against a raised block 450 on a top surface 452 of a printed circuit board (PCB) 454 of the GPS assembly 402. The length of the base member 426 is chosen to establish a snug fit of the raised block 450 within the U-shaped center portion 420 to keep the scissor spring 408 stationary during sliding motion of the switch activator 80. As shown in FIGS. 17A and 17B, whenever the switch activator 80 is in the recording ON slide setting position, the curved sections 432 of the scissor spring leg portions 424 rest in shallow notches formed at the distal ends 446 of the beveled portions 440. As shown in FIGS. 18A and 18B, whenever a user slides the switch activator 80 from the recording ON slide setting position to the recording OFF slide setting position, the curved sections 432 exit the shallow notches at the distal ends 446, slide along entire lengths of the beveled portions 440, and come to rest at shallow notches formed at the proximal ends 444 of the beveled portions 440. The curved sections 432 of the leg portions 424 are of complementary shape to the curved sections 448 of the inner end wall surface 412.

The shaping of the scissor spring 408 imparts resistance to prevent the initial sliding motion of the switch activator 80 in either direction, but in response to user applied pressure overcoming the resistance, the switch activator 80 automatically travels to the stopping position without effort by the user. The scissor spring 408 exerts passive resistance to any motion and therefore holds the switch activator 80 in the proper position until the user again moves the switch activator 80. The shape of the scissor spring 408 can be varied based upon, for example, the geometry of the switch activator 80, the length of travel, and desired holding force.

The above-described spring solution is uniquely resistant to vibration and is well-suited for a high vibration environment. The scissor spring 408 is an improvement over magnetic sliding switch movements because the former does not introduce magnetic interference that can affect other functions in the digital video camera 10. The scissor spring 408 is also an improvement over a double detent implementation because the user is confident the switch activator 80 is in the proper position. This spring solution can be expanded to include a combination of springs to provide specialized motion or specific force profiles. This spring design can also control linear or circular motion.

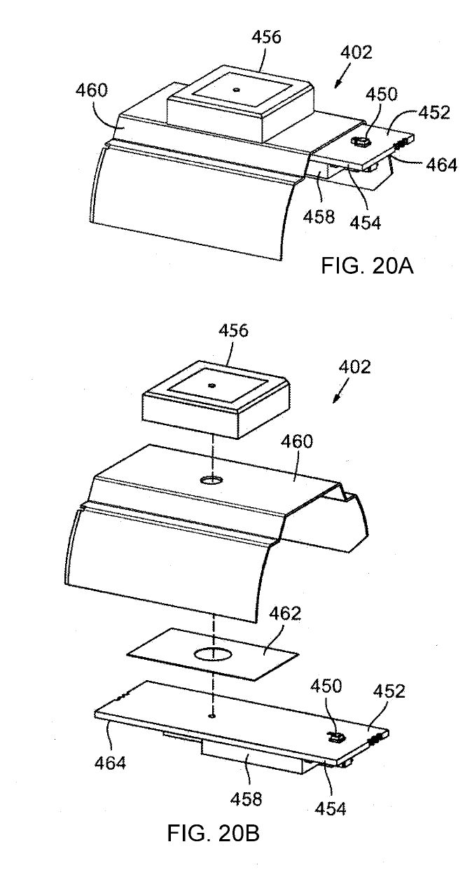

FIGS. 20A and 20B show respective perspective and exploded views of the GPS assembly 402 separate from the main housing 100, in which the GPS assembly 402 is installed for operation in the digital video camera 10. The GPS assembly 402 includes a GPS passive patch antenna 456 and a GPS receiver module 458 to provide GPS functionality to the digital video camera 10. A GPS ground plane 460 in the form of a stepped, generally U-shaped aluminum shroud is positioned between patch antenna 456 and the GPS printed circuit board 454 and affixed to the top surface 452 of the latter by GPS ground plane mounting tape 462. The GPS receiver module 458 is mounted to the GPS printed circuit board 454 on its bottom surface 464. An embodiment of a GPS patch antenna 456 is a Model PA1575MZ50K4G-XX-21, which is a high gain, customizable antenna available from INPAQ Technology Co., Ltd., Taiwan. The GPS patch antenna 456 is custom tuned to its peak frequency to account for detuning effects of the edges of the camera housing 22. An embodiment of a GPS receiver module 458 is a Model NEO-6 module available from u-blox AG, Switzerland.

FIGS. 20A and 20B show that the GPS ground plane 460 is physically shaped to complement or mirror the curved shape of the housing 22 so that the ground plane area can be maximized as the shape of the ground plane conforms to, i.e., without altering, the shape of the camera housing 22. Additionally, the GPS patch antenna 456 is supported by its own internal ground plane, which is arranged such that it overlaps the inside of the existing aluminum case. This overlap allows RF currents to pass between the aluminum case and the GPS ground plane 460 through capacitive coupling and hence have the effect of increasing the size of the overall ground plane area. This increased ground plane area further improves the GPS reception. Moreover, the GPS patch antenna 456 is tuned with these components coupled for optimal reception by the overall system. The ground plane customization and electrical coupling to the camera housing 22 or other metal components of the digital video camera 10 improve performance by achieving higher antenna gain and consequent enhanced signal reception when the digital video camera 10 is mounted in multiple positions.

When recording video or taking photographs in a sports application, the digital video camera 10 is often mounted in a location that does not permit the user to easily see the camera. Implementing the digital video camera 10 with a wireless connection protocol enables remote control of the operation of and remote access to image data stored in the digital video camera 10. In some embodiments, the integration of Bluetooth® wireless technology in the wearable digital video camera 10 facilitates implementation of several features, including remote control, frame optimization, multi-camera synchronization, remote file access, remote viewing, data acquisition (in combination with GPS capability), and multi-data sources access (in combination with GPS capability).

Implementing Bluetooth® wireless technology in the digital video camera 10 enables the user to control it remotely using a telephone, computer, or dedicated controller. This allows the digital video camera 10 to remain sleek, with few buttons and no screen. Additionally, a lack of need for access to a screen or controls provides more flexibility in mounting the digital video camera 10.

The remote control device (i.e., telephone, computer, dedicated viewer, or other Bluetooth®-enabled device) can access files stored on the digital video camera 10 to allow the user to review the content in such files and manage them on the camera. Such access can include file transfer or file playback in the case of video or audio content.

Using a wireless signal transfer, the remote device can access data streaming from the digital video camera 10. Such data can include camera status, video, audio, or other data (e.g., GPS data) collected. Standard video can exceed the bandwidth of a Bluetooth® connection. To resolve any quality of service issues, a fast photo mode is used to simulate video. In this case, photographs are taken in succession, then streamed and displayed in sequence to simulate video playback. Firmware in a main processor captures and streams the photographs, and the receiving application is designed to display photographs in quick succession. To be space efficient, the photographs can be stored in a FIFO buffer so that only limited playback is available.

Alternative implementations of a remote viewer include one or more of reduced resolution or frame rate, file sectioning, frame sampling, and Wi-Fi to media server. Reduced resolution or frame rate entails recording video in two formats, high quality and low quality, in which the lower quality file is streamed or played back after the recorded action has taken place. For streaming implementation, wireless connection bandwidth can be monitored to adapt to the available bandwidth the resolution, bit rate, and frame rate on the secondary recording. Additionally, buffering can be used in conjunction with adaptive bit rate control. File sectioning entails breaking a recording into small files and transferring each file upon completion to allow for viewing via a wireless device in near real time. File transfer can be delayed so as to limit interruptions that result from bandwidth limitations. Frame sampling entails real time video frame sampling (e.g., video compression intraframes (I-frames) only). Wi-Fi to media server entails use of Wi-Fi to establish the camera as a media server on selected networks, allowing other devices to read and play content accessed from the device.

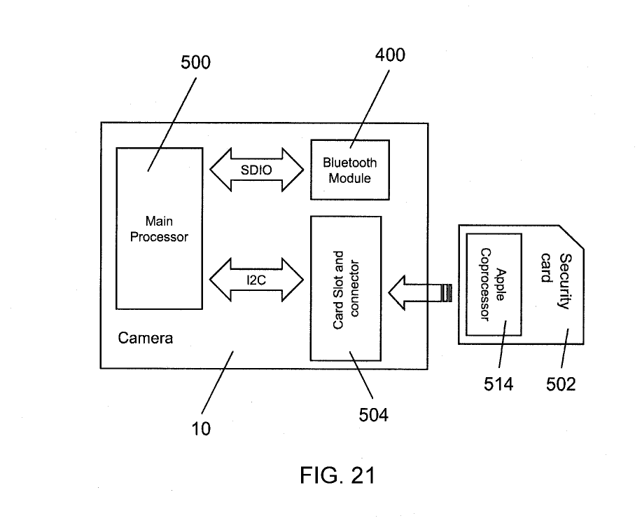

FIG. 21 is a simplified block diagram showing an implementation of wireless technology in the digital video camera 10. FIG. 21 shows the digital video camera 10 with a built-in Bluetooth® wireless module 400 that responds to a Contour Connect Mobile App application software executing on an operating system for mobile devices such as smartphones and tablet computers to enable such a mobile device to become a wireless handheld viewfinder. A Contour Connect Mobile App that is compatible for use with an iOS mobile operating system of Apple®, Inc. is available on the iPhone App Store and that is compatible for use on an Android mobile operating system of Google Inc. is available on the Android Market. The firmware of a main processor 500 stores an updated version of compatible software to respond to the Contour Connect Mobile App executing on a mobile device. This wireless connection capability enables a user to configure camera settings in real time and preview what the digital video camera 10 sees. Specifically, a user can check the camera angle on the wireless device screen and without guesswork align the camera shot and adjust video, light level, and audio settings before beginning the activity he or she wants to record.

The functionality permitted across industry standard interfaces is often limited by the receiving or transmitting device based on its permissions. This means that one device can refuse to permit certain functionality if the other device does not have proper certificates or authentications. For example, the Apple® iPhone and similar products require certain security authentication on data signals transmitted using the Bluetooth® interface. The security requirements on such interfaces vary by product and the manufacturer. Oftentimes the same product is intended to connect with a variety of devices, and it is not desirable to integrate the security component for all possible features or external devices.

In some embodiments, the signal path is designed such that the presence of this security integrated circuit is not required for full functionality for such other devices. However, by including a connector in this signal path, a security module can be added by the user after manufacturing to allow connection with such controlled devices. By including such a connector in the signal path, the relevant signal security module can be provided separately for only those applications that require such security authentication. Additionally, in some embodiments, the Apple® security card is packaged separately as a self-contained card. The circuit is designed to retain the authentication integrity but to interface with the controlling device through a standard connector FIG. 21 also shows placement of a Contour Connect View (security) Card 502 in a card slot and a connector 504 of the digital video camera 10 to enable connection with a supported Apple® iOS device. A Contour Connect View Card is available from Contour, Inc., the assignee of this patent application.

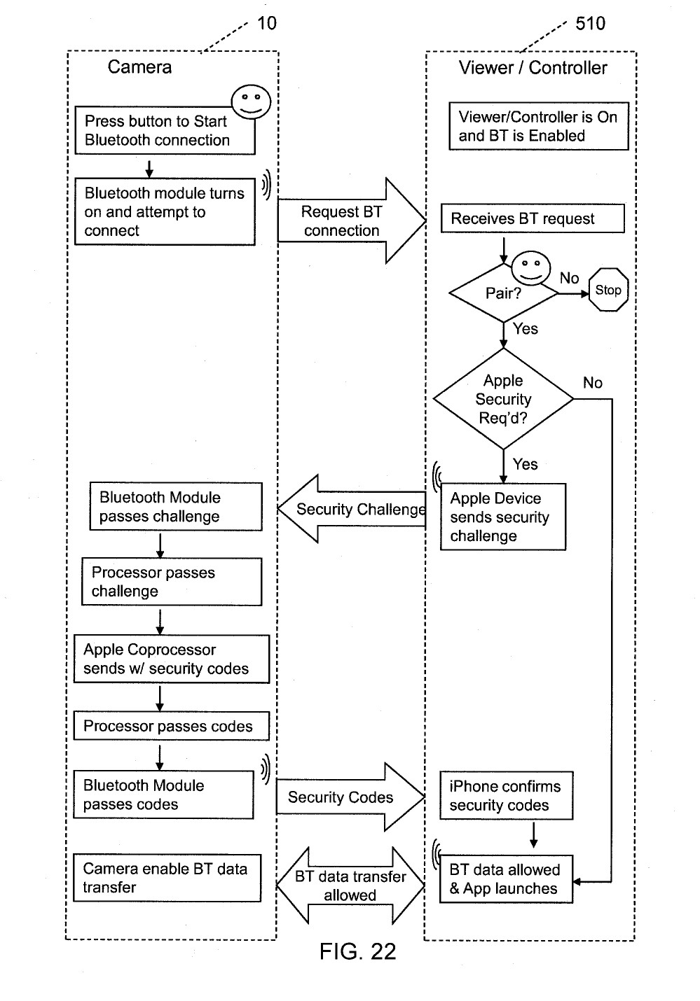

FIG. 22 is a flow diagram showing the pairing of two devices by Bluetooth® wireless connection. The main processor 500 of the digital video camera 10 stores a data file identifying a Bluetooth®-enabled viewer/controller device 510. (An appearance of a smiley face icon in the flow diagrams indicates action by or display of status information to a user.) A user presses a wireless connection activator button (which can be located near the switch activator 80 but not shown in the drawings) on the camera housing 22 to turn on the Bluetooth® module 400, which transmits a Bluetooth® (“BT”) Connection Request signal to the Bluetooth® connection-enabled viewer/controller 510. The viewer/controller 510 receives the Bluetooth® Connection Request signal, determines whether there is a Bluetooth® ID connection match pair, and upon recognition of a match pair, determines whether the viewer/controller 510 is iOS or Android implemented. If it is Android implemented and therefore Apple® security is not required, the viewer/controller 510 allows and launches the Contour Connect Mobile App to perform Bluetooth® data transfer to and from the digital video camera 10. If it is iOS implemented and Apple® security is required, the viewer/controller 510 sends a Security Challenge signal for passage through the Bluetooth® module 400 and the main processor 500 to an Apple® coprocessor 514 mounted on the Apple® security card 502. The Apple® coprocessor 514 sends security codes for passage through the main processor 500 and the Bluetooth® module 400 to the viewer/controller 510, which confirms the security codes and allows and launches the Contour Connect Mobile App to perform Bluetooth® data transfer to and from the digital video camera 10.

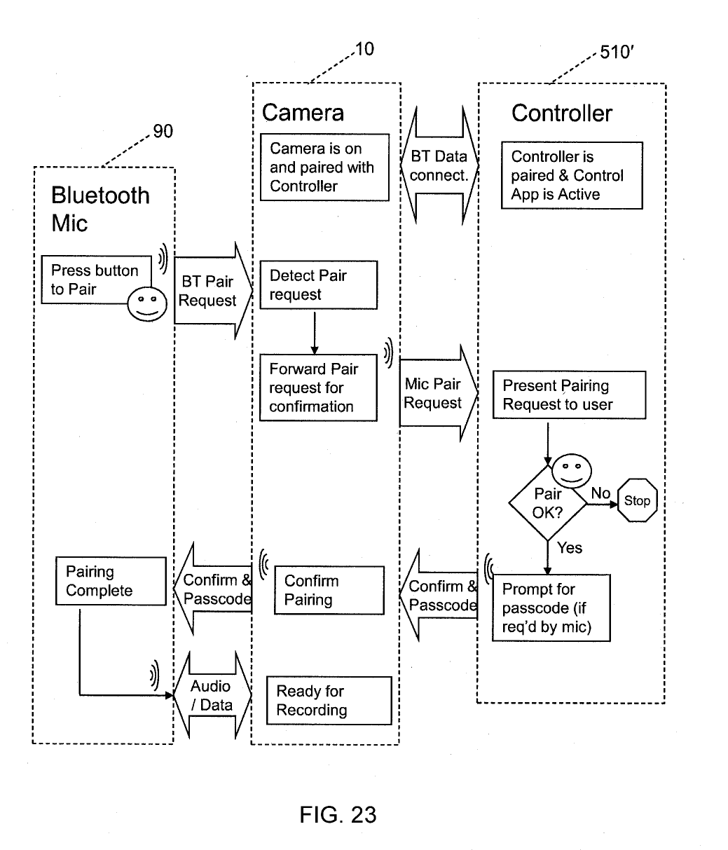

The use of a data file to identify the Bluetooth® ID of a device allows two devices to pair when neither device has a display screen. FIG. 23 is a flow diagram showing an example of pairing the Bluetooth® microphone 90 and the digital video camera 10, neither of which has a display screen. The digital video camera 10 and a controller 510′ are initially paired by Bluetooth® wireless data connection, and the Contour Connect Mobile App is active, as described above with reference to FIG. 22. The viewer/controller 510 and the controller 510′ are of similar construction, except that the latter has no display screen. A user slides the switch activator 80 to its ON position to supply power to the microphone 90 and transmit a Pair Request signal to the digital video camera 10, which detects and forwards to the controller 510′ a Microphone Pair Request signal for confirmation. The user responds to the pairing request by manipulating an actuator associated with the controller 510′. If user actuation indicates refusal of the pairing request, the controller 510′ concludes the pairing process. If user actuation indicates acceptance of the pairing request, the controller 510′ transmits to the digital vide the microphone 90. Upon receipt of the Confirmation signal, the digital video camera 10 transmits a Confirmation signal and any passcode to the microphone 90 and thereby completes the pairing by initiating audio data capture and recording by the audio encoder in the digital video camera 10.

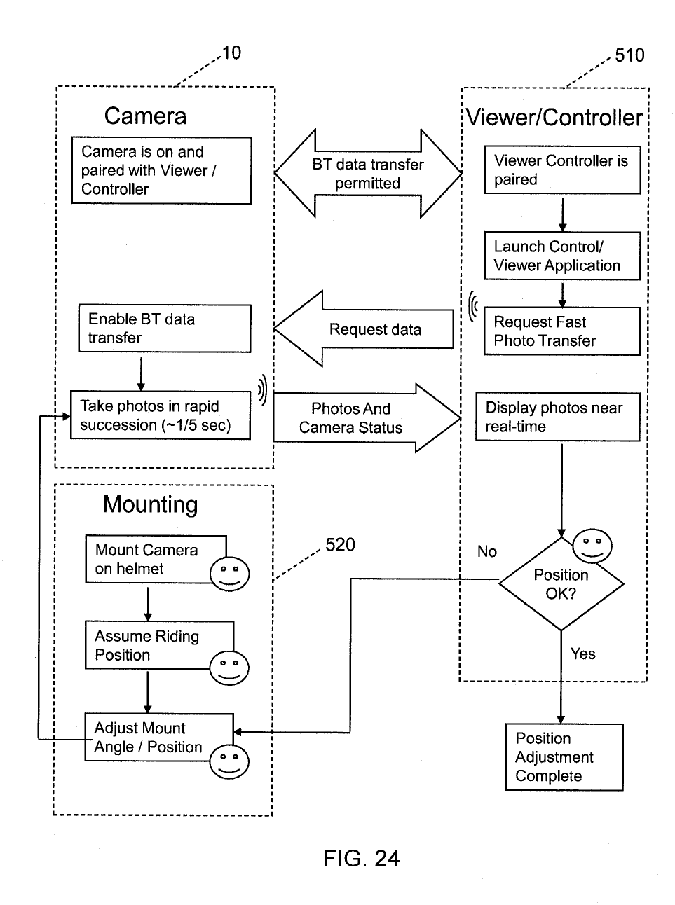

FIG. 24 is a flow diagram showing an embodiment of a camera position adjustment procedure carried out by a helmet-wearing user, such as a bicycle or snowboard rider or skier, to align the digital video camera 10 mounted on the user's helmet. The digital video camera 10 and the viewer/controller 510 are initially paired by Bluetooth® wireless data connection, and the Contour Connect Mobile App is active, as described above with reference to FIG. 22. A launch control/viewer application instruction causes transmission of a fast photo transfer Data Request signal to the Bluetooth® data transfer-enabled digital video camera 10, which responds by enabling the taking of photographs in rapid succession (e.g., five photographs each second) of the scene to which the camera lens 26 is pointed. A mounting activity sequence 520 indicated in FIG. 24 represents user activity of mounting the digital video camera 10 on the helmet, assuming a riding position, and adjusting the position and angle of the digital video camera 10 by selecting its mounting surface location on the helmet and rotating the rail plug 132 within the base mount 130h of the mounting system 300. The angle/position mounting adjustment performed by the user causes the taking of photographs of the scene in rapid succession and transmitting them for near real-time display to the user observing the display screen of the viewer/controller 510. Successive iterations of angle/position mounting adjustment, picture taking in rapid succession, and user observation of the displayed scene continue until the user is satisfied with the position of the scene displayed, whereupon the mounting position adjustment of the digital video camera 10 on the helmet is complete.

Frame optimization can be accomplished with a remote control device or within the digital video camera 10, if it is equipped with a screen and controls. Frame optimization can entail one or both of lighting and color optimization and frame alignment, either manually or automatically.

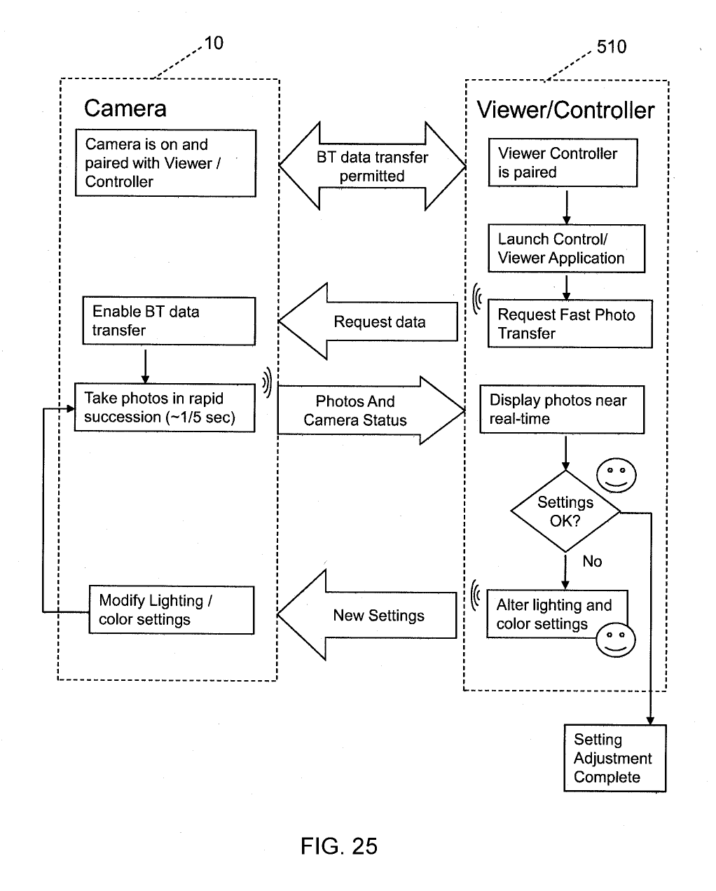

FIG. 25 is a flow diagram showing an embodiment of a manual lighting level and color settings adjustment procedure. The manual lighting level and color setting procedure shown in FIG. 25 differs from the mounting position adjustment procedure of FIG. 24 in that 1) the mounting activity sequence 520 does not apply, 2) a settings OK decision block replaces the Position OK decision block in the viewer/controller 510, and 3) the manual angle/position mounting adjustment causing the taking of photographs of the scene in rapid succession is replaced by transmission of a new settings instruction produced in response to user-manipulation of an alter lighting level and color settings actuator associated with the viewer/controller 510. The manual lighting level and color adjustment procedure entails the user observing the successive photographs on the display screen and manipulating the alter lighting level and color settings actuator associated with the viewer/controller 510 until the user is satisfied with the lighting level and color displayed, whereupon the manual setting adjustment is complete.

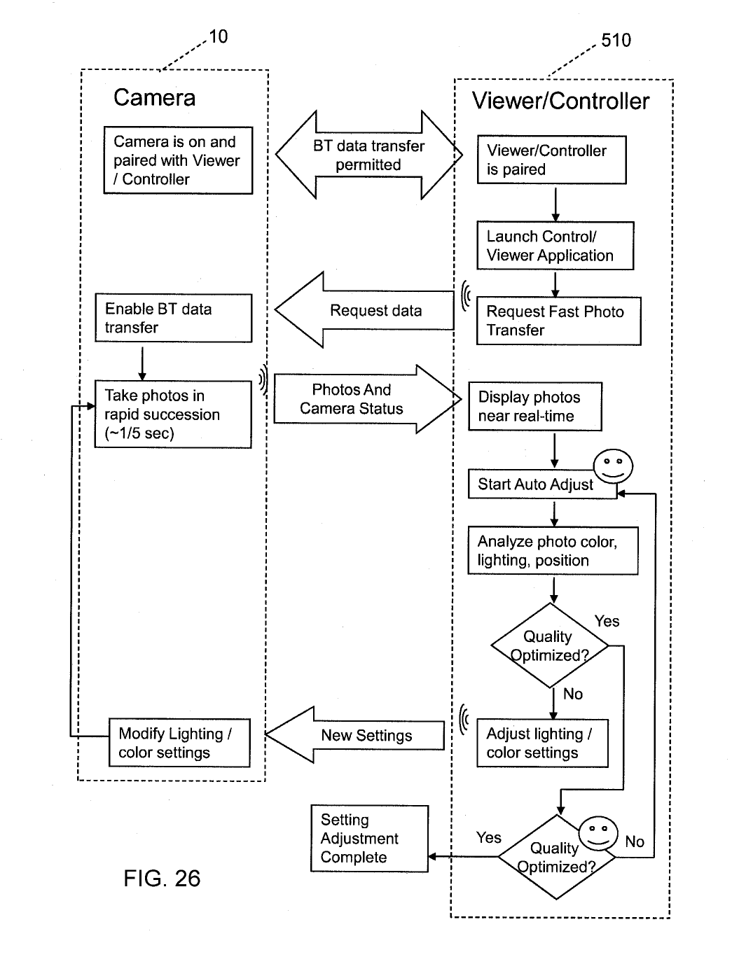

Automatic lighting and color optimization uses video or photographic analysis in controlling the device. FIG. 26 is a flow diagram showing an embodiment of an automatic lighting level and color settings adjustment procedure. The automatic lighting level and color settings procedure shown in FIG. 26 differs from the manual lighting level and color settings procedure shown in FIG. 25 in that an Auto Adjust iterative loop replaces the Settings OK decision block of FIG. 24. Specifically, a Start Auto Adjust process block initiates an iterative Auto Adjust loop of programmed analysis of photograph color, lighting level, and position followed by a Quality Optimization decision query based on a set of programmed quality standards. The Auto Adjust loop iteratively performs the analysis and causes transmission of a new settings instruction to the digital video camera 10 to take additional photographs for display and analysis by the viewer/controller 510. The automatic lighting level and color adjustment procedure entails the automatic internal analysis of the photographs on the display screen and preprogrammed automatic adjustment of the lighting level and color settings until the Quality Optimized decision block indicates that image quality meets preprogrammed optimum quality standards and the final ‘Quality Optimized decision block indicates that the user is satisfied by user manipulation of an actuator indicating the automatic setting adjustment is complete. The viewer/controller 510 can implement tuning algorithms to analyze frames, adjust settings, and reanalyze the frames to optimize lighting level and color settings. Small and fine alignment adjustments can be made automatically by altering the pixels used to define the frame. These adjustments can be made by redefining the center pixel or by redefining the bounding box. These adjustments can be horizontal, vertical, and rotational, including rotating a full 180° to allow for the digital video camera 10 to be positioned upside down, as shown in FIG. 16D. For more precise optimization, the digital video camera 10 can be pointed at a predefined chart to allow the automatic adjustments to achieve more precise and consistent settings.

Use of the many-to-many nature of Bluetooth® wireless technology enables a user to control multiple cameras. Multi-camera control allows for the controller to coordinate the lighting level and color settings on all cameras, provide guides for alignment of camera positions, and synchronize the videos on multiple cameras with synchronous start/stop or synchronous “alignment” on-screen display (OSO) frames or audio sound that can be embedded in the video to facilitate editing and post-processing. Use of wireless connection allows one camera to provide a synchronization signal to another camera so that videos can be synchronized in post-processing. The OSO frames can be stored in advance in the memory of the digital video camera 10 and be simply triggered by a frame sync pulse to limit transmission bandwidth requirements and any associated errors or delays. This synchronization can include information such as, for example, video file name and camera identity of the primary camera. To improve accuracy of synchronization timing, the wireless transfer rate can be calibrated by pinging a secondary device and listening for response. To further improve accuracy, this ping/response cycle is repeated multiple times.

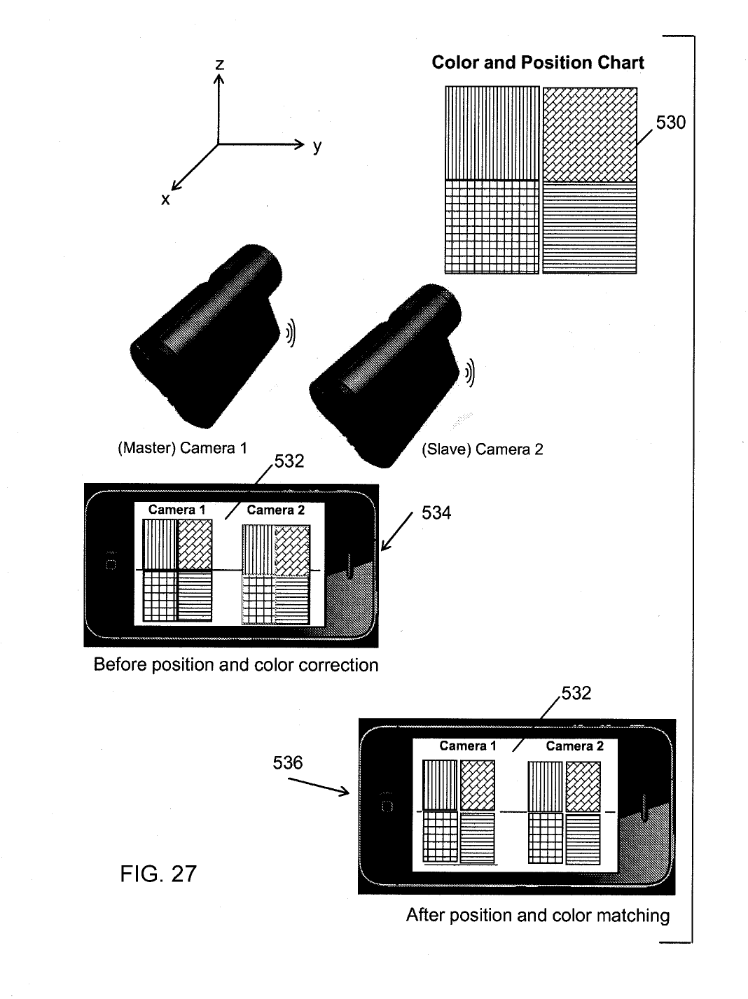

A separate remote device can be used to pair two cameras in which neither camera has a screen. FIG. 27 shows a (Master) Camera 1 and a (Slave) Camera 2 of the same type as the digital video camera 10 aimed at a common chart 530. The relative camera mounting can be adjusted to align the images in the Z-axis. The lighting level and color settings can be adjusted so that they are matched. Aligning the images and adjusting lighting level and color settings eliminate a need for post-processing when combining videos from multiple cameras at multiple angles or three-dimensional views. FIG. 27 shows an iPhone paired to Cameras 1 and 2 implemented with remote Start/Stop capability, which is described below. Master Camera 1 sends an OSD frame sync pulse to Slave Camera 2. Master Camera 1 analyzes photographs from Slave Camera 2 and adjusts settings to match the alignment and settings of Master Camera 1.

FIG. 27 presents two illustrations of a display screen 532 of the viewer/controller 510 of an iPhone type showing for user observation side-by-side images produced by Cameras 1 and 2 viewing chart 530. An upper illustration 534 and a lower illustration 536 show the comparative relationship between the position and color matching, respectively, before and after correction. The illustration 534 shows Z-axis misalignment of the two camera images and color imbalance, and the illustration 536 shows post-correction image position alignment and color matching.

By controlling multiple cameras, the user is able to coordinate shots from different angles and ensure the color and lighting settings are similar to allow for seamless switching in playback. The some embodiments, such as when multiple devices daisy-chained together, a single authentication can be used. For example, if there were two cameras that were connected via Bluetooth® to a device that required such authentication, the signal from one camera can route through the other to use its security and the intermediary device would be the only device that requires such security provision. This security component can also be able to become a standalone component that is simply inserted into the security path as a pass-through that adds the authentication or approval required only for the receiving device and performs any translation required for the response to be interpreted properly.

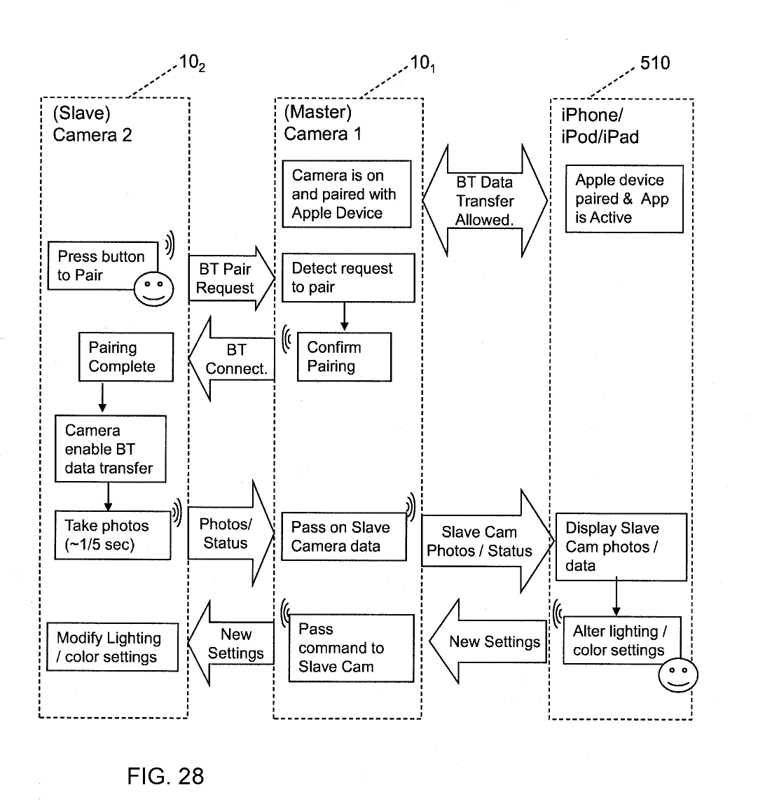

FIG. 28 shows an embodiment of a user application to allow the user to change lighting level and color settings and immediately see the resulting changed video. FIG. 28 is a flow diagram showing Camera 1 and an iOS mobile phone or tablet computer device 510 paired by Bluetooth® wireless connection and cooperating to accomplish without security the pass-through of Camera 2 data. A user pushes the wireless connection activator button on Camera 2 to transmit a Pair Connection Request signal to Bluetooth®-enabled Camera 2, which detects the request, confirms the pairing, and transmits a signal to Camera 2 to complete the pairing. Camera 2 responds by taking photos in rapid succession and transmitting them together with status information to Camera 1 for pass-through transmission to the device 510 for display as Camera 2 image and data on the display screen 532. A user manipulates an actuator associated with the device 510 to change lighting level and color settings by causing transmission to Camera 1 a New Settings command signal for pass-through transmission to Camera 2, which responds by changing its lighting and color settings.

Data acquisition and data synchronization in the use of wireless communication, in cooperation with GPS capability (in some instances), can be accomplished by one of several techniques. When capturing video during an activity, data can be used to better describe the activity as well as used for editing and optimizing either during recording or in post-processing. Typically, these data would be embedded in the video as user data or in the file as a data track (in accordance with MPEG specifications). In a first alternative, the data can be written to a text track in the file. These data are ignored by players unless text display is turned on. Post-processing algorithms extract these data for analysis. Generally, the text track survives editing. In a second alternative, the data can be written to a separate file, and the file name for the data can be written as metadata on the video file so that post-processing applications can properly associate the data with the video. Optimally, the data are synchronized with the video, but they need not be frame synchronized. In the event the data are stored in a separate file, a timestamp can be used to synchronize the video. This marker can be embedded in the data file to tag the file at a single time (e.g., beginning, middle, end, or upon designation by the user), tag the file with every video frame, or tag periodically.

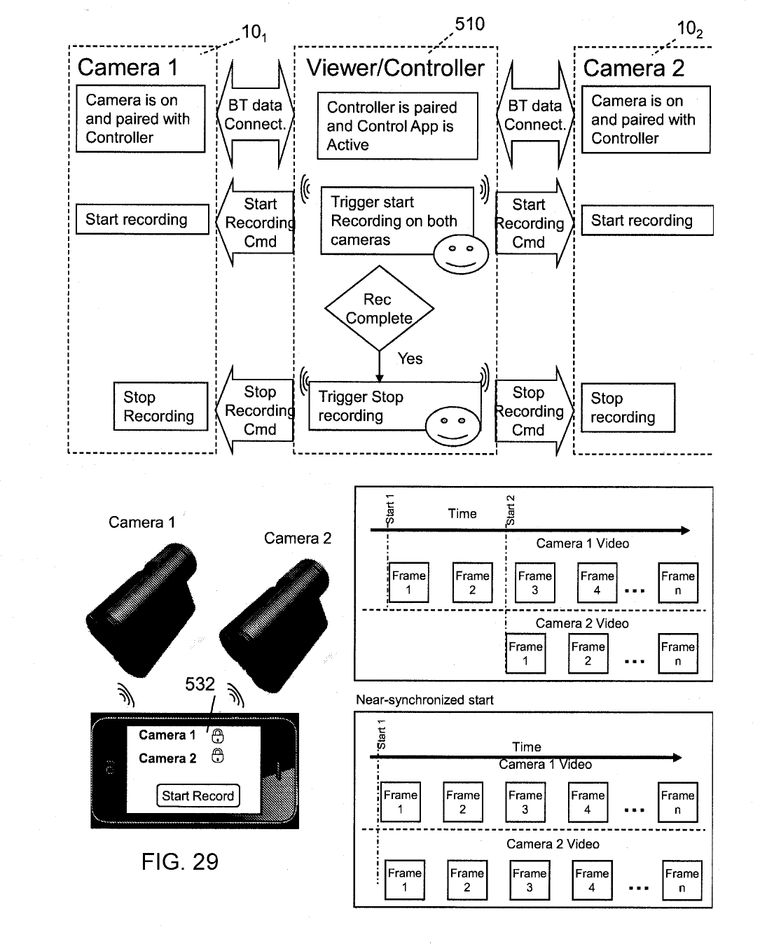

FIG. 29 shows a hybrid flow diagram and pictorial illustration of an iPhone viewer/controller 510 paired by Bluetooth® wireless data and control command connection to Cameras 1 and 2 to implement a remote Start/Stop capability for multiple cameras. (Cameras 1 and 2 are also identified by the respective reference numerals 101 and 102 to indicate they are of the same type as the digital video camera 10.) The flow diagram shows the iPhone viewer/controller 510 paired to Cameras 1 and 2 and Contour Connect Mobile App in its active operating mode. The pictorial view of the iPhone viewer/controller 510 shows on its display screen 532 a Start Record actuator.

The user wanting to start a recording session taps the Start Record actuator to transmit to Bluetooth®-enabled Cameras 1 and 2 a Start Recording command signal. The flow diagram shows Cameras 1 and 2 recording video data in response to the Start Recording command signal. The Bluetooth® wireless module 400 in each of Cameras 1 and 2 is configured to respond to the Start Recording command signal, irrespective of the OFF state of the switch activators 80 of Cameras 1 and 2.

The user wanting to complete a recording session taps a Stop Record actuator (not illustrated in FIG. 29) on the display screen 532 to transmit to Cameras 1 and 2 a Stop Recording command signal. The flow diagram shows Cameras 1 and 2 stopping video recording in response to the Stop Recording command signal.

FIG. 29 also shows upper and lower timing diagrams illustrating the timing sequences of video frame acquisition by Cameras 1 and 2 when they are, respectively, manually started asynchronously in response to user-positioning of the switch activators 80 and started nearly synchronously in response to user-tapping of the Start Record actuator on the display screen 532 of the iPhone controller/viewer 510. The lower timing diagram shows the benefit of wireless connection in accomplishing near synchronous acquisition of streams of video data from multiple cameras.

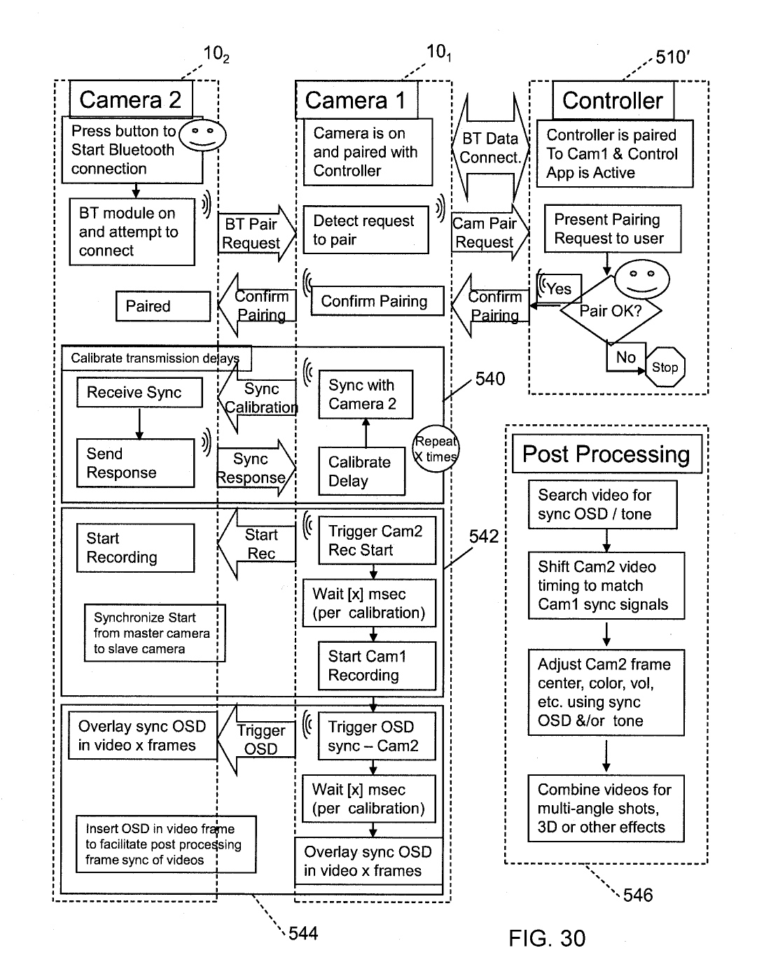

FIG. 30 is a flow diagram showing an example of pairing Camera 1 and Camera 2 by Bluetooth® wireless data and control command connection through either the viewer/controller 510 or the controller 510′, the latter of which is illustrated in FIG. 30. FIG. 30 shows Camera 1 paired by Bluetooth® wireless connection to the controller 510′ and Contour Connect Mobile App in its active operating mode. A user presses the wireless connection activator button on Camera 2 to turn on its Bluetooth® module 400, which transmits a Bluetooth® Pair (connection) Request signal to Camera 1. Camera 1, which is already paired with the controller 510′, detects the Pair Request signal and transmits a Camera Pair Request signal to the controller 510′. The controller 510′ presents a pairing request to the user, who manipulates an actuator to refuse the requested pairing connection, and thereby stop the pairing process, or manipulates an actuator to accept the requested pairing connection, and thereby transmit and pass through Camera 1 to Camera 2 a Confirm Pairing signal to complete the pairing connection.

A synchronization calibration sequence 540 performed between Cameras 1 and 2 calibrates transmission delays between them. Camera 1 transmits to Camera 2 a Sync Calibration signal, to which Camera 2 responds by transmitting a Sync Response signal. Camera 1 determines a calibration delay representing the amount of delay from transmission of the Sync Calibration signal to receipt of the Sync Response signal. This process is repeated a number of times until successive measured calibrated delays are within an operational tolerance.

A synchronized video recording process 542 starts upon completion of the synchronization calibration sequence 540. Camera 1, operating as the master camera and in response to a user-controlled trigger signal, transmits a Start Recording signal to Camera 2, which responds by starting to record video data. Camera 1 starts to record video data after expiration of the calibrated delay determined by the synchronization calibration sequence 540 to achieve a synchronized start of recording video data by Cameras 1 and 2.

An on-screen display (“OSO”) sync pulse insertion process 544 facilitates video frame synchronization in video and audio post-processing. Camera 1 transmits a Trigger OSO Sync signal to Camera 2 in response to the start of video data recording by Camera 1. Camera 2 responds to the Trigger OSO Sync signal by inserting an OSO Sync pulse overlay in the stream of video frames Camera 2 acquires. After expiration of the calibrated delay determined by the synchronization calibration sequence 540, Camera 1 inserts an OSD Sync pulse overlay in the stream of video frames Camera 1 acquires. The time base for computing calibration delay and OSD Sync pulse insertion can be provided by a GPS date/time clock available to the GPS receiver 458.

A video and audio post-processing procedure 546 entails performing a search of the streams of video frames for the OSD Sync pulses and shifting the timing of the stream of video frames of Camera 2 to match the OSD Sync pulses of Camera 1. The frame center, color, audio volume, and other parameters of the Camera 2 video and audio data are adjusted using the OSD Sync pulse so that the streams of video and audio data can be combined for multi-angle shots, three-dimensional images, or other effects.

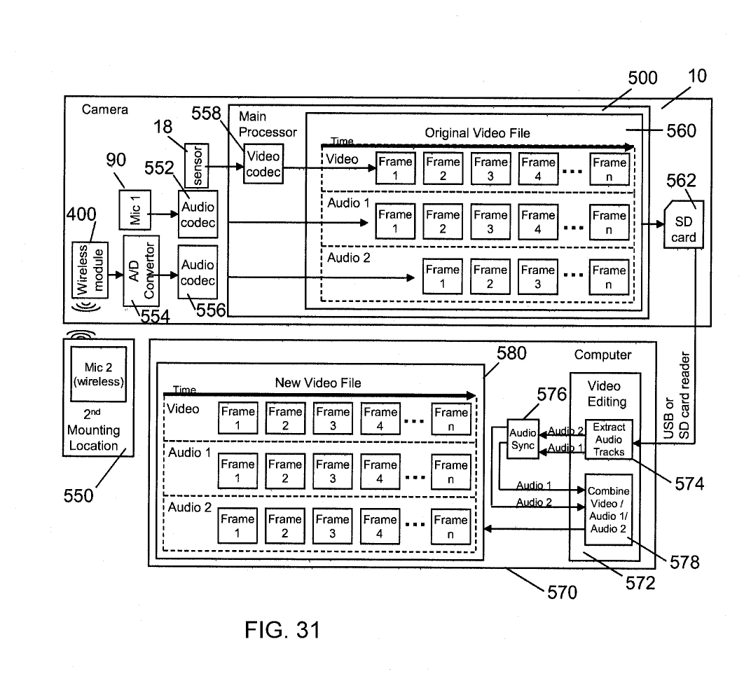

FIG. 31 is a block diagram showing the post-processing procedure of synchronizing audio data produced by a wireless microphone 550 and the wired microphone 90 incorporated in the digital video camera 10. Audi data produced by the microphone 90 are compressed by an audio codec 552. An audio signal produced by the wireless microphone 550 is received by the Bluetooth® wireless module 400, converted to digital form by an analog-to-digital convertor 554, and compressed by an audio codec 556. Video data produced by the image sensor 18 is compressed by a video codec 558, which resides in the main processor 500 of the digital video camera 10. An Audio 1 Track of hard-wired audio data, an Audio 2 Track of wireless audio data, and a Video Track of video data delivered from the respective outputs of the audio codec 552, the audio codec 556, and the video codec 558 are combined and contained as parallel tracks in an original video file 560 and stored in an SO memory card 562.

The wireless microphone 550 introduces a delay in the Audio 2 Track. FIG. 31 illustrates this delay by showing a one-frame temporal offset between corresponding frames of the Audio 1 and 2 Tracks. The above-described OSD Sync pulse functions as an audio time stamp that can be used to correct for the delay and thereby synchronize the Audio 1 and 2 Tracks for automatic post-processing audio analysis. Post-processing is performed in a peripheral computer 570, which includes a video editor 572 having an audio tracks extraction module 574 that receives from the SO card 562 the stored Video, Audio 1, and Audio 2 Tracks data from the original video file 560. The audio tracks extraction module 574 separates the Audio 1 and 2 Tracks, and an audio synchronizer module 576 using the time stamp sync pulse synchronizes them. The synchronized Audio 1 and 2 Tracks, together with the Video Track, are combined in a video/audio combiner module 578 and delivered in proper temporal frame alignment to a new video file 580.

Data measurements performed depend on the type of data acquired. The most appropriate data varies based upon sport or type of motion recorded; therefore, ideally data sensors are tailored to the relevant sport. Additionally, the best location for measuring data is often not the ideal location for mounting a camera.

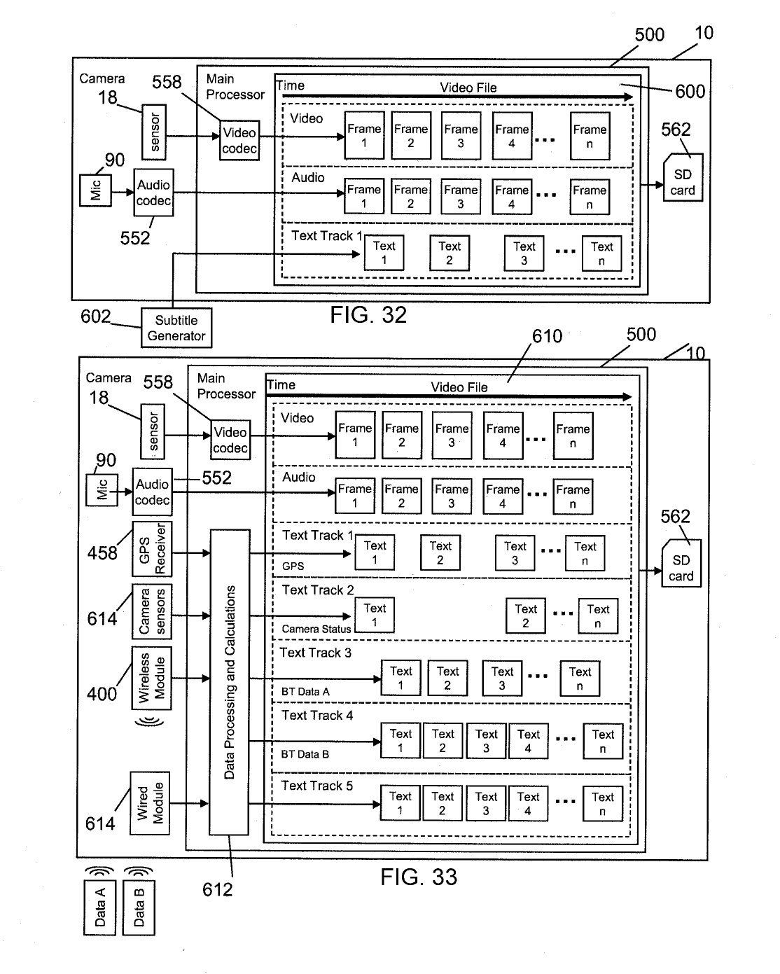

FIG. 32 is a simplified block diagram showing the processing of a single track of data from one data source. FIG. 32 shows the digital video camera 10 including in its main processor 500 a video file 600 containing a Video Track, an Audio Track, and a Text Track. The Video and Audio Tracks correspond to, respectively, the Video and Audio 1 Tracks contained in the original video file 560 of FIG. 31. The Text Track represents data that are produced by a subtitle generator 602 hardwired to the main processor 500 and is presented for display on the video frames.

By using Bluetooth® with its many-to-many connections, multiple data sources can be recorded by the camera. These data sources can be customized to the specific application, for example for automobile racing, data relating to the automobile engine can be captured from on-board diagnostics and transmitted to the digital video camera 10, where the data can be embedded in the video stream for later playback. Examples of multiple data sources include streaming data to one or more cameras from one or more data sources (e.g., GPS data from telephone or GPS collection device, and audio data from remote microphone) and storing such data as individual files or embedded in the video file as metadata, audio tracks, or text.

In post-processing, data associated with video content can be used in editing to correct for shade lighting changes, to correct for video processing errors, and to enhance the story with information about the path taken, location of the video, speed, and other information. Location and time data embedded in video from sources such as GPS can be used to synchronize videos in post-processing generating a three-dimensional video. Speed, vibration, altitude, temperature, date, and location can be combined to determine the likely sport or activity as part of a post-processing suite. The recommendations can be tuned based on data gathered from a large body of videos in which the activity in the video has been identified. Data associated with video content can be used to associate and group videos from one or more users. The groupings can be based on any characteristic such as time, location, speed, and other factors. Videos that intersect in time or location can be linked so that the viewer can transition to a different camera or video when two videos cross in location or time. Additionally, the data can be used to correlate multiple cameras or videos to create multiple view angles for the same location or event. These data can also be used to correlate videos of the same location taken over time to document the changes in that location over extended durations (hours, days, weeks, years).

Multiple “language” tracks on video file can be used to capture different audio sources (including wireless microphone) from the video camera. This allows the user to select from the optimal audio source in post-processing or allows automatic correction for signal errors and synchronization issues. By storing multiple sources, users are post-processing algorithms and can select the most reliable track in the event there is a dropout resulting from signal quality issues caused by use of a wireless device. Additionally, audio can be captured from multiple sources and from different locations to provide different audio information so that the desired audio can be selected in post-processing. In the event multiple audio tracks are not available, data tracks can be used and the data can be converted into an audio source in post-processing. In the event the wireless audio source cannot be channeled through the audio codec, the raw data can be stored and post-processing can modify these data to convert them to audio. Any delay introduced by the wireless connection can be corrected by synchronizing the wireless audio source to the primary audio source (internal microphone) using the audio waveforms.

The foregoing approach differs from the prior art technique of automatically switching between an internal microphone and an external microphone, where the external microphone is used when it exists and software automatically reverts to the internal microphone when the external microphone signal is unavailable. Automatic switching would, however, mix audio from different locations and not provide a seamless audio experience.

FIG. 33 is a simplified block diagram showing the processing of multiple tracks of data from multiple data sources. FIG. 33 shows the digital video camera 10 including in its main processor 500 a video file 610 containing Video and Audio Tracks corresponding to those contained in the video file 600 of FIG. 32 and five text tracks described below.

A data processing and calculations module 612 of the main processor 500 receives data from the GPS receiver 458, the camera sensors 614, the Bluetooth® wireless module 400 receiving data transmissions from Bluetooth® wireless connection enabled sources, and a wired data module 614 and delivers these data as Text Track 1, Text Track 2, Text Track 3, Text Track 4, and Text Track 5, respectively.

Text Track 1 contains GPS data such as longitude, latitude, elevation, date/time, and other data available from the GPS receiver 458. The date/time information enables associating acquired video and other data, including data on Text Tracks 2-5, to a certain time point in the video data stream. The peripheral computer 570 takes the time-stamped information and displays it by time point. The transmission delay calibration described with reference to FIG. 30 can be implemented using the GPS-provided date/time clock as a time standard.

Text Track 2 contains operating parameter data such as video resolution, compression rate, and frame rate information available from the camera sensors 614 associated with the digital video camera 10.

Text Tracks 3 and 4 contain data acquired from Bluetooth® wireless connection-enabled Data A and Data B transmission sources such as, for example, race car engine sensor data and race car driver heart rate monitor data. These data are typically periodically transmitted to the Bluetooth® module 400. Another example of Data A and Data B sources is data sources transmitting data at different transmission rates.

Text Track 5 contains data produced from a text data module (e.g., the subtitle generator 602 of FIG. 32) hardwired to data processing and the calculations module 612.

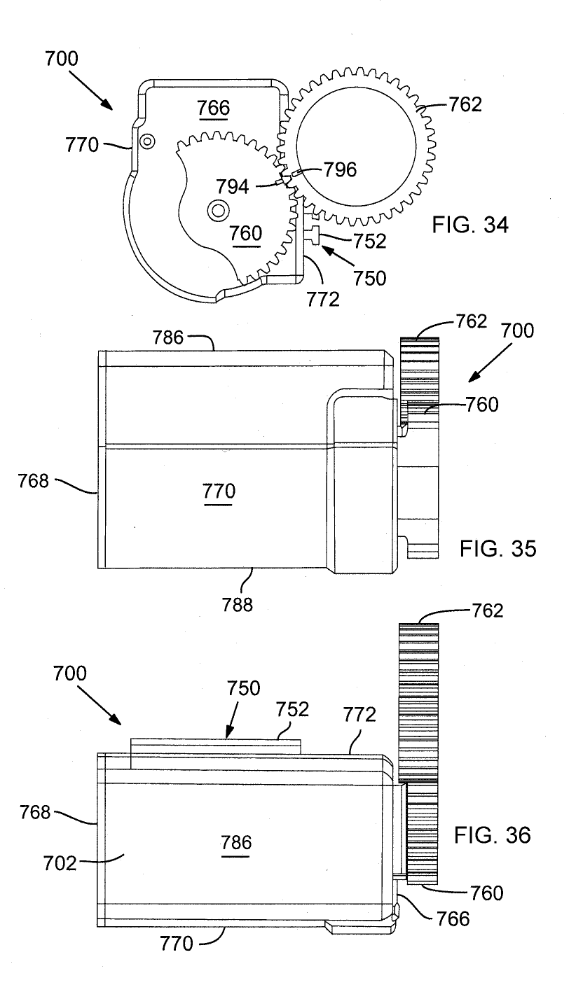

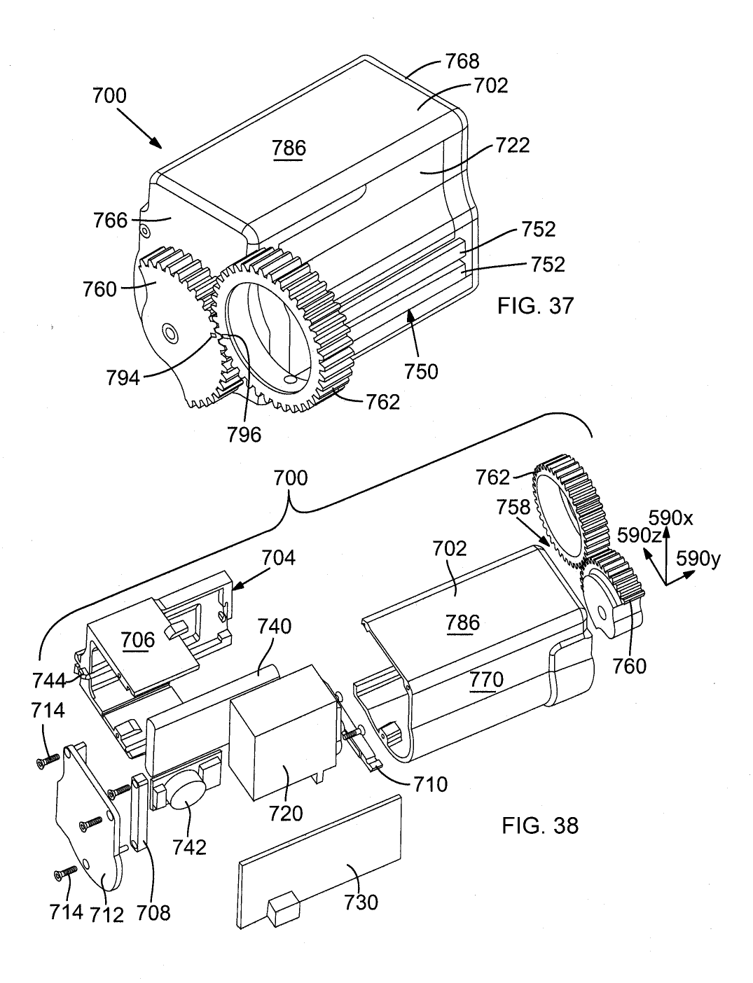

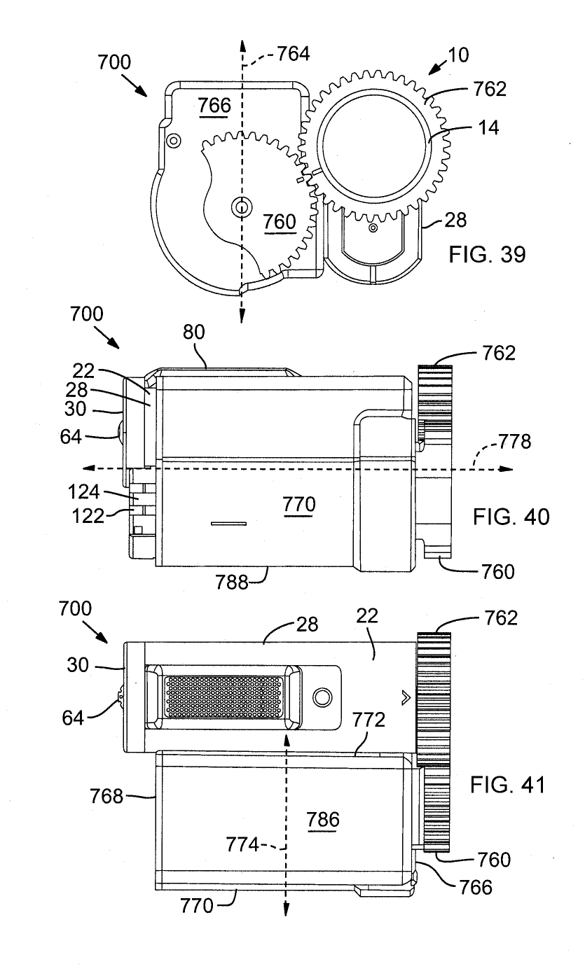

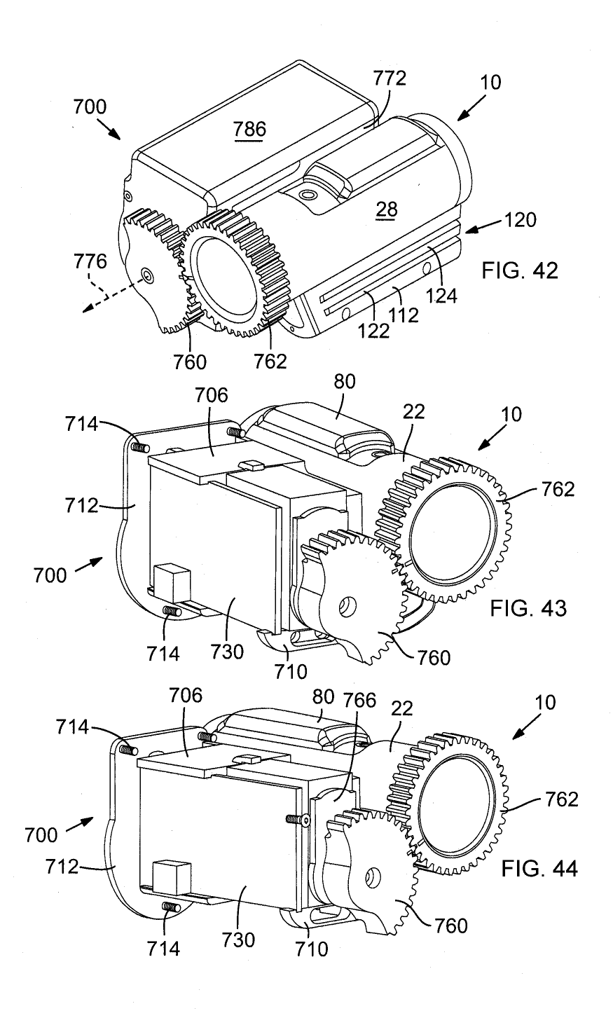

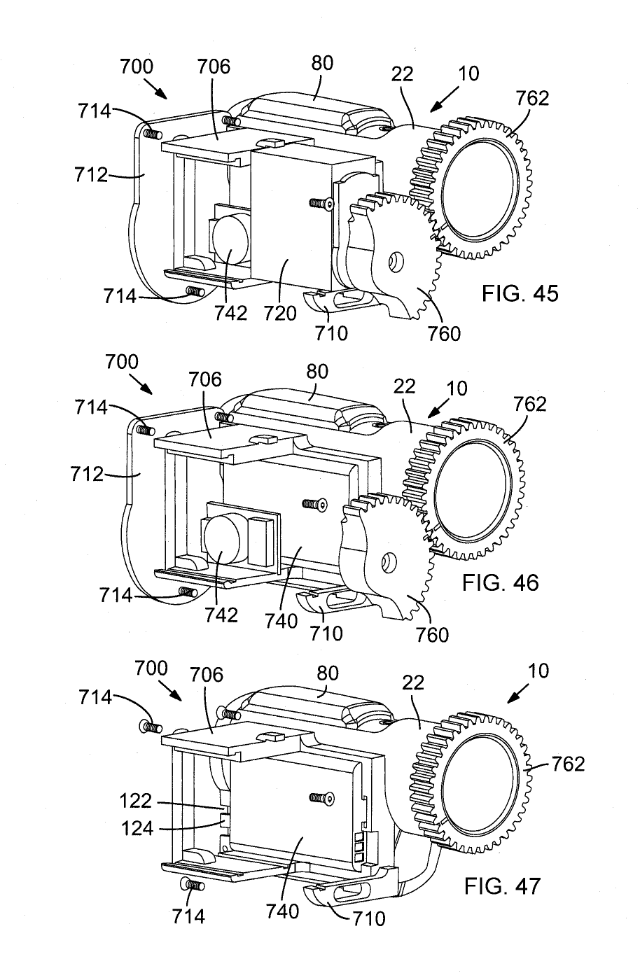

FIGS. 34-36 are respective front, left side, and plan views of an embodiment of a camera accessory 700 for controlling orientation of the image sensor 18. FIG. 37 is a top, front, right side isometric view of the camera accessory 700 shown in FIGS. 34-36, and FIG. 38 is an exploded view of an embodiment of the camera accessory 700 shown in FIGS. 34-36. FIGS. 39-41 are respective front, left side, and plan views showing an embodiment of a camera accessory 700 attached to an embodiment of the digital video camera 10. FIG. 42 is a top, front, right side isometric view of the camera accessory 700 shown in FIGS. 39-41 attached to an embodiment of the digital video camera 10. FIGS. 43-47 are top, front, left side isometric views of the camera accessory 700 shown in FIGS. 39-41 attached to an embodiment of the digital video camera 10 with certain components removed from the camera accessory 700.

With reference to FIGS. 34-47, an embodiment of the camera accessory 700 includes an accessory housing 702 that can be integrated with or connectable to one or more pieces of a skeletal frame 704. The skeletal frame 704 can include a frame structure 706, a frame structural support 708, a servo support 710, and an outer shell back cover 712 that can be directly or indirectly connected to each other and/or to the accessory housing 702. For example, the outer shell back cover 712 can be connected to the frame structural support 708 and/or the frame structure 706 by one or more screws 714 or using other adhering mechanisms, such as glue, compression, bolts, welding, etc.

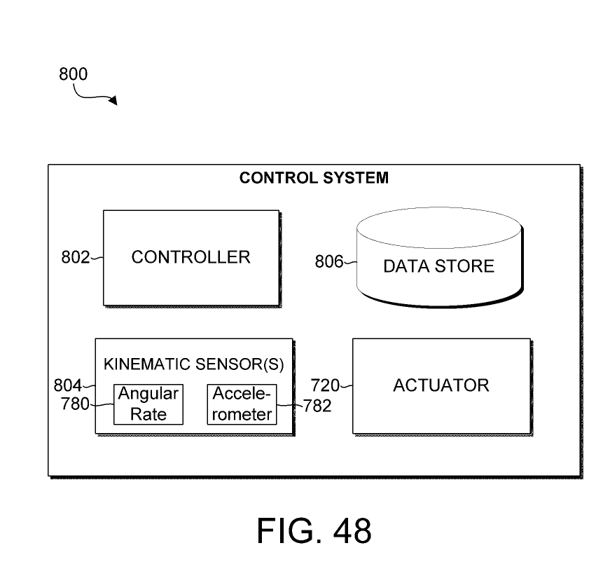

The skeletal frame 704 is configured to support a servomechanism or actuator 720 that is responsive to angular rate information and/or acceleration information concerning respective angular forces and/or acceleration experienced by the camera accessory 700 and its components. The angular forces can be detected by one or more angular rate sensors 780 (FIG. 48) mounted on or integrated with one or more circuit boards 730, and the acceleration forces can be detected by one or more accelerometers 782 (FIG. 48) mounted on or integrated with the circuit board(s) 730 or one or more different circuit boards (not shown).

In some embodiments, an actuator 720 can be relatively small, quickly responsive to inputs (high bandwidth), exhibits minimal settling fluctuations and minimal settling time, and consumes a minimal amount of power. In some embodiments, the actuator 720 can also be employed to perform calculated motions such as time lapse panning, such as on the roll and/or pan (yaw) axes. For example, the digital video camera 10 can be mounted pointing 90 degrees down so that the actuator gear also points down becoming a pan axis. The gear can be mated to a fixed base to obtain time lapse video on the pan axis. An embodiment of the actuator 720 is Model HS-7940TH manufactured by Hitec RCD, Inc. of Poway, Calif.

The skeletal frame 704 can also be configured to support a battery 740 and a voltage booster 742. The battery 740 can be connected to or held in place by a battery clip 744 that is attachable to or integrated with one of the components of the skeletal frame 704. The battery 740 can supply power to the actuator 720 and or the circuit board(s) 730 and the components thereon.

The skeletal frame 704 and/or the accessory housing 702 in particular also support or are integrated with an accessory mounting system 750 that is configured to releasably engage or mate with the camera mounting system 120. In some embodiments, the accessory mounting system 750 includes one or more accessory rails 752 that slidably engage one or housing rail cavities 122 on the camera housing 22. The accessory mounting system 750 can be similar to or identical with the some or all of the features of the mounting system 300 or its components, including but not limited to all the variations associated with the rail plug 132 or any adaptations or configurations suitable for mating with the camera mounting system 120. In particular, the accessory rails 752 can include bumps or detents (not shown). In some embodiments, the skeletal frame 704 and/or the accessory housing 702 in particular support or are integrated with an accessory mounting system 750 for each side of the accessory housing 702 to permit attachment to either side 28 of the camera housing 22.

With reference again to FIGS. 34-47, the actuator 720 directly or indirectly includes a drive mechanism such as a control gear 760 that transfers force through a coupling mechanism 758 to rotary controller 14. In this way, the actuator 720 can induce a rotational movement of the image sensor 18. In some embodiments, the coupling mechanism 758 includes a frame gear 762 integrated with or positionable about the rotary controller 14. In some embodiments, the coupling mechanism 758 involves direct contact between the control gear 760 and the frame gear 762. In other embodiments, the coupling mechanism 758 can employ multi-component gear complexes. In an integrated embodiment, the rotary controller 14 can, for example, comprise cogs that mesh with the cogs of the control gear 760. In an alternative embodiment, the coupling mechanism 758 can comprise a belt drive, beveled gear drive, or friction drive.

In some embodiments, the camera accessory 700 is bilaterally symmetrical about a first vertical cross-sectional plane 764 from the front 766 to the back 768 of the accessory housing 702 such that the camera accessory 700 can be mounted on either side 28 of the digital video camera 10. In such embodiments, the drive mechanism can be centrally positioned and dimensionally configured so that it can engage the coupling mechanism 758 from either side 28 of the camera housing 22. Alternatively, the drive mechanism 758 can include two actuator gears 760 that rotate about axes that are offset from the first vertically cross-sectional plane 764. In some embodiments, the camera accessory 700 can be asymmetrical from side 770 to side 772 with actuator gears 760 that are asymmetrically offset from the first vertically cross-sectional plane 764. In other embodiments, the camera accessory 700 can be asymmetrical from the side 770 to side 772 and support only one accessory mounting system 750.

In some embodiments, the camera accessory 700 is bilaterally symmetrical about a second vertically cross-sectional plane 774 from the side 770 to side 772 of the accessory housing 702 such that the camera accessory 700 can be mounted to a mounting system 120 on either side 28 of the digital video camera 10. In such embodiments, the actuator 720 can be configured to provide force to a drive mechanism at both the front 766 and the back 768 of the accessory housing 702. For example, the actuator gear or gears 760 can be mounted at either the front 766 or the back 768 of the accessory housing 702 or at both the front 766 and the back 768 of the accessory housing 702. These actuator gears 760 can rotate about a central collinear axis 776 (not depicted centrally), about different axes aligned along a common plane, or about different axes offset from the first vertically cross-sectional plane 764 by the same or different distances. Such an embodiment would permit a camera accessory 700 with only a single accessory mounting system 750 to be mountable on either side 28 of the camera housing 22. Alternatively, the top and bottom halves of the camera accessory 700 (with a single central control gear 760 and only a single accessory mounting system 750) can be symmetrical about a horizontally cross-sectional plane 778 such that the camera accessory 700 can be detached from the mounting mechanism 120 on one side 28 of the digital video camera 10 and flipped upside down and brought to engage the mounting mechanism 120 on the opposite side 28 of the digital video camera 10.

Embodiments of the camera accessory 700 that can be mounted to either side 28 of the digital video camera 10 can be advantageous because some circumstances can necessitate mounting the digital video camera 10 by only one of its particular sides 28 to a person, equipment, or a vehicle, thereby dictating which side 28 of the digital video camera 10 would be available to support the camera accessory 700.

FIG. 48 is a block diagram illustrating an embodiment of the control system 800 of the camera accessory 700. In some embodiments, the control system 800 can include a controller 802, one more kinematic sensors 804 (e.g., one or more angular rate sensors 780 and/or one or more accelerometers 782), the actuator 720, and a data store 806. Any one or more of the components of the camera accessory can be located internally or externally to the camera 10 or in a distinct camera accessory 702. For example, in some instances, the controller 802, kinematic sensors 804, and data store 806 can all be located in the camera 10, while the actuator 720 is located in a separate camera accessory housing 702. In such an embodiment, the controller 802 can send control signals to the actuator 720 via wired or wireless communication. In some cases, the controller 802, data store, and actuator 720 can be located in the camera accessory housing 702, while the kinematic sensors 804 can be located internally or externally to the camera 10. Any combination of the placement of the components of the camera accessory can be used as desired. For example, with respect to FIGS. 38 and 48 and as noted previously, the angular rate sensor(s) 780 and the accelerometer(s) 782 can be connected to or integrated with one or more circuit boards 730.

In some embodiments, the accelerometer 782 includes a sleep mode to reduce the amount of power drawn from the battery 704 when the camera accessory 700 is stationary. In some embodiments, the accelerometer 782 is a three-axis accelerometer (with respect to the x, y, or z planes). However, three separate independent accelerometers 782 can be employed, or different combinations of single-axis and double-axis, or dual-axis, accelerometers 782 can be employed. In some embodiments, the accelerometer 782 is a robust-design, high-shock survivability accelerometer. In certain embodiments, the accelerometer 782 is a low-G accelerometer. In some embodiments, the accelerometer 782 is a micro-machined accelerometer or MEMS accelerometer. In some embodiments, the accelerometer 782 employs a sample rate between 400 Hz and 1000 Hz. However, the sample rate can be faster or slower as desired. In certain embodiments, the accelerometer 782 employs low power consumption and suitable linearity and has a small physical size and an output voltage range that matches the range of the analog to digital converter (so a translator can be omitted). In some embodiments, the accelerometer 782 exhibits a current consumption of less than 1000 μA. In some embodiments, the accelerometer 782 exhibits a current consumption of less than 500 μA. In some embodiments, the accelerometer 782 exhibits a current consumption in a sleep mode of less than 10 μA. In some embodiments, the accelerometer 782 exhibits a current consumption in a sleep mode of less than 5 μA. In some embodiments, the accelerometer 782 operates at a voltage of less than or equal to 5 V. In some embodiments, the accelerometer 782 has a feature size of less than or equal to 5 mm in any dimension. In certain embodiments, the accelerometer 782 exhibits sensitivity greater than 500 mV/g at 1.5 g. An embodiment of the accelerometer 782 is a Model MMA7361 L accelerometer manufactured by Freescale Semiconductor, Inc. of Tokyo, Japan.

In some embodiments, the angular rate sensor(s) 780 include one or more gyroscope(s). When more than one gyroscope is used, they can be of the same type or different types. In some embodiments, at least one of the gyroscope(s) is a single-axis gyroscope. A single-axis gyroscope can be used to monitor changes about any one of the x, y, or z planes such as for yaw, pitch or roll. In some embodiments, at least one of the gyroscope(s) is a dual-axis gyroscope. A dual-axis gyroscope can be used to monitor changes about any two of the x, y, or z planes such as for any two of yaw, pitch or roll. In certain embodiments, at least one of the gyroscope(s) is a three-axis gyroscope. In some embodiments, at least one of the gyroscope(s) is a single-axis gyroscope and at least one of the gyroscope(s) is a dual-axis gyroscope. In some embodiments, a single-axis gyroscope is used to monitor changes about the z plane, while the dual-axis gyroscope is used to monitor changes about the x and y planes. However, it will be understood that the gyroscopes can be arranged in any combination. For example, in certain embodiments, a single three-axis gyroscope can be used to measure changes about the x, y, and z planes.

In some alternative, selectively cumulative, or cumulative embodiments, the gyroscope can employ a sample rate between 400 Hz and 1000 Hz. However, the sample rate can be faster or slower as desired. In some alternative, selectively cumulative, or cumulative embodiments, the gyroscope can employ low power consumption and suitable linearity and can have a small physical size and an output voltage range that matches the range of the analog to digital converter (so a translator can be omitted). An embodiment of a single-axis gyroscope is a Model ISZ-500 Single Axis Z-Gyro manufactured by InvenSense of Sunnyvale, Calif. An embodiment of a dual-axis gyroscope is a Model 1DG-500 Integrated Dual-Axis gyro manufactured by InvenSense of Sunnyvale, Calif.

An advantage of using multiple angular rate sensors 780 and accelerometers 782 is that one accelerometer 782 can measure gravity to obtain a reference point while other accelerometers can be dedicated to track orientations that are desirable to stabilize. The angular rate sensors 780 capture the speed of the movement changes. The data obtained facilitates corrective movement data that is then fed to the actuator 720. Multiple angular rate sensors 780 and accelerometers 782 are also advantageous because the digital video camera 10 and camera accessory 700 have complex movements through space while the digital video camera 10 is capturing video, encountering accelerations and gyroscopic forces that influence the reference point for the point of view. The multiple angular rate sensors 780 and accelerometers 782 facilitate four to six axes of awareness, removing error from motion. Moreover, in some embodiments, one or two axes, such as roll and/or pitch can be corrected. In some embodiments, two angular rate sensors 780 and two accelerometers 782 are employed. In some embodiments, three angular rate sensors 780 and three accelerometers 782 are employed. In some embodiments, three angular rate sensors 780 and two accelerometers 782 are employed. In some embodiments, two angular rate sensors 780 and three accelerometers 782 are employed, etc.

In some embodiments, the angular rate sensor(s) 780 and the accelerometer(s) 782 obtain force information with respect to one or more reference axes, such as axes 590x, 590y, and 590z, or one or more reference planes, such as plane 590x-y, 590y-z, and 590x-z. The reference planes can be pre-determined by the construction of the angular rate sensor(s) 780 and the accelerometer(s) 782. In some embodiments, the correlation of the reference planes to particular geometric axes and planes can be assigned based on a presumed standard geometric orientation of the camera accessory 700. For example, a reference plane 590x-y can be correlated with the general plane of the circuit board 730, which can be parallel to a general plane of the side of the camera accessory 700, the accessory housing 702, or the side of the accessory skeletal frame 704. In such embodiments, the reference plane 590y-z can be parallel to the general plane of the top 786 or bottom 788 of the camera accessory 700, and the reference plane 590x-z can be parallel to the plane of the front 766 or back 768 of the camera accessory 700.

In some embodiments, the reference plane 590y-z can be a plane defined by a reference position 794 of the control gear 760, a reference position 796 of the gear 762, the rotation indicator 54, or the horizontal image plane 16 of the camera housing 22.

With continued reference to FIG. 48, the kinematic sensor(s) 804 can be used to sense the forces to which the camera accessory 700 (and by mounted connection, the forces to which the digital video camera 10) are subjected with respect to one or all of the reference planes, and especially with respect to the roll axis. The angular rate sensor(s) 780 and the accelerometer(s) 782 can then feed the angular force and acceleration information or position adjustment information directly or indirectly to the actuator 720.

In some embodiments, the controller 802 can receive kinematic data, such as angular force and acceleration information or position/orientation information, from the kinematic sensors (e.g., angular rate sensor(s) 780 and/or the accelerometer(s) 782). The controller 802 can analyze or convert the kinematic data into rotation instructions that are then conveyed to the actuator 720. An embodiment of the controller 802 is a Model DSPIC33FJ256GP710 manufactured by Microchip technology, Inc. of Chandler, Ariz. However, it will be understood that the controller can be implemented in a variety of ways, such as by using one or more microcontroller, processors, programmable logic devices (PLD), field programmable gate arrays (FPGA), other circuit designs, etc.

The controller 802 can also include a setup controller to adjust the actuator 720 when the accessory is powered on. In some embodiments, the setup controller can be separate from the controller 802 and can be implemented using a DC-DCV-PWM setup controller. Furthermore, although not illustrated in FIG. 48, it will be understood that voltage regulators 812 and 814 can be employed as desired along any of the communication pathways between the components.

In some embodiments, when the angular rate sensors 780 and/or the accelerometers 782 are mounted to the camera housing 22, the setup controller can bring the actuator 720 to a predetermined reference position, irrespective of the accessory's actual position with respect to the ground. In some embodiments, when the angular rate sensors 780 and/or the accelerometers 782 are rigidly mounted directly or indirectly to the camera housing 22, the setup controller can bring the actuator 720 and the imaging receptacle to a position where the horizontal image plane is “level” with respect to the ground.

The data store 806, such as an EEPROM or other programmable and/or read-only memory device, can be in communication with the angular rate sensor(s) 780, the accelerometer(s) 782, and the controller 802. In some embodiments, the data store can store computer-executable instructions that, when executed, cause the controller 802 to use data received from the kinematic sensors 804 to control the actuator 720.

With reference to FIGS. 7-9, 10-17, and 34-43, as previously discussed, the accessory mounting system 750 can be used to mount the camera accessory 700 to the mounting mechanism 120 on either side 28 of the digital video camera 10 before or after the digital video camera 10 is mounted to a person, equipment, or vehicle. Then, the rotary controller 14 of the horizon adjustment control system 12, with or without the use of horizontal projection plane 52 of the lasers sources 48, can be adjusted to initially set the horizontal image plane 16 to a desired orientation of the field of view, such as horizontal with respect to the scene.

In some embodiments, the controller 802 and/or the setup controller can let the angular rate sensor(s) 780, the accelerometer(s) 782, and the actuator 720 of the camera accessory 700 automatically adjust the rotary controller 14 of the digital video camera 10 to initially set the horizontal image plane 16 to a horizontal orientation with respect to the scene.

In certain embodiments, the camera accessory 700 can automatically adjust the actuator 720 to cause the horizontal image plane 16 to return to a horizontal orientation with respect to the scene or with respect to the initially set desired orientation of the field of view regardless of the orientation of the camera accessory 700 or the camera housing 22.

The ability of the camera accessory 700 to mechanically control the orientation of the roll axis of the horizontal image plane 16 of the image sensor 18 of the digital video camera 10 is distinct from software-based anti-jitter/stabilization techniques that rely on per pixel comparative correction. Such software-based stabilization techniques have limited compensation range of less than a few degrees off-axis. The software-based stabilization techniques also tend to reduce the image quality, crop the field of view, and distort the image.

It will be appreciated, however, that such software-based stabilization techniques can be employed in addition to or in cooperation with the mechanical image sensor orientation control afforded by the camera accessory 700. In such embodiments, the camera accessory 700 can better achieve large scale correction and the software-based stabilization techniques can be employed for very small or fine correction. In such circumstances, the software-based stabilization techniques would be less likely to express the image distortion problems due to the modified range of orientation responsibility. In some embodiments, software stabilization can be implemented through use of a 2,000-4000 resolution image sensor and fast microprocessors to provide cropped raw 1080p resolution.

Moreover, by controlling the orientation of the roll axis of the image sensor 18 separately from the orientation of the camera housing 22, the camera accessory 700 can afford more instantaneous and more accurate adjustments of horizontal image plane 16 than can be affected by using angular rate sensor(s), accelerometer(s), and actuator(s) to move the entire digital video camera 10. The image sensor 18 has a much smaller mass than the entire digital video camera 10 so that a smaller, lighter, and potentially less powerful and cheaper actuator can be employed. In addition, movement of the entire digital video camera 10 can cause positioning jitter and settling time not incurred by movement of the image sensor 18 separately from the camera housing 22.

The ability of the camera accessory 700 to control the orientation of the roll axis of the image sensor 18 separately from the orientation of the camera housing 22 allows stabilization of the horizontal image plane 16 of the image sensor 18 while the digital video camera 10, and whatever (or whoever) it can be mounted upon to move freely (particularly about the roll axis). This ability also facilitates use of the versatile mounting mechanism 120. The camera accessory 700 allows the user to pay less attention to keeping the digital video camera 10 in a stable orientation (in hand held applications as well as mounted applications) and allows the user to pay more attention to capturing the sports action or to pay more attention to participating in the sports action.

In some embodiments, the actuator 720 provides greater than or equal to 90° rotation of the horizontal image plane 16 with respect to the housing plane 20 of the camera housing 22 in each of the clockwise and counterclockwise directions. In some embodiments, the actuator 720 provides greater than or equal to 135° rotation of the horizontal image plane 16 with respect to the housing plane 20 of the camera housing 22 in each of the clockwise and counterclockwise directions. In some embodiments, the actuator 720 provides greater than or equal to 180° rotation of the horizontal image plane 16 with respect to the housing plane 20 of the camera housing 22 in each of the clockwise and counterclockwise directions. In one example, the actuator 720 provides 180° plus greater than or equal to 6° of additional rotation in each direction, providing at least a 360° rotation of the horizontal image plane 16 with respect to the housing plane 20. A large operable range of rotation can be desirable for embodiments in which the camera accessory 700 initially sets the horizontal image plane 16 to a horizontal orientation with respect to the scene after the digital video camera 10 is mounted (without manual adjustment of the rotary controller 14).

In some embodiments, the actuator 720 can provide only a small range of rotation of the horizontal image plane 16 after it has been initially set by use of the rotary controller 14 after the digital video camera 10 has been mounted. In such embodiments, the range of rotation effected by the actuator 720 can be smaller than or equal to 45°. In other such embodiments, the range of rotation affected by the actuator 720 can be smaller than or equal to 25°. In other such embodiments, the range of rotation affected by the actuator 720 can be smaller than or equal to 10°. In other such embodiments, the range of rotation effected by the actuator 720 can be smaller than or equal to 5°.

In some embodiments, the actuator 720 can include different motors for effecting large and small degrees of rotation, such as in which a first motor is adapted to drive large changes of rotation and a second motor is adapted to drive small changes of rotation such as less than 5°. Information conveyed by the angular rate sensor(s) 780 and the accelerometer(s) 782 can be fed through a filter to drive a given motor.

In some embodiments, the electronics including the sensors and software can be supported on an add on GPS card or integrated with the circuit board or chip controlling other functions of the digital video camera so that the accessory 700 can be a “dumb” actuator such as connected through a USB port on the digital video camera. The CMS card sends corrective commands via the camera's USB port to the actuators USB port. Alternatively, the accessory can be equipped with Wi-Fi or Bluetooth® to communicate through the Wi-Fi or Bluetooth® capabilities of the digital video camera 10. Moreover, some or all of the hardware/electronics including the sensors can be incorporated in a camera handle, a helmet, or other wearable device and integrated with the camera through Wi-Fi or Bluetooth.

Finally, all of the hardware/electronics can be housed inside the camera 10 with the sensors being couple to the camera housing 22. In some cases, the actuator 720 can also be housed within the camera housing 22.

In some embodiments, the image sensor 18 can be mounted on a platform within the camera housing 22, wherein the platform can be steered by voice coil actuators, piezoelectric tilt actuators, or other small or micro actuators, to facilitate correction for yaw and/or pitch movement, while the actuator 720 corrects for roll movement.

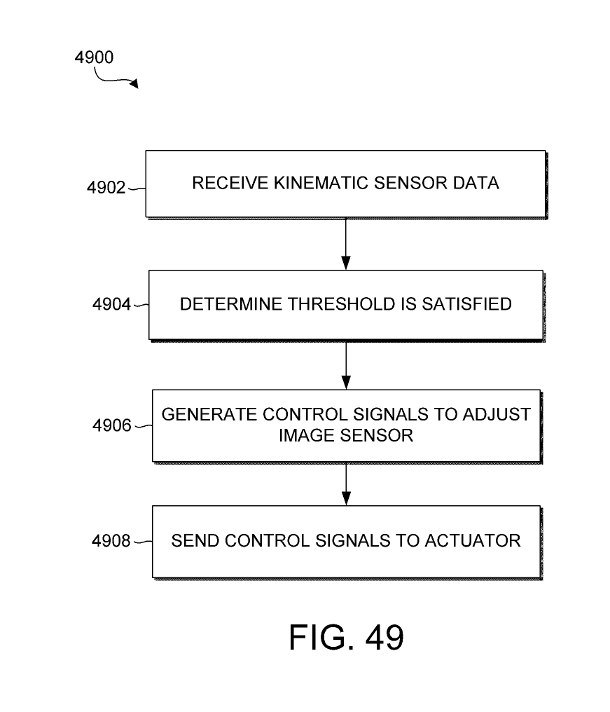

FIG. 49 is a flow diagram illustrating an embodiment of a routine implemented by the controller 802 of the accessory 700. As mentioned previously, the accessory 700 can be implemented as a distinct device with a separate housing 702 that is distinct from the camera 10 and/or as part of the camera 10.

At block 4902, the controller 802 receives sensor data from the kinematic sensors 804. The sensor data can include angular rate data and/or orientation data from one or more gyroscopes 780 and/or acceleration data from one or more accelerometers 782. Other sensors can be used as well, as desired. The controller 802 can receive the data from the sensors via wired and/or wireless communication.

At block 4904, the controller 802 uses the sensor data to determine that a measured orientation (or current orientation) and a desired orientation (or initial orientation) do not match and/or satisfy a threshold (e.g., an angle threshold, orientation threshold orientation, kinematic threshold). In some embodiments, the controller 802 can compare the measured orientation (e.g., measured angular data and/or acceleration data) with a desired orientation or an initial orientation (e.g., desired/initial angle, etc.) to determine that they do not match or satisfy the threshold. In some cases, the controller 802 can determine that they do not satisfy the threshold if they are not identical. In certain cases, the controller 802 can determine that the measured orientation and desired orientation do not match (or satisfy the threshold) if a difference between the two does not satisfy a threshold difference.

As an example, and not to be construed as limiting, if the threshold is 2° and the controller 802 determines that the difference between the desired orientation and the measured orientation is 1° (or less than or equal to 2°, as desired), the controller 802 can determine that the measured orientation does not satisfy the threshold (or the difference between the measured orientation and the desired orientation does not satisfy a threshold difference). However, if the controller 802 determines that the difference between the measured orientation and the desired orientation is 3° (or greater than or equal to 2°, as desired), the controller 802 can determine that the measured orientation satisfies the threshold (or the difference between the measured orientation and the desired orientation satisfies the threshold difference).

In addition, in some embodiments, if the controller 802 determines that the accessory is accelerating or moving away from the desired orientation, it can determine that the threshold is satisfied. With continued reference to the example, above, if the controller 802 determines that the difference between the measured orientation and the desired orientation is 1.5° and the measured orientation is accelerating or moving towards 2° (and beyond), the controller 802 can determine that the threshold is satisfied (or that the threshold difference is satisfied).

In some cases, the desired orientation (or initial orientation) can be pre-programmed or it can be dynamically adjusted by the user. For example, the desired orientation can be set as the orientation of the camera when the mount system 120 is directly below or on the side of the camera housing 22 (or any other desired orientation). In certain embodiments, the desired orientation can be determined based at least in part on the orientation of the image sensor 18. For example, the desired orientation can be configured as the orientation of the image sensor 18 when the camera 10 is powered on, when an orientation setting input (e.g., a button, switch, etc.) is activated, and/or when the image sensor 18 is perpendicular to the ground (or any other desired orientation). In some cases, the desired orientation is based at least in part on an input of a user, such as a button or switch being activated/de-activated by the user, etc.

At block 4906, based at least in part on the determination that the threshold difference is not satisfied, the controller 802 can generate one or more control signals to adjust the rotary controller 14 and/or image sensor 18. The control signals can include data and/or instructions to cause the actuator 720 to move the rotary controller 14 and/or image sensor 18 such that the measured orientation and the desired orientation satisfy the threshold difference. At block 4908, the controller 802 sends the control signals to the actuator 720.

Fewer, more, or different blocks can be used as part of routine 4900. For example, in some embodiments, routine 4900 can include determining the measured orientation of the accessory/camera, etc. In certain embodiments, the routine 4900 can omit block 4904 and can simply generate the control signals based at least in part on the received sensor data, as desired.

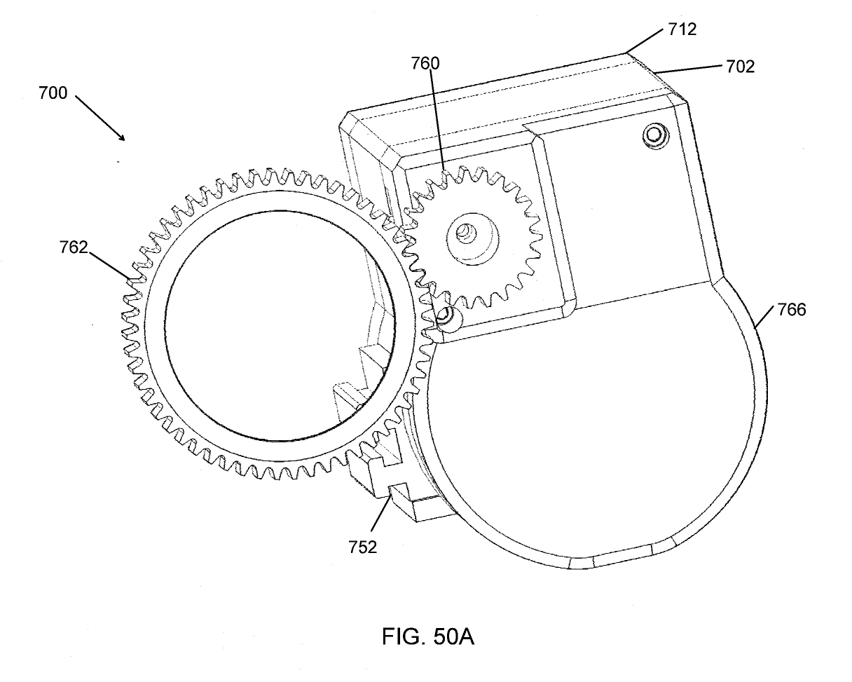

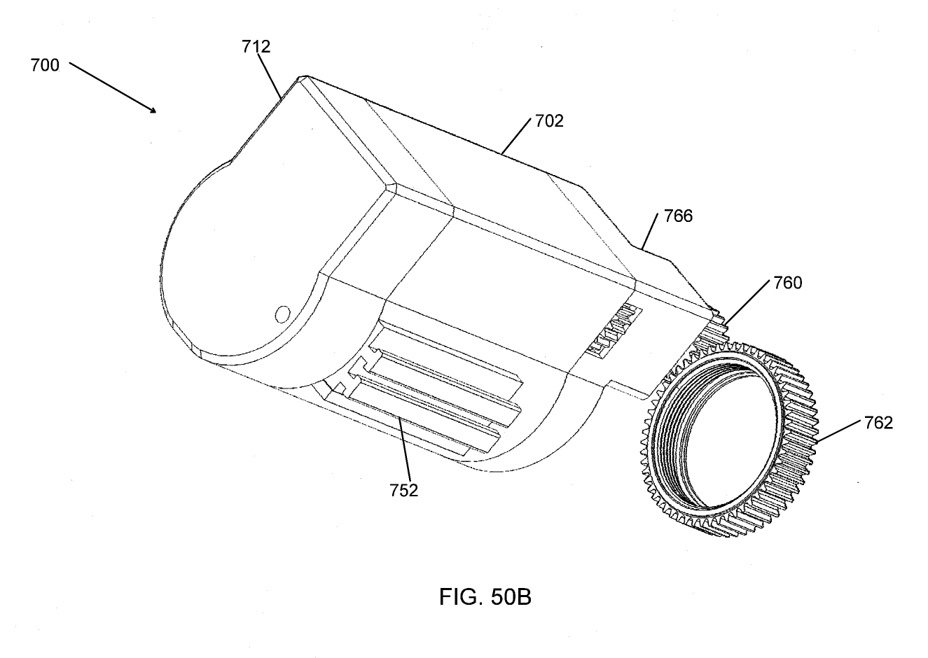

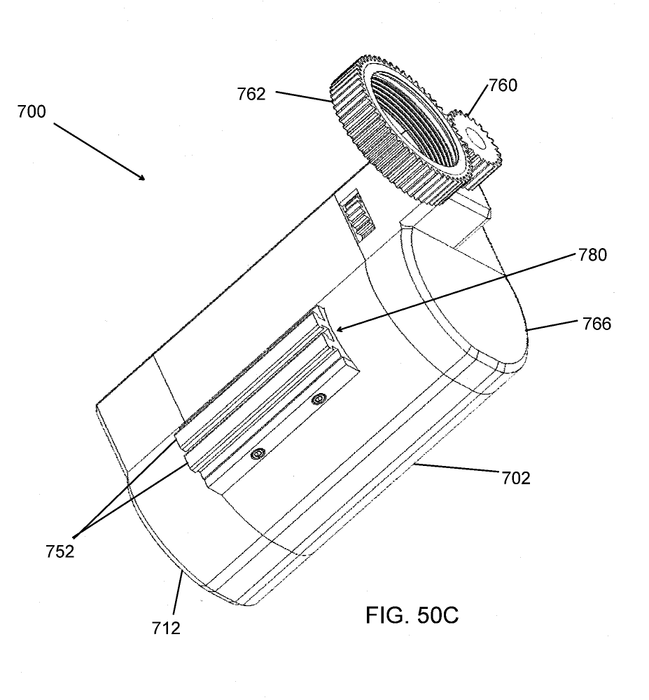

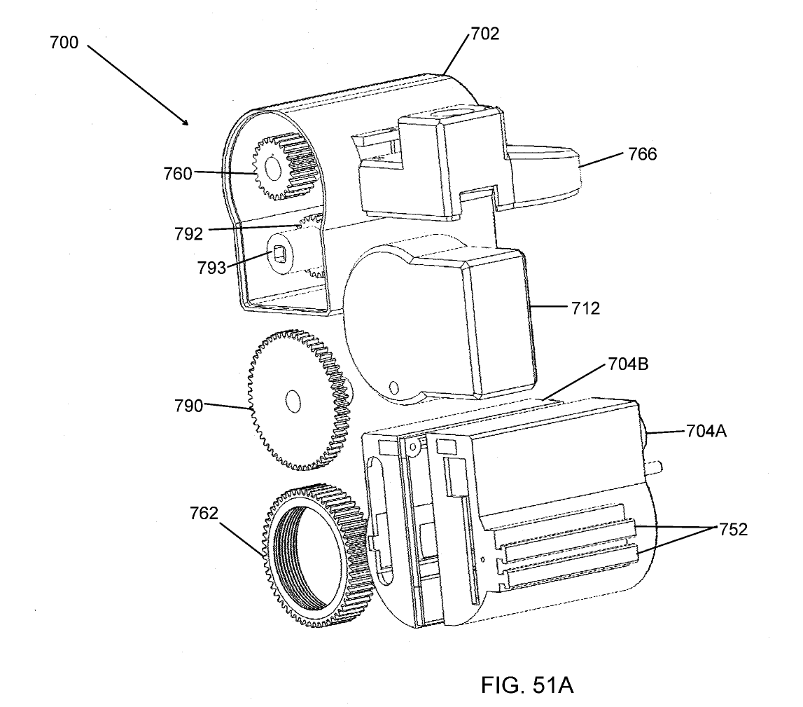

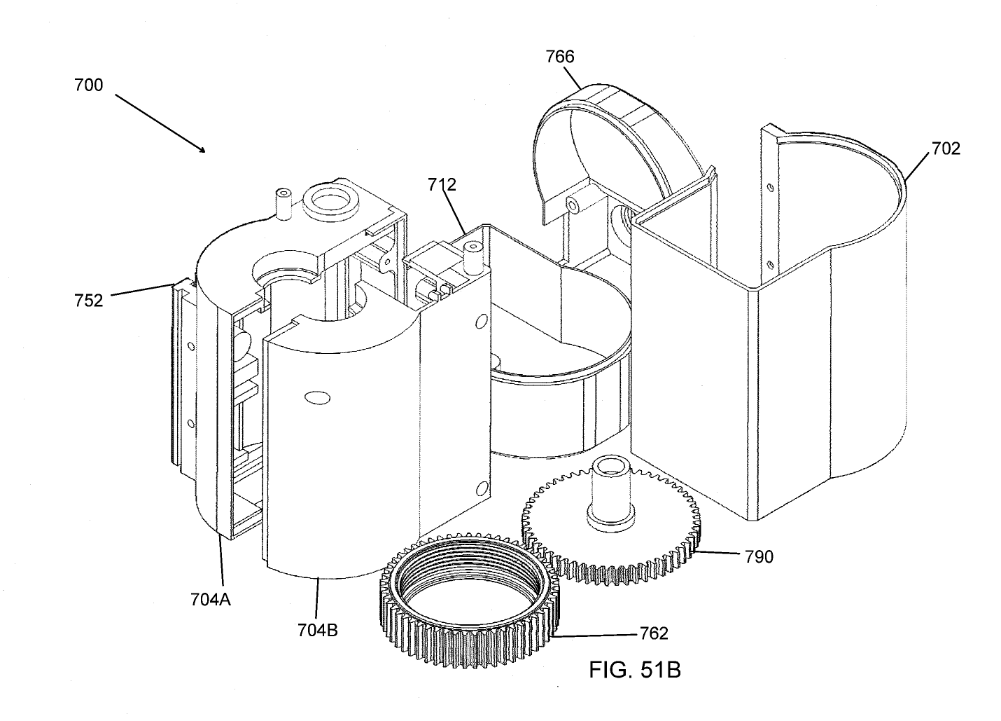

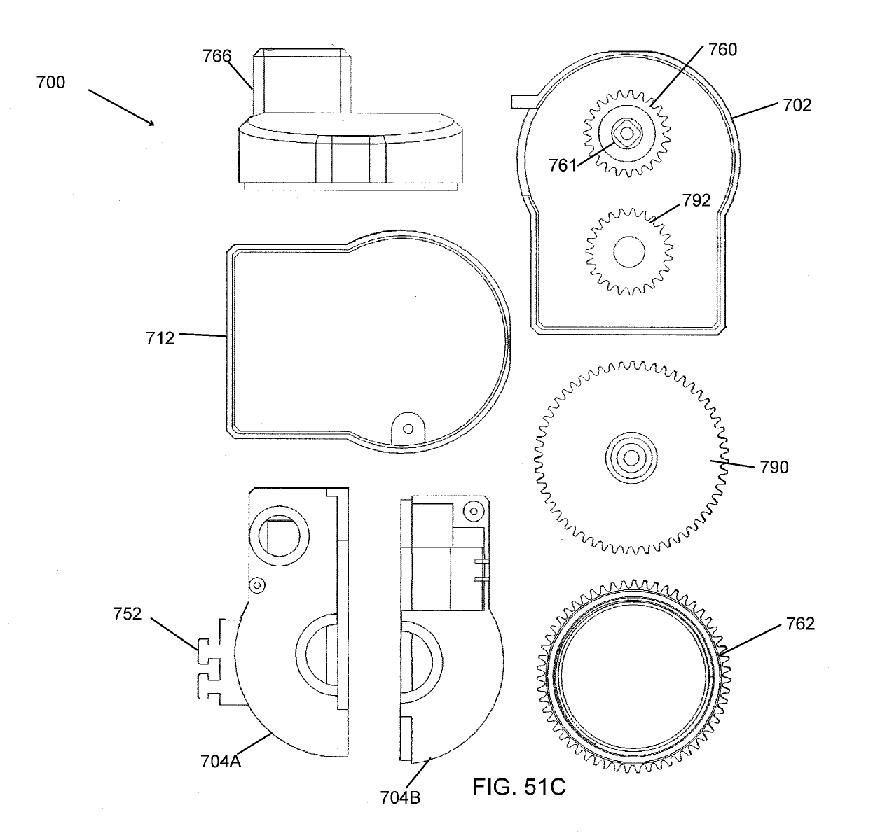

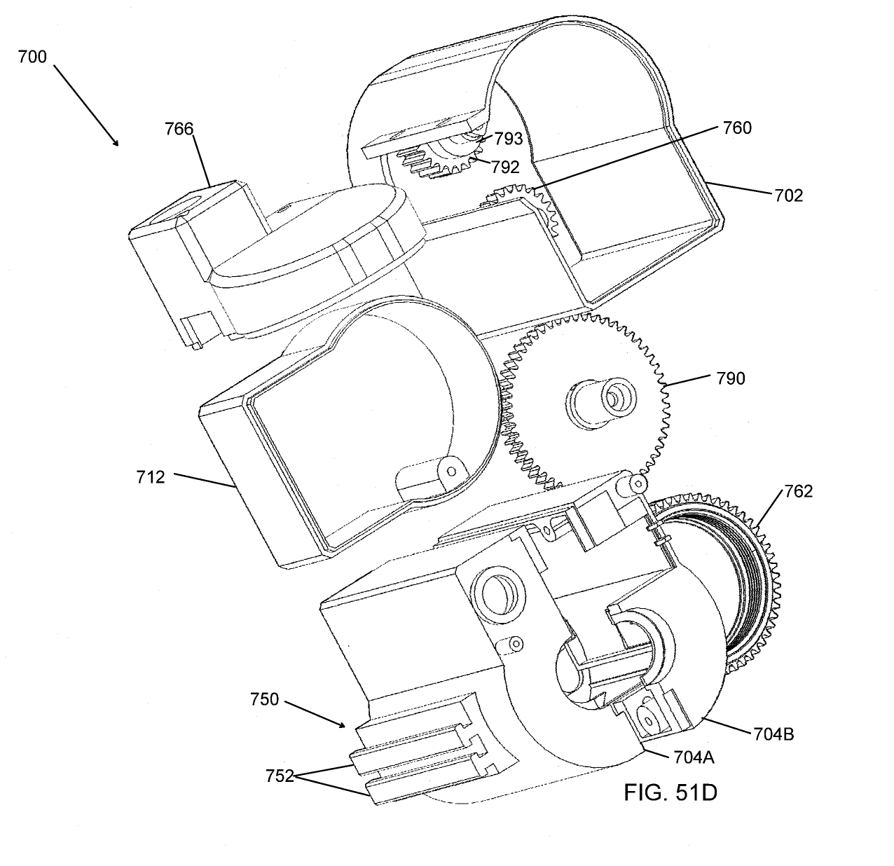

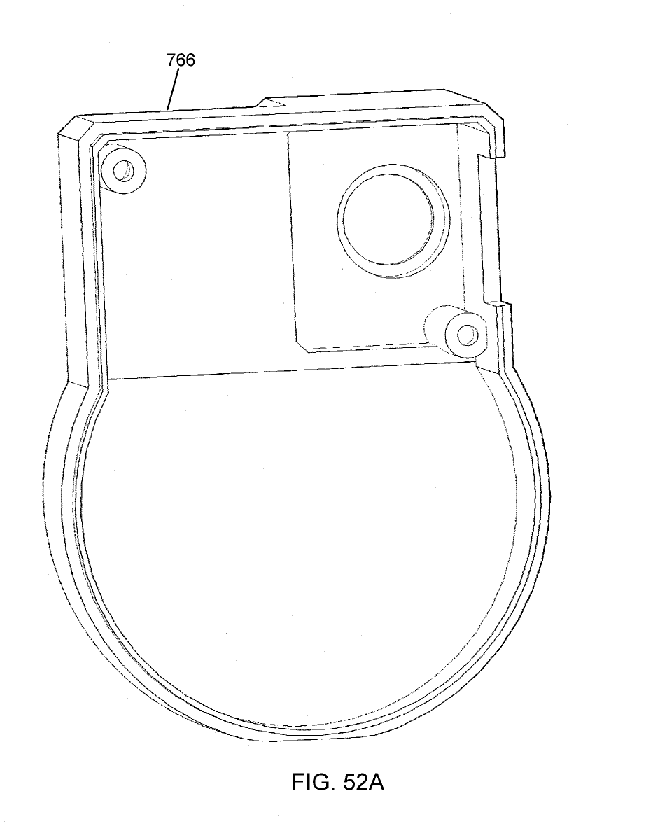

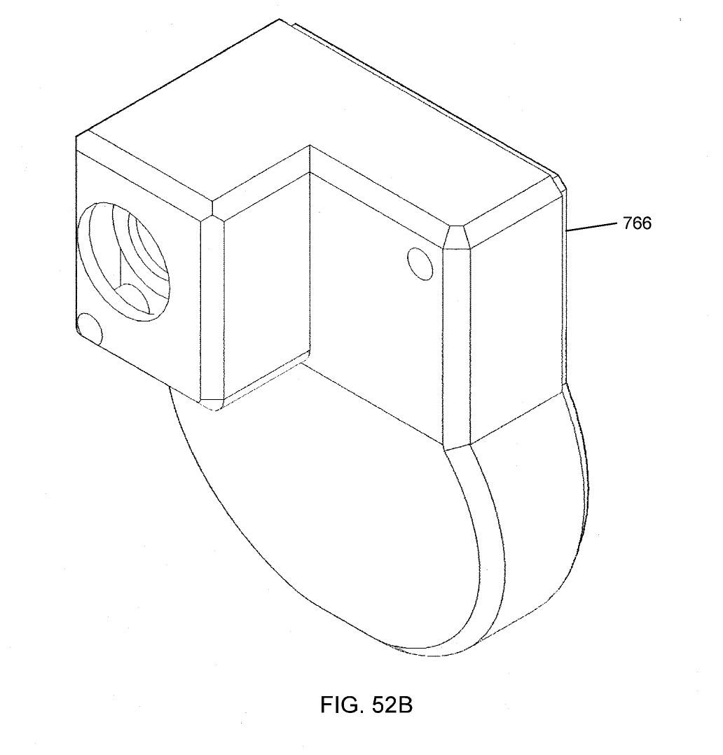

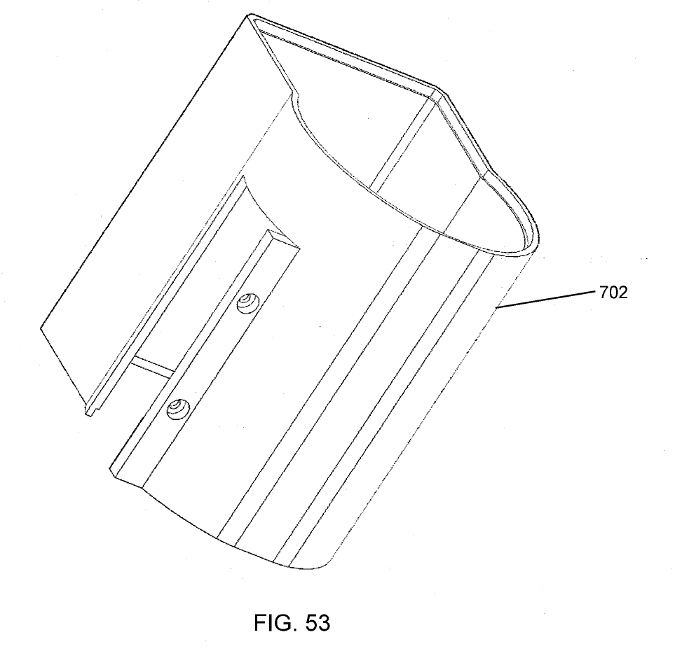

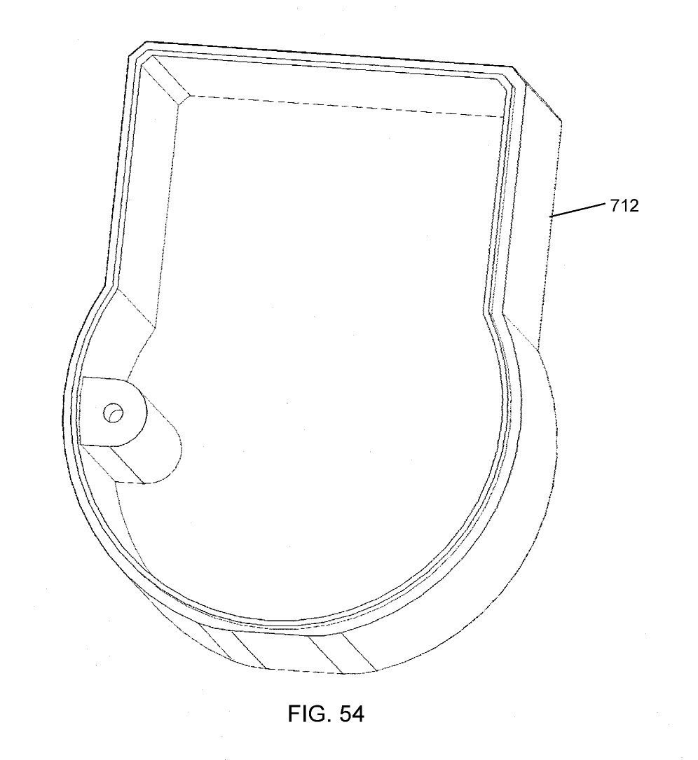

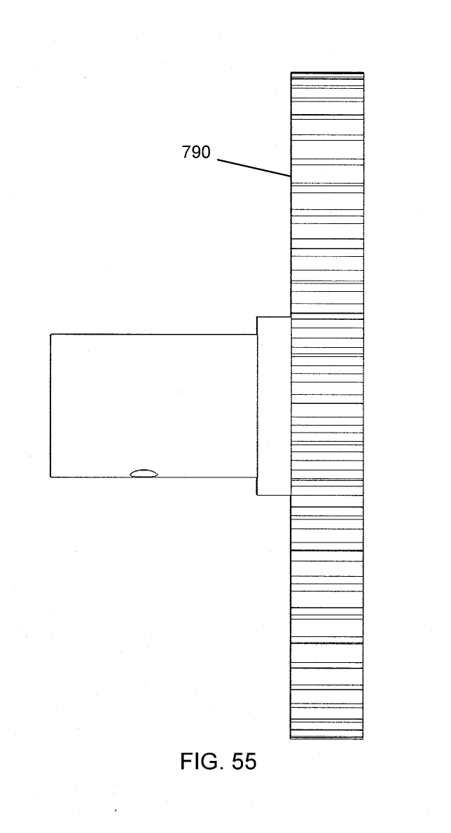

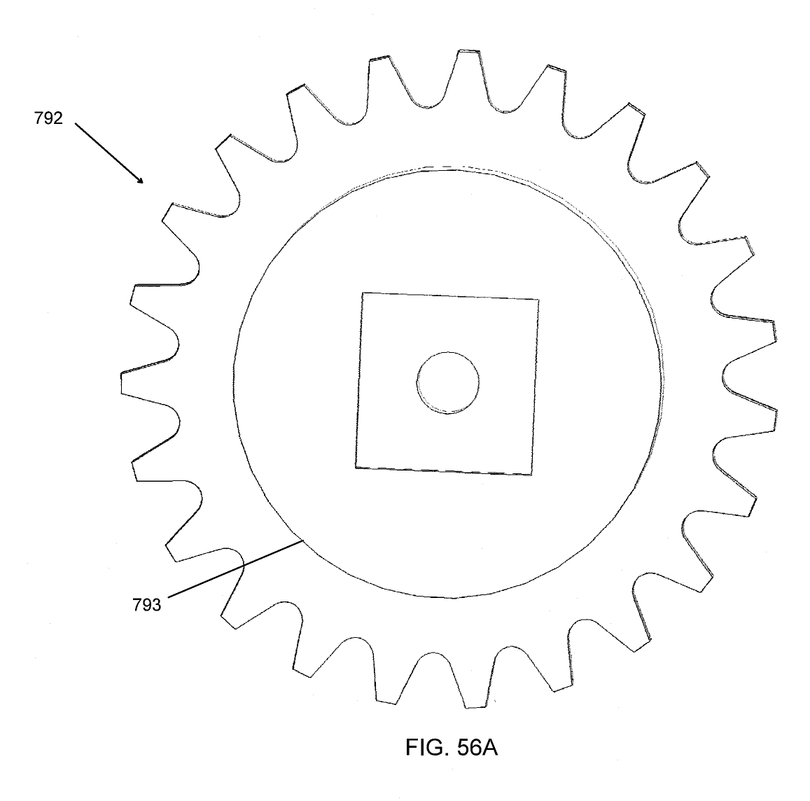

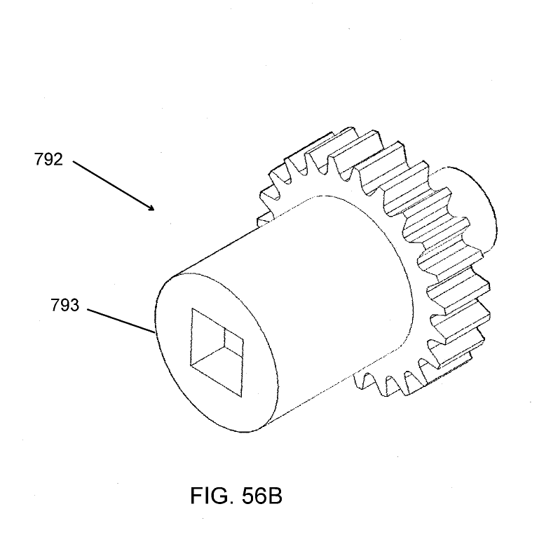

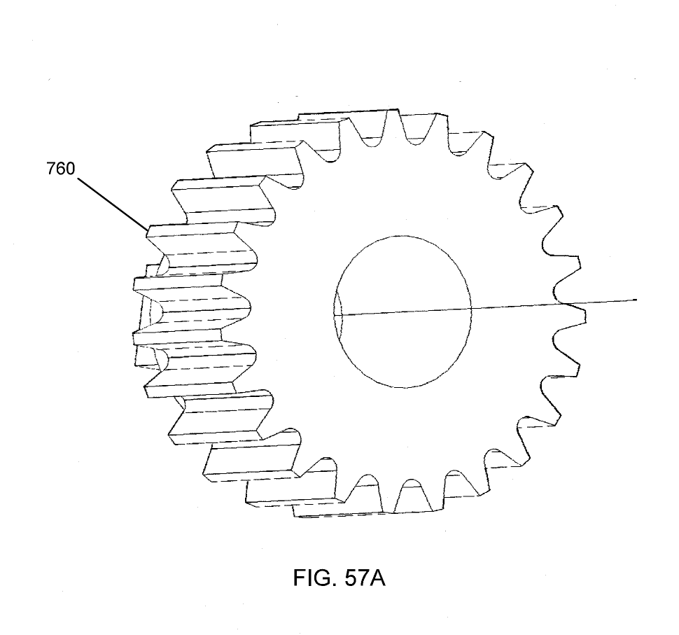

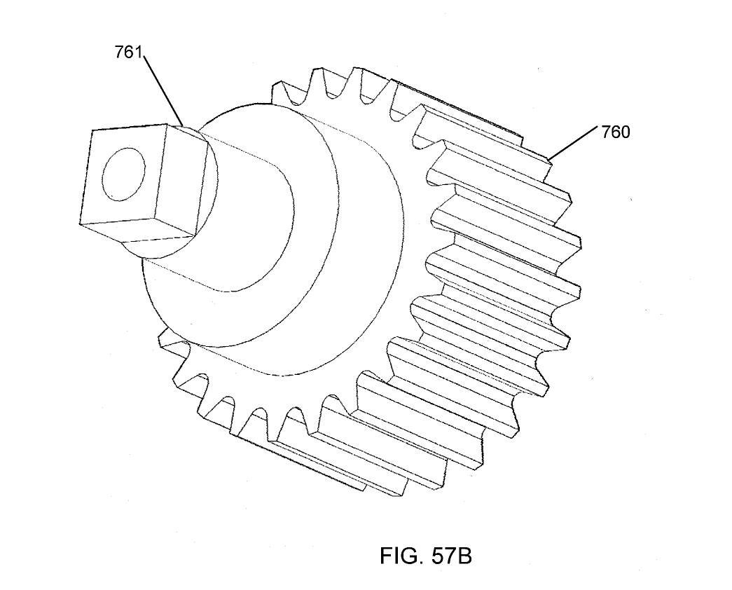

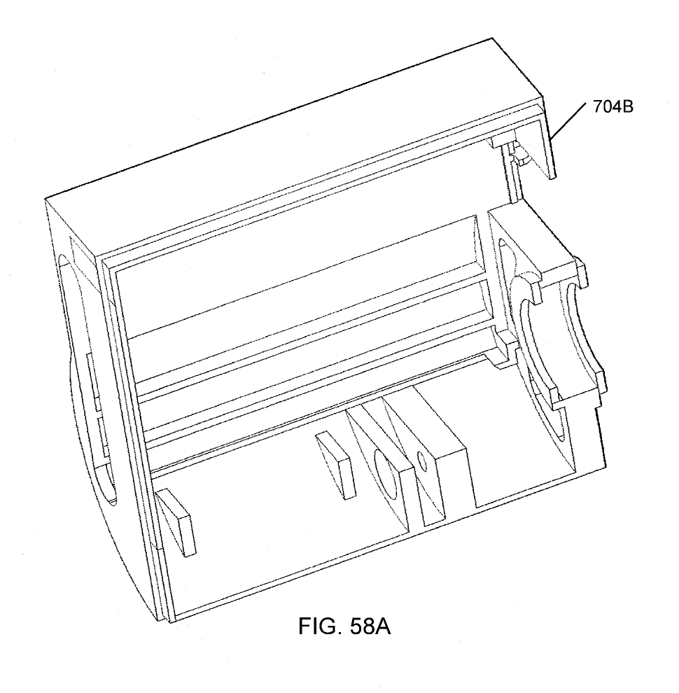

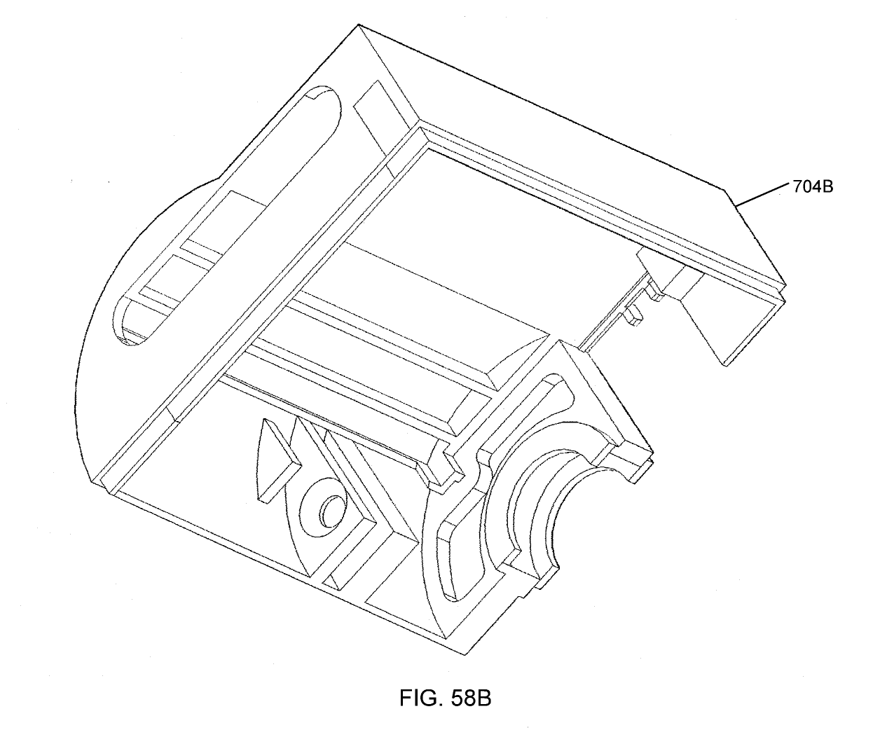

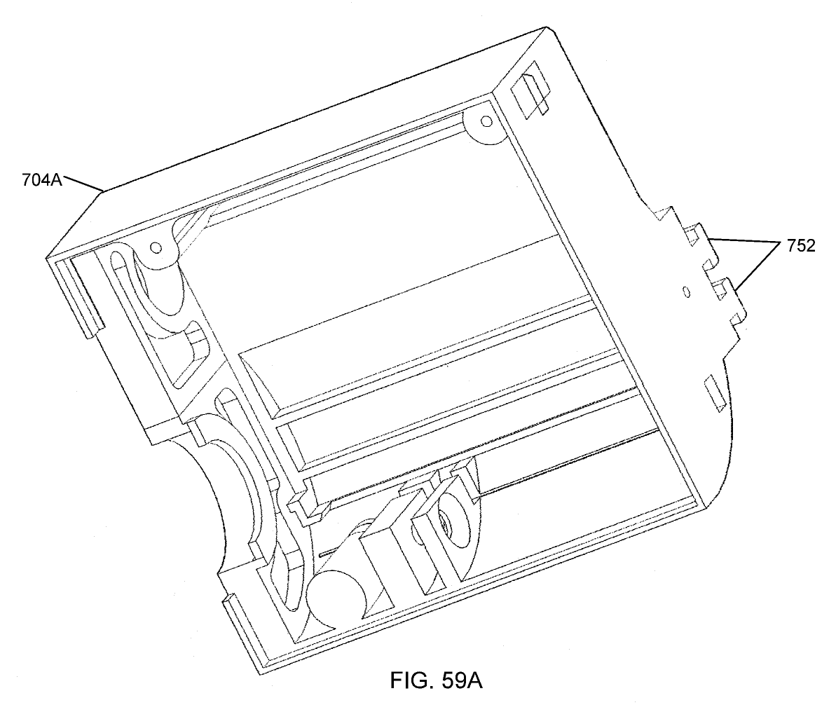

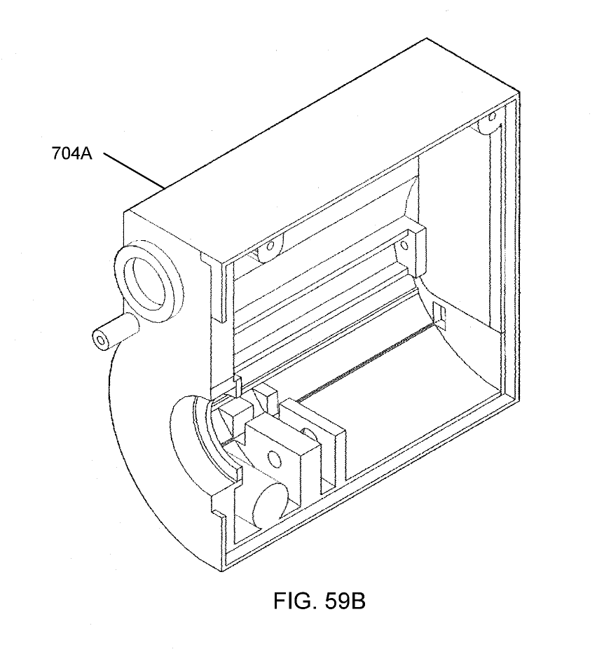

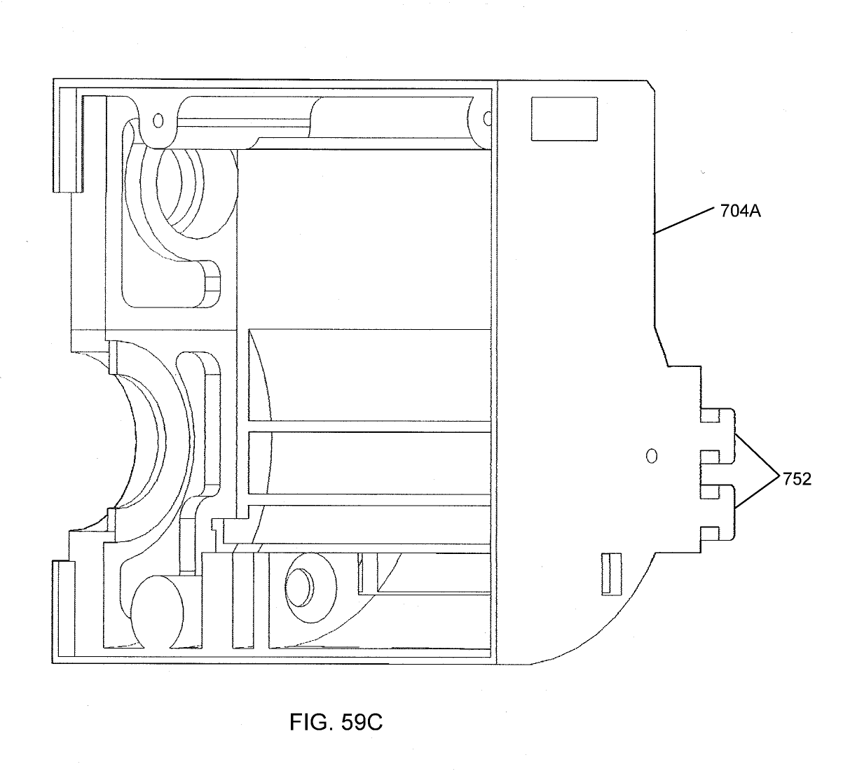

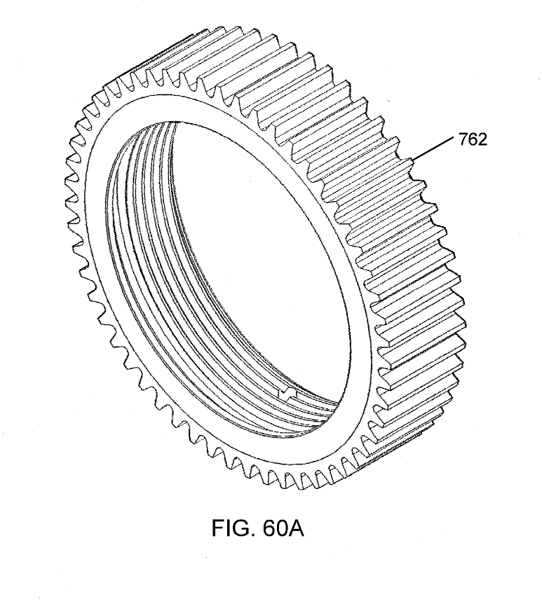

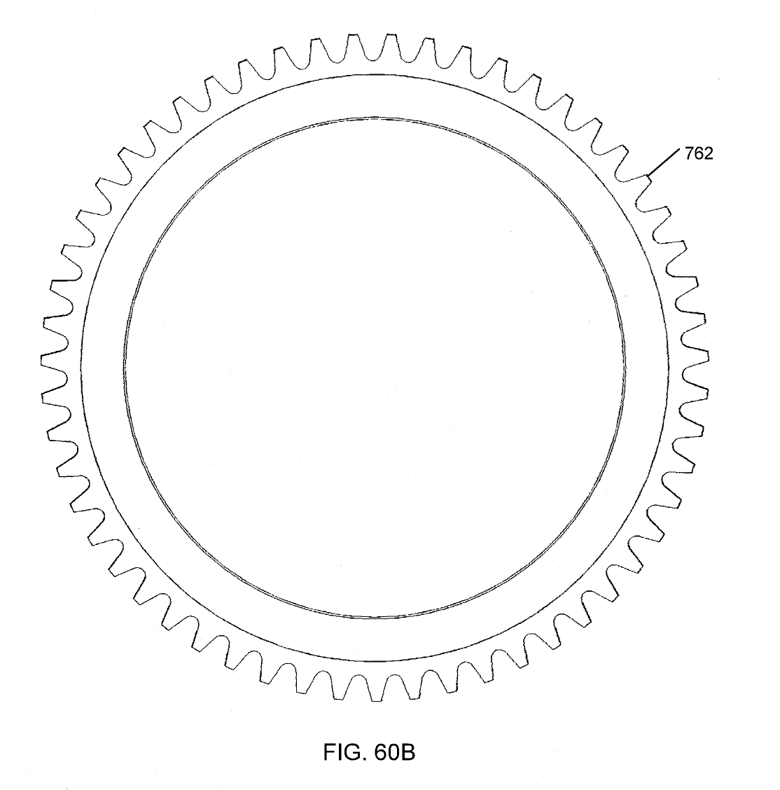

FIGS. 50A thru 60B show an alternative embodiment of accessory 700 and some of its individual components. As illustrated in FIGS. 50A-50C and 51A-51C, the accessory can include a housing 702, a back cover 712, a front 766, a control gear 760, a frame gear 762, an accessory mounting system including accessory rails 752, as well as skeletal frame members 704A, 704B and gear drive members 790, 792. Although not illustrated in FIGS. 50A thru 60B, it will be understood that the accessory 700 can include any one or any combination of the components described above with reference to FIGS. 34-49, such as a controller 802, kinematic sensors 804, actuator 720, data store 806, battery 740, voltage booster, and/or LEDs, etc.

In some embodiments, the gear drive member 790 can be coupled with the actuator (not shown) and with the gear drive member 792, such that movement of the actuator causes the gear drive member 790 to rotate, which in turn causes the gear drive member 792 to rotate. The gear drive member 792 can include a drive shaft portion 793 that couples with a drive shaft portion 761 of the control gear 760. It will be understood that the gear drive members 790, 792 can be arranged in a variety of ways in order to translate movement from the actuator to the gear actuator 760.

It will be obvious to those having skill in the art that many changes can be made to the details of the above-described embodiments without departing from the underlying principles of the invention. For example, skilled persons will appreciate that subject matter of any sentence or paragraph can be combined with subject matter of some or all of the other sentences or paragraphs, except where such combinations are mutually exclusive.

For example, although illustrated in FIGS. 39-47 as being paired with a hands free point-of-view camera 10, it will be understood that the accessory 700 and/or some its components need not be paired with the hands free point-of-view camera 10. The accessory 700 or some of its components can be employed to adjust the orientation of a movable image sensor of any hand-held digital video camera to smooth the video captured during inadvertent movement of the camera.

Furthermore, in some instances, one or more components of the accessory 700 can be embedded within, or coupled to, a video camera, such as the point-of-view camera 10 or other type of video camera. In such embodiments, the camera can automatically rotate the image sensor 18 based at least in part on data received from the sensors 780, above. For example, the camera 10 can include the controller 802, kinematic sensors 804, and the actuator 720. The controller 802 can be a separate controller or form part of the processor 500 of the video camera. As described in greater detail above, with reference to FIG. 48, the controller 802 can use the data received from the kinematic sensors 804 to control the actuator 720 and rotate the image sensor 18, camera lens 26, and/or the rotary controller 14 of the camera 10.

### Non-Limiting Example Embodiments

Various non-limiting example embodiments of the disclosure can be described in view of the following clauses:
Clause 1. A digital video camera, comprising:
   a camera housing having a first orientation with respect to a scene;
   a camera lens;
   an image sensor located within the camera housing and configured to capture light propagating through the camera lens, the light representing the scene;
   an angular rate sensor configured to sense an orientation of the digital video camera;
   an accelerometer configured to sense acceleration of the digital video camera;
   an actuator; and
   a controller communicatively coupled to the angular rate sensor and the accelerometer, the controller configured to:
      receive orientation data from the angular rate sensor and acceleration data from the accelerometer,
      generate one or more control signals based at least in part on the orientation data and the acceleration data, and
      communicate the one or more control signals to the actuator, wherein the actuator induces a rotational movement of the image sensor such that the image sensor has a second orientation with respect to the scene that is different from the first orientation.
Clause 2. A digital video camera, comprising:
   a camera housing having a first orientation with respect to a scene;
   a camera lens;
   an image sensor located within the camera housing and configured to capture light propagating through the camera lens, the light representing the scene;
   one or more kinematic sensors configured to sense at least one of orientation and movement of the digital video camera; and
   an actuator configured to induce a rotational movement of the image sensor in response to the at least one of orientation and movement of the digital video camera such that the image sensor has a second orientation with respect to the scene that is different from the first orientation.
Clause 3. The digital video camera of clause 2, further comprising:
   a controller communicatively coupled to the one or more kinematic sensors and the actuator, the controller configured to:
      receive kinematic data from the one or more kinematic sensors,
      determine a measured orientation of the digital video camera based at least in part on the received kinematic data;
      determine a threshold difference between the measured orientation and a desired orientation of the digital video camera is not satisfied;
      based at least in part on the determination that the threshold difference is not satisfied, generate one or more control signals for the actuator; and
      send the one or more control signals to the actuator, wherein the one or more control signals cause the actuator to induce the rotational movement of the image sensor.
Clause 4. The digital video camera of clause 3, wherein the desired orientation is determined based at least in part on a user input to the digital video camera.
Clause 5. The digital video camera of any of clauses 2-4, wherein the actuator induces the rotational movement of the image sensor about a longitudinal axis of the digital video camera.
Clause 6. The digital video camera of any of clauses 2-5, wherein the digital video camera is operable for mounting to a person, a vehicle, or equipment such that the camera housing has the first orientation with respect to the scene such that the digital video camera is operable for hands-free capture of video during motion of the person, the vehicle, or the equipment involved in an action sports activity.
Clause 7. The digital video camera of any of clauses 2-6, wherein the one or more kinematic sensors comprise one or more accelerometers configured to sense acceleration of the digital video camera, and wherein the actuator is configured to induce the rotational movement of the image sensor based at least in part on the acceleration of the digital video camera.
Clause 8. The digital video camera of clause 7, wherein the one or more accelerometers are positioned externally to the camera housing.
Clause 9. The digital video camera of any of clauses 7 and 8, wherein the one or more accelerometers comprise a three-axis accelerometer.
Clause 10. The digital video camera of any of clauses 7-9, wherein the one or more accelerometers comprise a dual-axis accelerometer and a single-axis accelerometer.
Clause 11. The digital video camera of any of clauses 7-10, wherein the one or more accelerometers employ a sample rate between 700 Hz and 1000 Hz.
Clause 12. The digital video camera of any of clauses 7-11, wherein the one or more accelerometers employ low power consumption and suitable linearity and have a small physical size and an analog to digital converter.
Clause 13. The digital video camera of any of clauses 7-12, wherein the one or more accelerometers are positioned within the camera housing.
Clause 14. The digital video camera of clause 13, wherein the one or more accelerometers communicates through a GPS port.
Clause 15. The digital video camera of any of clauses 7-14, wherein the one or more kinematic sensors comprise one or more angular rate sensors configured to sense the orientation of the digital video camera, and wherein the actuator is configured to induce the rotational movement of the image sensor based at least in part on the orientation of the digital video camera.
Clause 16. The digital video camera of clause 15, wherein the one or more angular rate sensors comprises a dual-axis gyroscope.
Clause 17. The digital video camera of any of clauses 15 and 16, wherein the one or more angular rate sensors comprises a dual-axis gyroscope and a single axis gyroscope.
Clause 18. The digital video camera of any of clauses 15-17, wherein the one or more angular rate sensors comprise different types of gyroscopes.
Clause 19. The digital video camera of any of clauses 15-18, wherein the one or more angular rate sensors employ a sample rate between 400 Hz and 1000 Hz.
Clause 20. The digital video camera of any of clauses 15-19, wherein the one or more angular rate sensors employ low power consumption and suitable linearity and have a small physical size and an analog to digital converter.
Clause 21. The digital video camera of any of clauses 2-20, wherein the actuator and the image sensor are powered by different batteries.
Clause 22. The digital video camera of any of clauses 2-21, wherein the one or more kinematic sensors comprise at least one accelerometer and at least one angular rate sensor.
Clause 23. The digital video camera of any of clauses 2-22, wherein at least one of the at least one angular rate sensor and the at least one accelerometer are rigidly mounted directly or indirectly to the camera housing.
Clause 24. A method, comprising:
   receiving kinematic data of a digital video camera from a kinematic sensor coupled to the digital video camera, wherein a camera housing of the digital video camera has a first orientation with respect to a scene; and
   causing an actuator to induce a rotational movement of an image sensor of the digital video camera in response to the at least one of orientation and movement of the digital video camera such that the image sensor has a second orientation with respect to the scene that is different from the first orientation.
Clause 25. The method of clause 24, wherein the actuator induces the rotational movement of the image sensor about a longitudinal axis of the digital video camera.
Clause 26. A camera accessory, comprising:
   an accessory housing having an accessory mounting system for engaging a camera mounting system of a digital video camera, the digital video camera comprising an image sensor and a camera housing having a first orientation with respect to a scene;
   an angular rate sensor configured to sense orientation of the camera accessory;
   an accelerometer configured to sense acceleration of the camera accessory;
   an actuator;
   a control gear directly or indirectly coupled to the actuator and a frame gear, wherein the frame gear is coupled to the digital video camera; and
   a controller communicatively coupled to the angular rate sensor and the accelerometer, the controller configured to:
      receive orientation data from the angular rate sensor and acceleration data from the accelerometer,
      generate one or more control signals based at least in part on the orientation data and the acceleration data, and
      communicate the one or more control signals to the actuator, wherein the actuator induces a rotational movement of the control gear and the frame gear such that the image sensor of the digital video camera has a second orientation with respect to the scene that is different from the first orientation.
Clause 27. A camera accessory, comprising:
   an accessory housing having an accessory mounting system operable for engaging a camera mounting system of a digital video camera, the digital video camera comprising an image sensor and a camera housing having a first orientation with respect to a scene;
   one or more kinematic sensors configured to sense at least one of orientation and movement of the digital video camera;
   a control gear coupled a frame gear, wherein the frame gear is coupled to the digital video camera; and
   an actuator directly or indirectly coupled to the control gear, the actuator configured to induce a rotational movement of the control gear and the frame gear such that the image sensor of the digital video camera has a second orientation with respect to the scene that is different from the first orientation.
Clause 28. The camera accessory of clause 27, wherein the actuator induces the rotational movement of the image sensor about a longitudinal axis of the camera accessory.
Clause 29. The camera accessory of any of clauses 27 and 28, further comprising:
   a controller communicatively coupled to the one or more kinematic sensors and the actuator, the controller configured to:
      receive kinematic data from the one or more kinematic sensors,
      determine a measured orientation of the digital video camera based at least in part on the received kinematic data;
      determine a threshold difference between the measured orientation and a desired orientation of the digital video camera is not satisfied;
      based at least in part on the determination that the threshold difference is not satisfied, generate one or more control signals for the actuator; and
      send the one or more control signals to the actuator, wherein the one or more control signals cause the actuator to induce the rotational movement of the image sensor.
Clause 30. The camera accessory of clause 29, wherein the desired orientation is determined based at least in part on a user input to at least one of the digital video camera and the camera accessory.
Clause 31. The camera accessory of any of clauses 27-30, wherein the one or more kinematic sensors comprise one or more accelerometers configured to sense acceleration of the camera accessory, and wherein the actuator is configured to induce the rotational movement of the control gear based at least in part on the acceleration of the camera accessory.
Clause 32. The camera accessory of clause 31, wherein the one or more accelerometers comprise a dual-axis accelerometer and a single axis accelerometer.
Clause 33. The camera accessory of any of clauses 31 and 32, wherein the one or more accelerometers comprise a three-axis accelerometer.
Clause 34. The camera accessory of any of clauses 31-33, wherein the one or more accelerometers employ a sample rate between 400 Hz and 1000 Hz.
Clause 35. The camera accessory of any of clauses 31-34, wherein the one or more accelerometers employ low power consumption and suitable linearity and have a small physical size and an analog to digital converter.
Clause 36. The camera accessory of any of clauses 27-35, wherein the one or more kinematic sensors comprise one or more angular rate sensors configured to sense an orientation of the camera accessory, and wherein the actuator is configured to induce the rotational movement of the control gear based at least in part on the orientation of the camera accessory.
Clause 37. The camera accessory of clause 36, wherein the one or more angular rate sensors comprise a dual-axis gyroscope.
Clause 38. The camera accessory of any of clauses 36 and 37, wherein the one or more angular rate sensors comprise a dual-axis gyroscope and a single axis gyroscope.
Clause 39. The camera accessory of any of clauses 36-38, wherein the one or more angular rate sensors comprise different types of gyroscopes.
Clause 40. The camera accessory of any of clauses 36-39, wherein one or more angular rate sensors employ a sample rate between 400 Hz and 1000 Hz.
Clause 41. The camera accessory of any of clauses 36-40, wherein the one or more angular rate sensors comprise employ low power consumption and suitable linearity and has a small physical size and an analog to digital converter.
Clause 42. A method, comprising:
   receiving kinematic data of a camera accessory from a kinematic sensor coupled to the camera accessory, the camera accessory coupled to a digital video camera having a first orientation with respect to a scene; and
   causing an actuator to induce a rotational movement of an image sensor of the digital video camera coupled to the camera accessory in response to the at least one of orientation and movement of the camera accessory such that the image sensor has a second orientation with respect to the scene that is different from the first orientation.
Clause 42. A digital video camera operable for capturing video during motion of the video camera, comprising:
   a camera housing supporting a switch, wherein the camera housing is operable to have a first orientation with respect to a scene;
   camera housing an imaging receptacle supported by the camera housing, wherein the imaging receptacle supports a lens and an image sensor, and wherein the image sensor is operable for capturing light propagating through the lens and representing the scene, wherein the imaging receptacle is operable for rotation independent of the camera, wherein the image sensor is supported in rotational congruence with the imaging receptacle such that rotation of the imaging receptacle causes rotation of the image sensor and such that the image sensor is operable to have a second orientation with respect to the scene, wherein the second orientation is different from the first orientation;
   an angular rate sensor operable to obtain angular rate information concerning angular forces experienced by the camera housing;
   an accelerometer operable to obtain acceleration information concerning acceleration experienced by the camera housing; and
   an actuator directly or indirectly responsive to angular rate information obtained by the angular rate sensor and the acceleration information obtained by the accelerometer, wherein the actuator is operable to directly or indirectly rotate the imaging receptacle in response to the angular rate information, the acceleration information, or both of the angular rate information and the acceleration information such that the actuator is operable to cause a change of the second orientation of the image sensor with respect to the scene without causing a change to the first orientation of the camera housing with respect to the scene.
Clause 43. A digital video camera operable for capturing video during motion of the video camera, comprising:
   a camera housing supporting a switch, wherein the camera housing is operable to have a first orientation with respect to a scene;
   an imaging receptacle supported by the camera housing, wherein the imaging receptacle supports a lens and an image sensor, and wherein the image sensor is operable for capturing light propagating through the lens and representing the scene, wherein the imaging receptacle is operable for rotation independent of the camera, wherein the image sensor is supported in rotational congruence with the imaging receptacle such that rotation of the imaging receptacle causes rotation of the image sensor and such that the image sensor is operable to have a second orientation with respect to the scene, wherein the second orientation is different from the first orientation;
   an angular rate sensor operable to obtain angular rate information concerning angular forces experienced by the angular rate sensor;
   an accelerometer operable to obtain acceleration information concerning acceleration experienced by the accelerometer; and
   an actuator directly or indirectly responsive to angular rate information obtained by the angular rate sensor and the acceleration information obtained by the accelerometer, wherein the actuator is operable to directly or indirectly rotate the imaging receptacle in response to the angular rate information, the acceleration information, or both of the angular rate information and the acceleration information such that the actuator is operable to cause a change of the second orientation of the image sensor with respect to the scene without causing a change to the first orientation of the camera housing with respect to the scene.
Clause 44. The digital video camera of clause 43, wherein the camera housing is operable for mounting to a person, a vehicle, or equipment such that the camera housing has the first orientation with respect to the scene such that the digital video camera is operable for hands-free capture of video during motion of the person, the vehicle, or the equipment involved in an action sports activity.
Clause 45. The digital video camera of any of clauses 43 and 44, wherein the camera is a handheld camera.
Clause 46. The digital video camera of any of clauses 43-45, wherein the accelerometer is positioned externally to the camera housing.
Clause 47. The digital video camera of any of clauses 43-46, wherein the accelerometer is positioned within the camera housing.
Clause 48. The digital video camera of any of clauses 43-47, wherein the accelerometer communicates through a GPS port.
Clause 49. The digital video camera of any of clauses 43-48, further comprising one or more additional accelerometers operable to obtain additional acceleration information concerning acceleration experienced by the camera housing, wherein the actuator is responsive to the additional acceleration information.
Clause 50. The digital video camera of any of clauses 43-49, wherein the accelerometer comprises a three-axis accelerometer.
Clause 51. The digital video camera of any of clauses 43-50, wherein the accelerometer comprises a dual-axis accelerometer and a single axis accelerometer.
Clause 52. The digital video camera of any of clauses 43-51, wherein the accelerometer employs a sample rate between 4700 Hz and 1000 Hz.
Clause 53. The digital video camera of any of clauses 43-52, wherein the accelerometer employs low power consumption and suitable linearity and has a small physical size and a matching analog to digital converter.
Clause 54. The digital video camera of any of clauses 43-53, wherein the angular rate sensor is positioned externally to the camera housing.
Clause 55. The digital video camera of any of clauses 43-54, wherein the angular rate sensor comprises a dual-axis gyroscope.
Clause 56. The digital video camera of any of clauses 43-55, wherein the angular rate sensor comprises a dual-axis gyroscope and a single axis gyroscope.
Clause 57. The digital video camera of any of clauses 43-56, further comprising one or more additional angular rate sensors operable to obtain additional angular rate information concerning angular forces experienced by the camera housing, wherein the actuator is responsive to the additional a angular rate information.
Clause 58. The digital video camera of any of clauses 43-57, wherein the angular rate sensor and the additional angular rate sensor(s) comprise different types of gyroscopes.
Clause 59. The digital video camera of any of clauses 43-58, wherein the angular rate sensor employs a sample rate between 400 Hz and 1000 Hz.
Clause 60. The digital video camera of any of clauses 43-59, wherein the angular rate sensor employs low power consumption and suitable linearity and has a small physical size and a matching analog to digital converter.
Clause 61. The digital video camera of any of clauses 43-60, wherein at least one of the accelerometer and the angular rate sensor are integrated onto a computer chip or circuit board.
Clause 62. The digital video camera of any of clauses 43-61, wherein the actuator is supported by an actuator housing having an actuator housing top and actuator housing sides, and wherein the actuator employs an actuator gear that is positioned about an actuator axis that bisects the actuator housing sides.
Clause 63. The digital video camera of any of clauses 43-62, wherein the actuator is supported by an actuator housing having a first actuator housing side with a first actuator mounting feature configured for coupling with a first camera mounting feature on a first side of the camera housing, wherein the actuator housing has a second actuator housing side has a second actuator mounting feature configured for coupling with a second camera mounting feature on a second side of the camera housing.
Clause 64. The digital video camera of clause 63, in which the first and second camera mounting features are configured for coupling with a camera mounting mechanism that is configured for coupling to, respectively, the camera housing and a person, a vehicle, or equipment such that the actuator housing is operable to be mounted to the first camera mounting feature while the camera mounting mechanism is mounted to the second camera mounting feature.
Clause 65. The digital video camera of clause 64, wherein:
   the scene has a level orientation;
   the person, the vehicle, or the equipment has a mounting surface with an off-axis orientation with respect to the level orientation of the scene;
   the mounting mechanism provides positioning adjustment of the camera housing with respect to the level orientation of the scene;
   cooperative adjustment of the mounting mechanism and the imaging receptacle with respect to the camera housing facilitate adjustments of the second orientation of the image sensor for pitch, yaw, and roll with respect to the level orientation of the scene to compensate for the off-axis orientation of the mounting surface; and
   the actuator is operable to cause the imaging receptacle to move in a manner that is superimposed on the cooperative adjustments.
Clause 66. The digital video camera of any of clauses 43-65, wherein the image sensor and the lens are positioned along an optical axis, wherein the imaging receptacle is operable for rotation about a control axis, and wherein the optical axis and the control axis are collinear.
Clause 67. The digital video camera of any of clauses 43-66, wherein the actuator and the image sensor are powered by different batteries.
Clause 68. The digital video camera of any of clauses 43-67, wherein at least one of the angular rate sensor and the accelerometer are rigidly mounted directly or indirectly to the camera housing.
Clause 69. The digital video camera of any of clauses 43-68, wherein at least one of the angular rate sensor and the accelerometer are rigidly mounted directly or indirectly to the imaging receptacle.
Clause 70. The digital video camera of any of clauses 43-69, wherein a coupling mechanism operable for coupling motion provided by the actuator to the rotatable frame, wherein the rotatable frame is operable for rotation independently from the camera housing such that the actuator is operable to cause a change in the orientation of the image sensor with respect to the camera housing.
Clause 71. A camera accessory for controlling orientation of an image sensor mounted within a rotatable frame that is supported by a camera housing having a camera housing mounting feature, comprising:
   an accessory housing having and accessory mounting feature operable for engaging the camera housing mounting feature;
   an angular rate sensor positionable within the accessory housing and operable to obtain angular rate information concerning angular forces experienced by the accessory housing;
   an accelerometer positionable within the accessory housing and operable to obtain acceleration information concerning acceleration experienced by the accessory housing;
   an actuator positionable within the accessory housing, wherein the actuator is directly or indirectly responsive to the angular rate information obtained by the angular rate sensor and the acceleration information obtained by the accelerometer, and wherein the actuator is operable to provide counter motion to offset angular forces and acceleration experienced by the accessory housing; and
   a coupling mechanism operable for coupling motion provided by the actuator to the rotatable frame, wherein the rotatable frame is operable for rotation independently from the camera housing such that the actuator is operable to cause a change in the orientation of the image sensor with respect to the camera housing.
Clause 72. A camera accessory for controlling orientation of an image sensor mounted within a rotatable frame that is supported by a camera housing having a camera housing mounting feature, comprising:
   an accessory housing having and accessory mounting feature operable for engaging the camera housing mounting feature;
   an angular rate sensor positionable within the accessory housing and operable to obtain angular rate information concerning angular forces experienced by the angular rate sensor;
   an accelerometer positionable within the accessory housing and operable to obtain acceleration information concerning acceleration experienced by the accelerometer;
   an actuator positionable within the accessory housing, wherein the actuator is directly or indirectly responsive to the angular rate information obtained by the angular rate sensor and the acceleration information obtained by the accelerometer, and
   wherein the actuator is operable to provide counter motion to offset angular forces and acceleration experienced by the accessory housing; and
   a coupling mechanism operable for coupling motion provided by the actuator to the rotatable frame, wherein the rotatable frame is operable for rotation independently from the camera housing such that the actuator is operable to cause a change in the orientation of the image sensor with respect to the camera housing.
Clause 73. The camera accessory of clause 72, wherein the coupling mechanism employs an actuator gear for coupling to a frame gear that is operable for attachment to the rotatable frame.
Clause 74. The camera accessory of any of clauses 72 and 73, wherein the camera housing is operable for mounting to a person, a vehicle, or equipment such that the camera housing has the first orientation with respect to the scene such that the digital video camera is operable for hands-free capture of video during motion of the person, the vehicle, or the equipment involved in an action sports activity.
Clause 75. The camera accessory of any of clauses 72-74, wherein the camera is a handheld camera.
Clause 76. The camera accessory of any of clauses 72-75, further comprising one or more additional accelerometers operable to obtain additional acceleration information concerning acceleration experienced by the camera housing, wherein the actuator is responsive to the additional acceleration information.
Clause 77. The camera accessory of any of clauses 72-76, wherein the accelerometer comprises a dual-axis accelerometer and a single axis accelerometer.
Clause 78. The camera accessory of any of clauses 72-77, wherein the accelerometer comprises a three-axis accelerometer.
Clause 79. The camera accessory of any of clauses 72-78, wherein the accelerometer employs a sample rate between 400 Hz and 1000 Hz.
Clause 80. The camera accessory of any of clauses 72-79, wherein the accelerometer employs low power consumption and suitable linearity and has a small physical size and a matching analog to digital converter.
Clause 81. The camera accessory of any of clauses 72-80, wherein the camera
Clause 82. The camera accessory of any of clauses 72-81, wherein the angular rate sensor comprises a dual-axis gyroscope.
Clause 83. The camera accessory of any of clauses 72-82, wherein the angular rate sensor comprises a dual-axis gyroscope and a single axis gyroscope.
Clause 84. The camera accessory of any of clauses 72-83, further comprising one or more additional angular rate sensors operable to obtain additional angular rate information concerning angular forces experienced by the camera housing, wherein the actuator is responsive to the additional a angular rate information.
Clause 85. The camera accessory of any of clauses 72-84, wherein the angular rate sensor and the additional angular rate sensor(s) comprise different types of gyroscopes.
Clause 86. The camera accessory of any of clauses 72-85, wherein the angular rate sensor employs a sample rate between 400 Hz and 1000 Hz.
Clause 87. The camera accessory of any of clauses 72-86, wherein the angular rate sensor employs low power consumption and suitable linearity and has a small physical size and a matching analog to digital converter.
Clause 88. The camera accessory of any of clauses 72-87, wherein at least one of the accelerometer and the angular rate sensor are integrated onto a computer chip or circuit board.
Clause 89. The camera accessory of any of clauses 72-88, wherein the actuator is supported by an actuator housing having an actuator housing top and actuator housing sides, and wherein the actuator employs an actuator gear that is positioned about an actuator axis that bisects the actuator housing sides.
Clause 90. The camera accessory of any of clauses 72-89, wherein the actuator is supported by an actuator housing having a first actuator housing side with a first actuator mounting feature adapted to mate with a first camera mounting feature on a first side of the camera housing, wherein the actuator housing has a second actuator housing side has a second actuator mounting feature adapted to mate with a second camera mounting feature on a second side of the camera housing.
Clause 91. The camera accessory of any of clauses 72-90, wherein the image sensor and the lens are positioned along an optical axis, wherein the imaging receptacle is operable for rotation about a control axis, and wherein the optical axis and the control axis are collinear.
Clause 92. The camera accessory of any of clauses 72-91, further comprising:
   angular rate characterization software operable for interpreting the angular forces experienced by the camera housing;
   acceleration characterization software operable for interpreting the acceleration experienced by the camera housing; and
   processing circuitry directly or indirectly in communication with the angular rate characterization software and the acceleration characterization software for determining instructions for the actuator to rotate the imaging receptacle.
Clause 93. A camera accessory for controlling orientation of an image sensor mounted within a rotatable frame that is supported by a camera housing having a camera housing mounting feature, comprising:
   an accessory housing having and accessory mounting feature operable for engaging the camera housing mounting feature;
   an actuator positionable within the accessory housing, wherein the actuator is directly or indirectly responsive to angular rate information obtained by an angular rate sensor and acceleration information obtained by an accelerometer, and wherein the actuator is operable to provide counter motion to offset angular forces and acceleration experienced by the angular rate sensor and the accelerometer, wherein the angular rate sensor is located remotely from the camera accessory and operable to obtain angular rate information concerning angular forces experienced by the angular rate sensor, and wherein the accelerometer is located remotely from the camera accessory and operable to obtain acceleration information concerning acceleration experienced by the accelerometer; and
   a coupling mechanism operable for coupling motion provided by the actuator to the rotatable frame, wherein the rotatable frame is operable for rotation independently from the camera housing such that the actuator is operable to cause a change in the orientation of the image sensor with respect to the camera housing.
Clause 94. A method for adjusting orientation of an image sensor with respect to a reference plane, comprising:
   supporting a camera housing with a first orientation with respect to the reference plane;
   rotating an imaging receptacle supported by the camera housing, wherein the imaging receptacle is operable for rotation independent of the camera, wherein the imaging receptacle supports a lens and an image sensor, wherein the image sensor is supported in rotational congruence with the imaging receptacle such that rotation of the imaging receptacle causes rotation of the image sensor and such that the image sensor is operable to have a second orientation with respect to the reference plane, wherein the second orientation is different from the first orientation;
   employing an angular rate sensor to obtain angular rate information concerning angular forces experienced by the camera housing with respect to the reference plane;
   employing an accelerometer operable to obtain acceleration information concerning acceleration experienced by the camera housing with respect to the reference plane;
   causing an actuator to rotate the imaging receptacle directly or indirectly in response to angular rate information obtained by the angular rate sensor and the acceleration information obtained by the accelerometer, such that the actuator is operable to cause a change of the second orientation of the image sensor with respect to the reference plane while maintaining the first orientation of the camera housing with respect to the reference plane; and
   employing the image sensor to capture light propagating through the lens and representing the scene.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and circuits described in connection with the implementations disclosed herein can be implemented or performed with a microprocessor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. The microprocessor can include a controller, microcontroller, or state machine, etc. A processor can also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such that the processor can read information from, and write information to, the computer-readable storage medium. In the alternative, the storage medium can be integral to the processor. The processor and the storage medium can reside in an ASIC. The ASIC can reside in a user terminal, camera, or other device. In the alternative, the processor and the storage medium can reside as discrete components in a user terminal, camera, or other device.

The previous description of the disclosed implementations is provided to enable any person skilled in the art to make or use the present invention. Various modifications to these implementations will be readily apparent to those skilled in the art, and the generic principles defined herein can be applied to other implementations without departing from the spirit or scope of the invention. Thus, the present invention is not intended to be limited to the implementations shown herein but is to be accorded the widest scope consistent with the principles and novel features disclosed herein.

1-25. (canceled)

26. A camera accessory, comprising:
an accessory housing having an accessory mounting system for engaging a camera mounting system of a digital video camera, the digital video camera comprising an image sensor and a camera housing having a first orientation with respect to a scene;
an angular rate sensor configured to sense orientation of the camera accessory;
an accelerometer configured to sense acceleration of the camera accessory;
an actuator;
a control gear directly or indirectly coupled to the actuator and a frame gear, wherein the frame gear is coupled to the digital video camera; and
a controller communicatively coupled to the angular rate sensor and the accelerometer, the controller configured to:
receive orientation data from the angular rate sensor and acceleration data from the accelerometer,
generate one or more control signals based at least in part on the orientation data and the acceleration data, and
communicate the one or more control signals to the actuator, wherein the actuator induces a rotational movement of the control gear and the frame gear such that the image sensor of the digital video camera has a second orientation with respect to the scene that is different from the first orientation.

27. A camera accessory, comprising:
an accessory housing having an accessory mounting system operable for engaging a camera mounting system of a digital video camera, the digital video camera comprising an image sensor and a camera housing having a first orientation with respect to a scene;
one or more kinematic sensors configured to sense at least one of orientation and movement of the digital video camera;
a control gear coupled a frame gear, wherein the frame gear is coupled to the digital video camera; and
an actuator directly or indirectly coupled to the control gear, the actuator configured to induce a rotational movement of the control gear and the frame gear such that the image sensor of the digital video camera has a second orientation with respect to the scene that is different from the first orientation.

28. The camera accessory of claim 27, wherein the actuator induces the rotational movement of the image sensor about a longitudinal axis of the camera accessory.

29. The camera accessory of claim 27, further comprising:
a controller communicatively coupled to the one or more kinematic sensors and the actuator, the controller configured to:
receive kinematic data from the one or more kinematic sensors,
determine a measured orientation of the digital video camera based at least in part on the received kinematic data;
determine a threshold difference between the measured orientation and a desired orientation of the digital video camera is not satisfied;
based at least in part on the determination that the threshold difference is not satisfied, generate one or more control signals for the actuator; and
send the one or more control signals to the actuator, wherein the one or more control signals cause the actuator to induce the rotational movement of the image sensor.

30. The camera accessory of claim 29, wherein the desired orientation is determined based at least in part on a user input to at least one of the digital video camera and the camera accessory.

31. The camera accessory of claim 27, wherein the one or more kinematic sensors comprise one or more accelerometers configured to sense acceleration of the camera accessory, and wherein the actuator is configured to induce the rotational movement of the control gear based at least in part on the acceleration of the camera accessory.

32. The camera accessory of claim 31, wherein the one or more accelerometers comprise a dual-axis accelerometer and a single axis accelerometer.

33. The camera accessory of claim 31, wherein the one or more accelerometers comprise a three-axis accelerometer.

34. The camera accessory of claim 31, wherein the one or more accelerometers employ a sample rate between 400 Hz and 1000 Hz.

35. The camera accessory of claim 31, wherein the one or more accelerometers employ low power consumption and suitable linearity and have a small physical size and an analog to digital converter.

36. The camera accessory of claim 27, wherein the one or more kinematic sensors comprise one or more angular rate sensors configured to sense an orientation of the camera accessory, and wherein the actuator is configured to induce the rotational movement of the control gear based at least in part on the orientation of the camera accessory.

37. The camera accessory of claim 36, wherein the one or more angular rate sensors comprise a dual-axis gyroscope.

38. The camera accessory of claim 36, wherein the one or more angular rate sensors comprise a dual-axis gyroscope and a single axis gyroscope.

39. The camera accessory of claim 36, wherein the one or more angular rate sensors comprise different types of gyroscopes.

40. The camera accessory of claim 36, wherein one or more angular rate sensors employ a sample rate between 400 Hz and 1000 Hz.

41. The camera accessory of claim 36, wherein the one or more angular rate sensors comprise employ low power consumption and suitable linearity and has a small physical size and an analog to digital converter.

42. A method, comprising:
receiving kinematic data of a camera accessory from a kinematic sensor coupled to the camera accessory, the camera accessory coupled to a digital video camera having a first orientation with respect to a scene; and
causing an actuator to induce a rotational movement of an image sensor of the digital video camera coupled to the camera accessory in response to the at least one of orientation and movement of the camera accessory such that the image sensor has a second orientation with respect to the scene that is different from the first orientation.
